(19) United States
(12) Patent Application Publication
(10) Pub. No.: US 2009/0066722 A1
(43) Pub. Date: Mar. 12, 2009

(54) System, Device, and Method for Conveying Information Using Enhanced Rapid Serial Presentation

(76) Inventors: Joshua F. Kriger, Cambridge, MA (US); Eileen C. Shapiro, Cambridge, MA (US)

Correspondence Address: BROMBERG & SUNSTEIN LLP, 125 SUMMER STREET, BOSTON, MA, 02110-1618, US

(21) Appl. No.: 12/187,830

(22) Filed: Aug. 7, 2008

Related U.S. Application Data
(63) Continuation-in-part of application No. 11/512,425, filed on Aug. 29, 2006.
(60) Provisional application No. 60/712,665, filed on Aug. 29, 2005.
(60) Provisional application No. 60/977,838, filed on Oct. 5, 2007.

(51) Int. Cl. G09G 5/00

(52) U.S. Cl. 345/619

(57) ABSTRACT

A method for rendering a rapid serial presentation on a consumer device having at least a display screen involves rendering a portion of the rapid serial presentation on the display screen of the consumer device, automatically pausing rendering of the rapid serial presentation, displaying a message on the display screen for a quantum of time during such pausing, and thereafter resuming rendering of the rapid serial presentation on the display screen. The message may include an advertisement, a suggested action, or a question presented to a consumer. RSP content and non-RSP content may be rendered at different locations of the display screen.

### CROSS-REFERENCE TO RELATED APPLICATION

This application is a continuation-in-part of, and therefore claims priority from, U.S. patent application Ser. No. 11/512,425 entitled SYSTEM, DEVICE, AND METHOD FOR CONVEYING INFORMATION USING A RAPID SERIAL PRESENTATION TECHNIQUE filed on Aug. 29, 2006 in the name of Joshua Kriger, which claims priority from U.S. Provisional Patent Application No. 60/712,665 entitled ENHANCED-RAPID SERIAL VISUAL PRESENTATION filed on Aug. 29, 2005 in the name of Joshua Kriger.

This application also claims priority from U.S. Provisional Patent Application No. 60/977,838 entitled SYSTEM, DEVICE, AND METHOD FOR CONVEYING INFORMATION USING ENHANCED RAPID SERIAL PRESENTATION filed on Oct. 5, 2007 in the names of Joshua Kriger and Eileen Shapiro.

Each of the above-referenced patent applications is hereby incorporated herein by reference in its entirety.

### FIELD OF THE INVENTION

The present invention relates generally to presentation of information using an enhanced rapid serial presentation technique.

### BACKGROUND OF THE INVENTION

In the early 20th century, the idea of a machine reader first emerged with the concept of a tachistoscope, for which the common definition is a device that projects words and images in rapid succession to test visual perception by increasing comprehension to aid in information intake and learning. Tachistoscopes are built using a cylinder having words and images viewed from the cylinder by a backlight, allowing projections to be processed visually.

When cognitive science started to gain recognition as a field of research during the 1970's, a parallel technique called rapid serial visual presentation emerged. Commonly referred to by the acronym RSVP, rapid serial visual presentation allows researchers to test many types of visual information processing by displaying a symbol, image, or word at a fixed location for a duration of time, followed by a successive symbol, image, or word.

Although RSVP technology has given scientists studying attention, memory, and learning an opportunity to gain insight into cognitive processes including attention, memory, and learning, RSVP has given the average person little if any direct benefit in their daily information intake. Some companies have tried to solve this problem by utilizing rapid serial visual presentation as a reading system to increase reading speed and comprehension, but despite much effort, have not resolved the fundamental issue of the uncomfortable feeling people often report when text is displayed using RSVP. Research in cognitive science has shown that using current RSVP techniques of text display, consumers still prefer normal methods of reading over RSVP.

U.S. Pat. No. 6,056,551 (Marasco, issued May 2, 2000), which is hereby incorporated herein by reference in its entirety, claims to offer methods to increase reading speed and user comprehension. Marasco understood the importance of using word groups to display text in rapid succession, but this technique is taught by almost all speed reading courses that emphasize reading in word grouping rather than refocusing on each word, thereby increasing reading speed by requiring fewer eye movements (called saccades, which generally last 10-80 milliseconds, during which time no reading is effectively performed).

U.S. Pat. No. 4,845,645 (Matin, issued Aug. 28, 1987), which is hereby incorporated herein by reference in its entirety, creates a display system and method to present data in real time rapid temporal succession at one spatial location. Envisioned for operators of nuclear power plants, military instruments, and air traffic controllers, no provisions were laid out to compensate for processing times for different modes of comprehension. Also claims were made for display times between 100 to 450 milliseconds; this parameter does not take into account language processing, which can occur as fast as 40 milliseconds.

Several types of RSVP text display systems have been proposed and implemented, with products such as Acereader, Bailando, and BuddyBuzz providing various levels of functionality and sophistication. While some RSVP implementations merely display each word of text for a fixed amount of time and add delays at appropriate points (e.g., at a comma or at the end of a sentence), other RSVP implementations attempt to improve comfort levels for RSVP users by selecting the display characteristics for each word or phrase (e.g., display time, font, font size, font effect, color, etc.) based on such things as the number of times a word has been encountered in the text (e.g., a word might be displayed for a longer amount of time the first time it is encountered, with subsequent instances of the word displayed for shorter amounts of time), word length (e.g., longer words may be displayed for longer amounts of time than shorter words), word frequency (e.g., a lexicon of word frequencies may be used to assign a weight to each word based on its measured frequency of use in textual content—see, for example, Oquist, Adaptive Rapid Serial Visual Presentation 2001, which is hereby incorporated herein by reference in its entirety), and word type (e.g., proper names may be displayed for a longer amount of time than prepositions—see, for example, Kanellos, Reading phone text one word at a time, Jul. 13, 2005, which is hereby incorporated herein by reference in its entirety). Wong, Visible Language Workshop paper, which is hereby incorporated herein by reference in its entirety, discusses dynamic visual treatment of text as an extension of written language, and recognizes that a range of emotional qualities and tones of voice can be conveyed through treatment of the typographical form (e.g., typeface, weight, color) and also recognizes that electronic media extends the expressive possibilities by enabling typographic forms to change dynamically in size, color, and position according to a writer's expression or a reader's interaction in real time. Unfortunately, such implementations do not account for the way people actually process the words, and therefore generally do not provide substantial improvements in user comfort levels.

Other attempts to improve comfort levels for RSVP users involve various types of interfaces through which the user can control rendering of the presentation, such as the overall rate of textual display (e.g., speed up or slow down) and the ability to pause and rewind the display (see, for example, Williams, RSVP User's Guide, 1999, which is hereby incorporated herein by reference in its entirety). Some proposals incorporate a “familiar metaphor” for controlling the RSVP display, such as through controls that mimic driving an automobile or flying an airplane (see, for example, U.S. Pat. No. 6,515,690 issued on Feb. 4, 2003 to Back et al.; Back et al., The AirBook: force-free interaction with dynamic text in an assistive reading device; and Back et al., Speeder Reader: An Experiment in the Future of Reading, all of which are hereby incorporated herein by reference in their entireties. Still other proposals involve monitoring eye movements and automatically adjusting the RSVP display, e.g., slowing down the display if the user looks away from the screen (see, for example, Akervall, Smart Bailando Eye controlled RSVP on handhelds, 2002, which is hereby incorporated herein by reference in its entirety). In general, such attempts to improve comfort levels have not met with much success because they are either difficult for the user or are impractical (e.g., the eye monitoring proposal requires two cameras, which is not practical on a small portable consumer device; similarly, input devices that mimic driving or flying are not practical for use with small portable consumer devices).

Recently, there has been a particular focus on RSVP implementations intended for consumer devices having small display screens, such as, for example, mobile telephones, personal digital assistants, personal computers, pagers, video games, wrist watches, and the like, particularly because such devices are generally not well-suited for textual display (see, for example, Muter, Interface Design and Optimization of Reading of Continuous Text, 1996; Goldstein et al., Enhancing the Reading Experience: Using Adaptive and Sonified RSVP for Reading on Small Displays; Castelhano et al., Optimizing the reading of electronic text using rapid serial visual presentation (2001); Sicheritz, Applying the Rapid Serial Visual Presentation Technique to Small Screens; Chittaro, Visualizing Information on Mobile Devices, March 2006; Johnson, Opus: Composing and Exploring Dynamic Typography; and United States Published Patent Application No. 2006/0100984 to Fogg et al., all of which are hereby incorporated herein by reference in their entireties). Furthermore, there has also been a focus on the use of RSVP for navigating applications on consumer devices, such as, for example, scrolling through the various menus of a cell phone, PDA, or web browser (see, for example, de Bruijn et al., RSVP Browser—Web Browsing on Small Screen Devices, which is hereby incorporated herein by reference in its entirety, and de Bruijn et al., Rapid Serial Visual Presentation, which is hereby incorporated herein by reference in its entirety). Here, rather than requiring the user to scroll through a list of menu options (e.g., using a mouse or scroll wheel), icons representing the various options may be displayed to the user sequentially, and the user can select an option, for example, by “clicking” when the corresponding icon is being displayed.

In the context of RSVP for use with portable consumer devices, certain proposed systems include a backend server that converts textual content into a markup language file and sends the markup language file to the consumer device for rendering (see, for example, Oquist, Adaptive Rapid Serial Visual Presentation, 2001, which was incorporated by reference above, and United States Published Patent Application No. 2006/0100984 to Fogg et al., which was incorporated by reference above).

Thus, even though the underlying RSVP concepts have been around for decades and there have been a number of recent attempts to improve RSVP, RSVP implementations remain woefully inadequate for mass consumption of information.

### SUMMARY OF THE INVENTION

In accordance with one aspect of the invention there is provided a method for rendering a rapid serial presentation on a consumer device having at least a display screen. The method involves rendering a portion of the rapid serial presentation on the display screen of the consumer device, automatically pausing rendering of the rapid serial presentation, displaying a message on the display screen for a quantum of time during such pausing, and thereafter resuming rendering of the rapid serial presentation on the display screen.

In various alternative embodiments, the message may include an advertisement (e.g., an advertisement, coupon, incentive, bonus, etc) or a questions requiring a response from a consumer. The advertisement may include a link that a consumer can select in order to obtain further information. The message may include a suggested action for a consumer to perform (e.g., click a predetermined key or button, click on a specified link, answer one or more questions, provide specified information, complete a puzzle, forward the message to a friend, send a reply or a text message to a specified address, respond verbally, or a suggestion to “blink,” “breath,” or “take a break,” etc.). The rapid serial presentation may be rendered at a first location on the display screen and the message may be displayed at a different location on the display screen.

Rendering of the rapid serial presentation may be resumed after the message has been displayed for a predetermined amount of time or upon receipt of a specified input from a consumer via the consumer device (e.g., selection of a link, actuation of an actuator of the consumer device, affirmation that the consumer has read the message, in which case the consumer may be provided with a credit or discount for having read the message). Rendering may resume from where the rapid serial presentation was paused or may resume from prior to where the rapid serial presentation was paused.

Rendering of the rapid serial presentation may be paused after a predetermined amount of time or after a predetermined number of words. The predetermined amount of time and the predetermined number of words may be configurable by a consumer.

Rendering of the rapid serial presentation may be paused upon encountering an unknown word in the rapid serial presentation. The message may present a number of consumer-selectable options including at least a first option to add the unknown word to a dictionary and a second option to resume rendering of the rapid serial presentation without adding the unknown word to the dictionary.

The consumer device may include a light detector (e.g., an in-built camera of a mobile phone, an “electric eye,” etc.) through which ambient light conditions can be monitored, in which case automatically pausing rendering of the rapid serial presentation may include automatically pausing rendering of the rapid serial presentation upon detection of a predetermined unacceptable ambient light condition. The predetermined unacceptable ambient light condition may include an ambient light level below a predetermined ambient light level threshold or an ambient light level above a predetermined ambient light level threshold. Rendering of the rapid serial presentation may be automatically resumed upon return to a predetermined acceptable ambient light condition.

The consumer device may include a microphone through which ambient noise levels can be monitored, in which case automatically pausing rendering of the rapid serial presentation may include automatically pausing rendering of the rapid serial presentation upon detection of a predetermined unacceptable ambient noise condition. The predetermined unacceptable ambient noise condition may include an ambient noise level above a predetermined noise level threshold. Rendering of the rapid serial presentation may be automatically resumed upon return to a predetermined acceptable ambient noise condition.

Rendering of the rapid serial presentation may be paused upon receipt of a telephone call, email message, text message, or other such event at the consumer device.

Rendering of the rapid serial presentation may be paused upon detecting a condition indicating that a consumer has not viewed the rendering of the rapid serial presentation for a predetermined amount of time. For example, the consumer device may include an eye monitor (built-in camera of the consumer device) and rendering may be paused upon determining that the consumer blinked, blinked more than once within a predetermined amount of time, or looked away from the display screen for a predetermined amount of time. The consumer device may include a pulse monitor (e.g., mechanical sensor, a thermal sensor, an optical sensor, and a galvanic skin response sensor of the consumer device) and rendering may be paused upon detecting a change in consumer pulse rate or absence of a pulse signal. The consumer device may include a contact device (e.g., mechanical sensor, a thermal sensor, an optical sensor, and a galvanic skin response sensor of the consumer device) that the consumer must contact in order for rendering to occur and rendering may be paused upon determining that the consumer is no longer in contact with the contact device. The consumer device may include a proximity monitor (e.g., an infrared proximity detector of the consumer device) and rendering may be paused upon determining that the consumer is outside of a predetermined proximity.

The message may include a link that a consumer can select to forward the message to one or more other consumers. The consumer may be provided with a credit or discount for forwarding the message. The amount of the credit or discount may be based on the number of other consumers to which the message is forwarded.

Displaying the message may involve selecting a message from among a plurality of messages and displaying the selected message. The message may be selected based upon an attribute associated with a consumer (e.g., a demographic attribute, a psychographic attribute, and/or a behavioral attribute associate with the consumer) or a location of the consumer device. An attribute associated with the consumer may be obtained from a profile. The profile may include feedback information obtained previously from the consumer.

Rendering of the rapid serial presentation may be paused based on pause information included in the rapid serial presentation or independently of pause information included in the rapid serial presentation. Rendering of the rapid serial presentation may be automatically paused at least in part based on preference information provided previously by a consumer.

An advertisement may be displayed on the display screen simultaneously with rendering the portion of the rapid serial presentation, and the message displayed during pausing may relate to the displayed advertisement. The portion of the rapid serial presentation may be rendered in a predetermined window area of the display screen and the advertisement may be displayed in an area adjacent to the window area, an area surrounding the window area, a background area, or a control area. The message may prompt a consumer for feedback information regarding the advertisement, and wherein the rendering is resumed only upon receipt of the feedback information.

Feedback information may be collected from the consumer in response to the message. The feedback information may include an unknown word flagged by the consumer, an answer to a question concerning the message, or an opinion concerning the message.

An advertisement may be displayed on the display screen prior to rendering the portion of the rapid serial presentation, and the portion of the rapid serial presentation may be rendered only upon receipt of a specified input from a consumer via the consumer device.

Rendering of the rapid serial presentation may be automatically paused at a non-RSP component of the rapid serial presentation, in which case the message may allow a consumer to selectively render the non-RSP component. The non-RSP component may include a chart, a table, a graph, a spreadsheet, a footnote, a comment, a picture, a drawing, a slide show, an object, a video clip, an audio clip, a file, a document, or a link. The rapid serial presentation may be rendered at a first location on the display screen and the non-RSP component may be rendered at a second location on the display screen. Rendering of the rapid serial presentation may be selectively resumed at the first location in conjunction with rendering of the non-RSP component at the second location.

In accordance with another aspect of the invention there is provided a method for rendering RSP content and non-RSP content on a consumer device having at least a display screen. The method involves rendering the RSP content at a first location on the display screen and rendering the non-RSP content at a second location on the display screen.

In various alternative embodiments, the rendering of the RSP content may be synchronized with the rendering of the non-RSP content. The RSP content and the non-RSP content may be rendered in separate windows at different locations on the display screen. Multiple RSP windows and/or multiple non-RSP windows may be displayed on the same display screen.

The non-RSP content rendered at the second location may include video content, and the RSP content rendered at the first location may include corresponding captions (e.g., closed-captioning or subtitles).

The non-RSP content rendered at the second location may include foreign-language audio content, and the RSP content rendered at the first location may include corresponding translation of the foreign-language audio content.

The non-RSP content rendered at the second location may include audio content, and the RSP content rendered at the first location may include corresponding transcription of the audio content.

The non-RSP content rendered at the second location may include slides for a slide show, and the RSP content rendered at the first location may include corresponding captions.

The non-RSP content rendered at the second location may include a portion of a document, and the RSP content rendered at the first location may include corresponding text for the portion of the document.

The non-RSP content rendered at the second location may include a document relating to the RSP content rendered at the first location. The document may be used by a consumer to enter notes regarding the RSP content.

### BRIEF DESCRIPTION OF THE DRAWINGS

The foregoing and advantages of the invention will be appreciated more fully from the following further description thereof with reference to the accompanying drawings wherein:

FIG. 1 is a conceptual diagram depicting an eRSP system in accordance with an exemplary embodiment of the present invention;

FIG. 2 is a schematic block diagram showing the relevant components of an eRSP server in accordance with an exemplary embodiment of the present invention;

FIG. 3 is a schematic block diagram showing the relevant components of an eRSP generator in accordance with an exemplary embodiment of the present invention;

FIG. 4 is a schematic block diagram showing possible contents of a database in accordance with an exemplary embodiment of the present invention;

FIG. 5 is a schematic block diagram showing the relevant components of consumer device in accordance with an exemplary embodiment of the present invention;

FIG. 6 is a logic flow diagram for generating targets and corresponding descriptors in accordance with exemplary embodiments of the present invention;

FIG. 7 is a logic flow diagram for use of a dictionary containing psycholinguistic attributes, in accordance with an exemplary embodiment of the present invention;

FIG. 8 is a logic flow diagram for use of rule sets, in accordance with an exemplary embodiment of the present invention;

FIG. 9 is a logic flow diagram for voice-to-text in accordance with an exemplary embodiment of the present invention;

FIG. 10 is a logic flow diagram for biofeedback in accordance with an exemplary embodiment of the present invention;

FIG. 11 shows an exemplary search screen for a consumer device in accordance with an exemplary embodiment of the present invention;

FIG. 12 shows an exemplary settings screen for a consumer device in accordance with an exemplary embodiment of the present invention;

FIG. 13 shows an exemplary text display setting screen for a consumer device in accordance with an exemplary embodiment of the present invention;

FIG. 14 shows an exemplary text size setting screen for a consumer device in accordance with an exemplary embodiment of the present invention;

FIG. 15 shows an exemplary profiles settings screen for a consumer device in accordance with an exemplary embodiment of the present invention;

FIG. 16 shows an exemplary dimmer setting screen for a consumer device in accordance with an exemplary embodiment of the present invention;

FIG. 17 shows an exemplary full screen setting screen for a consumer device in accordance with an exemplary embodiment of the present invention;

FIG. 18 shows an exemplary word per minute setting screen for a consumer device in accordance with an exemplary embodiment of the present invention;

FIG. 19 shows an exemplary color setting screen for a consumer device in accordance with an exemplary embodiment of the present invention;

FIG. 20 shows an exemplary timer setting screen for a consumer device in accordance with an exemplary embodiment of the present invention;

FIG. 21 shows an exemplary eRSP screen for a consumer device in accordance with an exemplary embodiment of the present invention;

FIG. 22 shows an exemplary full screen for a consumer device in accordance with an exemplary embodiment of the present invention;

FIG. 23 shows an exemplary bookmarks screen for a consumer device in accordance with an exemplary embodiment of the present invention;

FIG. 24 shows an exemplary history screen for a consumer device in accordance with an exemplary embodiment of the present invention;

FIG. 25 shows some of the open window space made available by eRSP in an exemplary embodiment of the invention;

FIG. 26 shows an exemplary eRSP screen including a progress/scroll bar placed in the open space to the right side of the eRSP window area in accordance with an exemplary embodiment of the present invention; and

FIG. 27 shows an exemplary eRSP screen including a sponsor banner, an information panel, and a set of additional control tabs positioned in the open space around the eRSP window area in accordance with an exemplary embodiment of the present invention.

### DETAILED DESCRIPTION OF SPECIFIC EMBODIMENTS

### Definitions

As used in this description and the accompanying claims, the following terms shall have the meanings indicated, unless the context otherwise requires:

“Content” is electronic information to be presented to a consumer. Content can include such things as stored information files, streamed information, web pages, electronic books, and the like. Thus, for example, content may include such things as documents (e.g., Microsoft Word, Excel™, Outlook™, Powerpoint™ documents, pdf documents, etc.), e-mails, text messages, instant messages, web pages, and search engine results, to name but a few. Content may be directly or indirectly obtained from, or provided by, online sources such as, for example, online databases (e.g., Wikipedia™, etc.); online dictionaries (e.g., merriam-webster.com, freeonlinedictionary.com, etc.); online search facilities (e.g., Google™, Yahoo™, Ask.com™, etc.); online publishers (e.g., online newspapers such as Boston.com™ or Washingtonpost.com™, online magazines, etc.); online stores (e.g., Amazon™, Apple iTunes™, etc.); online sports networks (e.g., espn.com, nfl.com, mlb.com, etc.); online social networking services (e.g., YouTube™, FaceBook™, etc.); electronic learning environments (e.g., reading/language training for children, foreign language lessons, etc.); company/organization web sites; web browsers (e.g., Microsoft Explorer™, Apple Safari™, etc.); and wireless service providers (e.g., Verizon™, AT&T™, T-Mobile™, Research In Motion™, etc.), to name but a few.

A “term” is a quantum of information, such as a word or phrase, that is parsed from content. In essence, content can be characterized as a sequence of terms.

A “target” is information to be presented as a unit to a consumer as part of a rapid serial presentation. Targets are generally derived from content and can include, for example, a single term or a group of terms. Additional targets, such as, for example, inserted text, audio, video, image, and tactile information, can also be included in a rapid serial presentation.

A “descriptor” defines one or more characteristics for presenting a target during a rapid serial presentation. Descriptors can define any of a number of typographic and display attributes, such as font, font size, font style/effects (e.g., bold, underline, italic), font color, display position, display orientation, display duration, and the like. A descriptor may define different characteristics for different parts of the target, e.g., first word bold, second word green, third word in different font. Descriptors may be in the form of XML-like tags.

“Rapid serial presentation” or “RSP” is an expansion of Rapid Serial Visual Presentation (RSVP) that includes enhanced textual display capabilities and may also incorporate audio, visual, and tactile components; enhancements and embodiments described in the related applications incorporated by reference above, as well as additional enhancements and embodiments discussed below, are referred to collectively as enhanced rapid serial presentation or eRSP.

The term “rapid serial presentation” may be used to refer to a compilation of a sequence of targets and corresponding descriptors that is capable of being rendered on a consumer device. A rapid serial presentation generally, although not necessarily, includes at least one descriptor for each target. A rapid serial presentation may include multiple descriptors for a single target and may include independent descriptors that are not associated with any particular target. A rapid serial presentation may be in the form of a markup language file (e.g., using XML-like syntax) or other electronic document.

The term “rapid serial presentation” may also be used to refer to the actual rendering of the compilation on a consumer device.

A “consumer device” is a device capable of rendering a rapid serial presentation. A consumer device typically includes at least a display screen (e.g., a CRT, LCD, plasma screen) or an interface (e.g., a video out connector) to a display screen on which visual information (e.g., textual, video, image information) can be displayed, but may also include other components, such an audio output (e.g., a speaker or buzzer) for generating audible signals or a tactile output (e.g., a vibrator or a movable member, for example, as in U.S. Pat. No. 5,989,099, which is hereby incorporated herein by reference in its entirety) for generating tactile signals. Consumer devices may be stationary or mobile. Some examples of mobile consumer devices include mobile telephones, personal digital assistants, personal computers, pagers, portable video games, digital watches, portable media players (e.g., Apple™iPod™ or iPhone™), and the like. Some examples of stationary consumer devices include desktop computers, television monitors, kiosks, automated teller machines, digital set top boxes, and the like. A consumer device is not required to support rendering of all types of targets and descriptors. For example, a consumer device without a tactile output might ignore targets/descriptors that convey tactile signals.

A rapid serial presentation is “rendered” on a consumer device by serially outputting the sequence of targets on the consumer device in accordance with the presentation characteristics specified by the descriptors. During rendering of a rapid serial presentation, textual information is generally displayed at a single predetermined location on a display screen, although the descriptors may specify a different orientation, position, or other display attribute for certain textual information.

A “dictionary” is a database of information characterizing at least some of the terms. Each term in the dictionary may be associated with various attributes, including linguistic and psycholinguistic attributes. Each attribute is typically assigned a quantitative value. Exemplary dictionaries include the Medical Research Council (MRC) Psycholinguistic Database and the Oxford Psycholinguistic Database, which define 26 linguistic and psycholinguistic attributes by which terms can be characterized. The various attributes are described in Wilson, MRC Psycholinguistic Database: Machine Usable Dictionary. Version 2.00, Oxford University Computing Service, 1987, which can be found at http://www.psy.uwa.edu.au/mrcdatabase/mrc2.html (referred to hereinafter as the “MRC2 Dictionary Documentation”), the content of which is hereby incorporated herein by reference in its entirety. “Lingustic attributes” include such things as number of letters in the word, number of phonemes in the word, number of syllables in the word, Kucera and Francis written frequency, Kucera and Francis number of categories, Kucera and Francis number of samples, Thorndike-Lorge frequency, Brown verbal frequency, type, part of speech (SOED syntactic category), part of speech (Jones' Pronouncing Dictionary syntactic category), alphasyllable, status, variant phoneme, written capitalized, irregular plural, the actual word, phonetic transcription, edited phonetic transcription, and stress pattern; “psycholinguistic attributes” include such things as familiarity, concreteness, imagery, mean Colerado meaningfulness, mean Pavio meaningfulness, and age of acquisition. Descriptions of these linguistic and psycholinguistic attributes can be found In the MRC2 Dictionary Documentation. It should be noted that the dictionary need not (and typically does not) include a quantified value for each attribute for each term. A particular eRSP implementation may support multiple dictionaries that are configured for specific uses, such as for different types of content or different users. Custom dictionaries may be created specifically for eRSP, with new or modified types of psycholinguistic attributes reflecting users' experiences with eRSP. A dictionary may include entries defining interactions between words, phrases, sounds, images, and tactile signals. A dictionary may include one or more default entries for use when a term is not in the dictionary or a referenced attribute for a particular term is not quantified.

In the context of generating a rapid serial presentation, a “rule set” is a set of rules for converting terms into a sequence of targets and related descriptors. There may be different rule sets for different users and/or different types of content. In the context of rendering a rapid serial presentation, a rule set is a set of rules or descriptors included in the rapid serial presentation file (e.g., XML-like constructs included in an eRSP markup language file) for rendering targets.

A “latent physiological condition” is a physiological condition of a consumer that is not outwardly apparent but is capable of being monitored and quantified in order to infer an emotional state of the consumer during a rapid serial presentation. Physiological parameters may include such things as heart rate, blood flow, brain waves, electronic signals, galvanic skin response, breathing, temperature, and other latent physiological conditions, but would not include such things as eye movements and blinking that can be outwardly observed.

A “demographic attribute” is an attribute relating to selected characteristics and dynamics of a consumer or of a population associated with a consumer. Examples of demographic attributes include race, age, gender, income, disabilities, mobility (e.g., in terms of travel time to work or number of vehicles available), education, reading level, home ownership status, home value, household size, age of children, occupation, employment status, and geographic location/region, to name but a few.

A “psychographic attribute” is an attribute relating to psychological characteristics of a consumer or of a population associated with a consumer. Examples of psychographic attributes include personality, values, attitudes, interests, opinions, preferences, or lifestyles, to name but a few.

A “behavioral attribute” is an attribute relating to behavioral characteristics of a consumer or of a population associated with a consumer. Examples of behavioral attributes include usage rate, loyalty, and purchase history, to name but a few.

The terms demographic attribute, psychographic attribute, and behavioral attribute are used herein in an open-ended way to describe various categories of information that may be used to select such things as content (e.g., articles, advertisements, messages, questions) and operating parameters for a consumer in various embodiments of the present invention. There may be overlap between the various categories (i.e., a particular attribute might be considered to fall within more than one of these categories either generally or within a particular context). These attributes may be collected directly from consumers (e.g., through questionnaires or otherwise) and/or indirectly (e.g., by analyzing consumer activities such as web browsing, click-through rates, bounce rates, topics searched or reviewed, or online usage patterns, to name but a few). The present invention is not limited to the specific attribute examples provided above.

### Introduction

Embodiments of the present invention provide a number of enhancements over traditional Rapid Serial Visual Presentation (RSVP) techniques and implementations. For example, conversion of content into targets and descriptors may utilize psycholinguistic information in order to account for the way in which people process certain terms. Rule sets may be employed to process content differently for different users or for different types of content. User profiles may be used to tailor a rapid serial presentation to a particular user or group of users. Techniques are discussed for creating a rapid serial presentation that mimics a reading of textual content. Techniques are also discussed for dynamically adjusting the rendering of a rapid serial presentation based on latent physiological conditions that infer an emotional state of the user. Information about the user (such as latent physiological conditions and other metrics) may be collected by the consumer device and transmitted to a central server so that user preferences can be tracked and used during the creation of subsequent rapid serial presentations for the user. These and other enhancements are discussed further below.

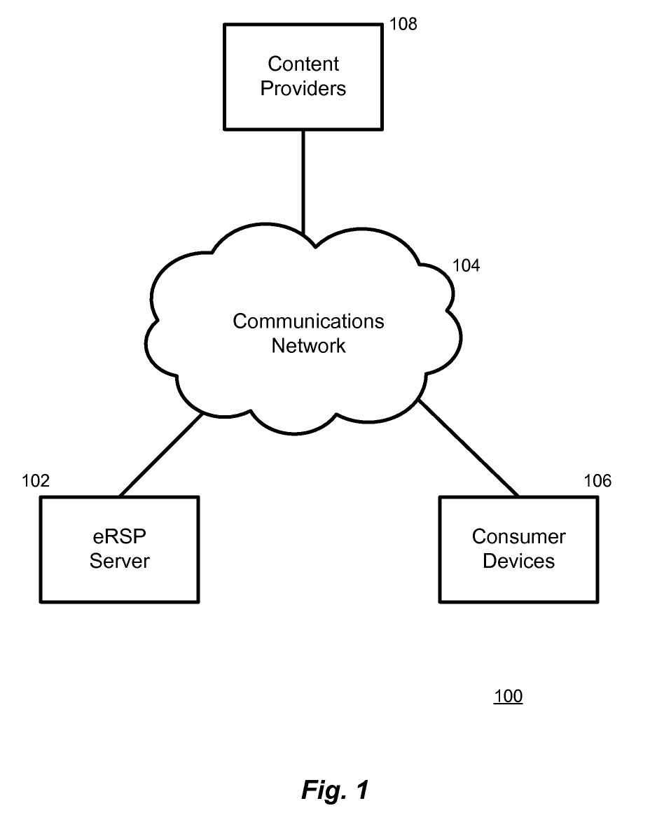

FIG. 1 is a conceptual diagram depicting an eRSP system 100 in accordance with an exemplary embodiment of the present invention. In this example, an eRSP server 102 is in communication with various consumer devices 106 and various content providers 108 over a communications network 104. The eRSP server 102 typically obtains content from the content servers 108, for example, by downloading content from the content providers 108 at various times and/or receiving content streams from the content providers 108. The eRSP server 102 generates rapid serial presentations, for example, in the form of XML-like files. The eRSP server 102 may generate a particular rapid serial presentation in real time (e.g., as streamed content is received) or may generate a rapid serial presentation on demand (e.g., upon receiving a request for specified information from a consumer device 108). The eRSP server 102 may store rapid serial presentations locally and/or may transmit rapid serial presentations over the communications network 104 to the various consumer devices 106. The consumer devices 108 render the rapid serial presentations under user control or otherwise in due course.

It should be noted that the communications network 104 is not intended to represent any particular network, but rather is intended to represent any one or more communications networks by which, or through which, the various devices communicate. The communications network 104 need not be a single contiguous network, but rather may include multiple distinct networks. Thus, the communications network 104 may include public and/or private networks, including the Internet, and may include wireless (e.g., cellular telephone, Blackberry™, Bluetooth™, satellite) or wired (e.g., PSTN, cable modem, DSL) networks capable of conveying information to and from communication devices.

During operation of the eRSP system 100, a consumer device 106 may send a request for specified content to the eRSP server 102. For example, the consumer device 106 may request a particular document, web page, or search term for a database lookup. Provided the specified content is not stored locally at the eRSP server 102, the eRSP server 102 interacts with the appropriate content provider 108 in order to obtain the specified content. Upon receipt of the specified content from the appropriate content provider 108, the eRSP server 102 processes the content and generates an appropriate rapid serial presentation, which is then transmitted to the requesting consumer device 108. The rapid serial presentation is then available to be rendered to the user.

In one exemplary embodiment, the eRSP server 102 will maintain a local copy of a remote database. Specifically, the eRSP server 102 will periodically copy information from the remote database to the local copy in order to remain some degree of synchronization with the remote database. Accesses to the database made by the consumer devices 108 will be satisfied through the local copy of the database.

In essence, then, the eRSP server 102 acts as a hub for sending requests for content, receiving content, receiving preferred viewing methods and rule sets, referencing the content to a dictionary, taking content post reference to a dictionary or dictionaries and applying rule sets, assigning descriptors through a markup language, transmitting files to the consumer devices, saving user information and profiles, saving user feedback, referencing user feedback, engaging consumer device's physiological sensors, etc. In this example, the eRSP server 102 is separate from the consumer devices, but some or all of the eRSP server functionality could be integrated into the consumer device.

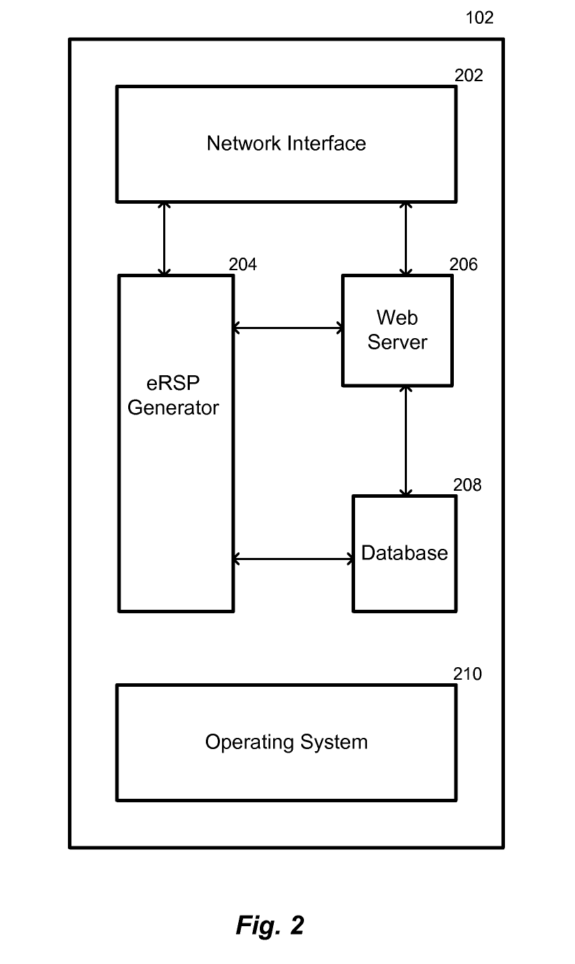

FIG. 2 is a schematic block diagram showing the relevant components of the eRSP server 102 in accordance with an exemplary embodiment of the present invention. Among other things, the eRSP server 102 includes a network interface 202, an eRSP generator 204, a web server 206, a database 208, and an operating system 210.

The web server 206 operates as the interface through which users can personalize operation of the eRSP generator 204 (e.g., by updating user profiles and selecting rule sets) and obtain content in the form of rapid serial presentations. To that end, the web server 206 receives requests from the consumer devices 108 via the network interface 202, obtains and stores content (if not already available locally), invokes the eRSP generator 204 to convert content into rapid serial presentations, and distributes completed rapid serial presentations to the consumer devices 108 via the network interface 202. The web server 206 stores information (such as user profiles and content) in the database 208 for use by the eRSP generator 204. The web server 206 may also receive feedback information from the consumer devices 108 regarding user preferences, actions, and measured behaviors and store such information in the database 208 for use by the eRSP generator 204.

The eRSP generator 204 is responsible for converting content into rapid serial presentations. To that end, the eRSP generator 204 typically obtains content from the database 208 and converts the content into rapid serial presentation. As part of the conversion process, the eRSP generator 204 may access dictionaries, rule sets, and/or user profiles stored in the database 208. The eRSP generator 204 stores completed rapid serial presentations in the database 208 for transmittal to the consumer devices 108 by the web server 206.

The database 208 stores content, dictionaries, rule sets, user profiles, completed rapid serial presentations, and other pertinent information for use by the eRSP generator 204 and web server 206. The database 208 may be integral to the eRSP server 102 or be externally attached to the eRSP server 102 (e.g., an external disk drive, a storage area network, or network-attached storage).

The network interface 202 provides a conduit through which the eRSP generator 204 and the web server 206 send and receive information over the communications network 104. The network interface 202 may include a LAN interface, a WAN interface, or other type of interface.

The operating system 210 is an appropriate operating system that provides the general operating environment for the eRSP server 102. The operating system 210 and related software runs on an appropriate processor (e.g., Windows XP running on an Intel processor). The server may utilize a 64 bit dual processor for enhanced performance, although the present invention is not limited to any particular operating system or processor. It is envisioned that the server will include at least 2 GB of RAM and at least 500 GB of storage (e.g., 250 GB for live database and at least 250 GB for maintenance, back-ups, and dumping of the database), although, again, the present invention is not limited to any particular types or amounts of memory.

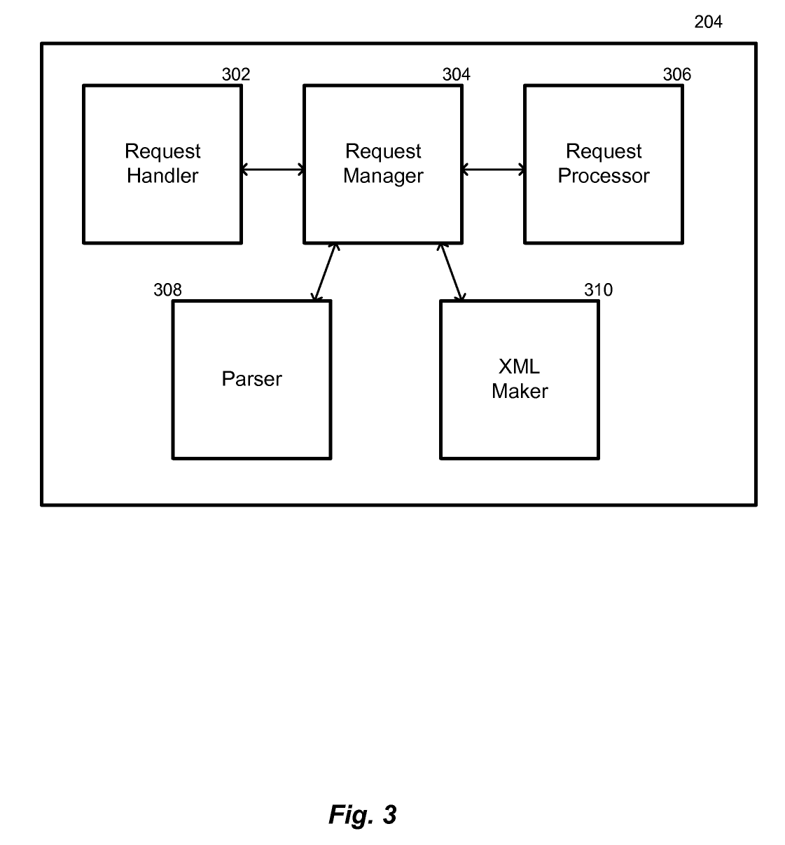

FIG. 3 is a schematic block diagram showing the relevant components of the eRSP generator 204 in accordance with an exemplary embodiment of the present invention. Among other things, the eRSP generator 204 includes a request handler 302, a request manager 304, a request processor 306, a parser 308, and an XML maker 310.

The request handler receives incoming request, gets the request's body of information, and sends the information to the request manager. When the request manager processes the information, it then sends the information with XML tags to the request handler, which sends the tagged information to the client. The request manager receives content and parses it into XML with the accompanied processor requests; the request manager also authenticates the request. The request processor(s) receives the processor requests and sends the operations with the request parameters to the processor, which generates a response. The XML parser receives contents and generates processor requests according to the defined scheme. The XML maker reverses the processes of the XML parser, receives processor requests, and generates the XML contents.

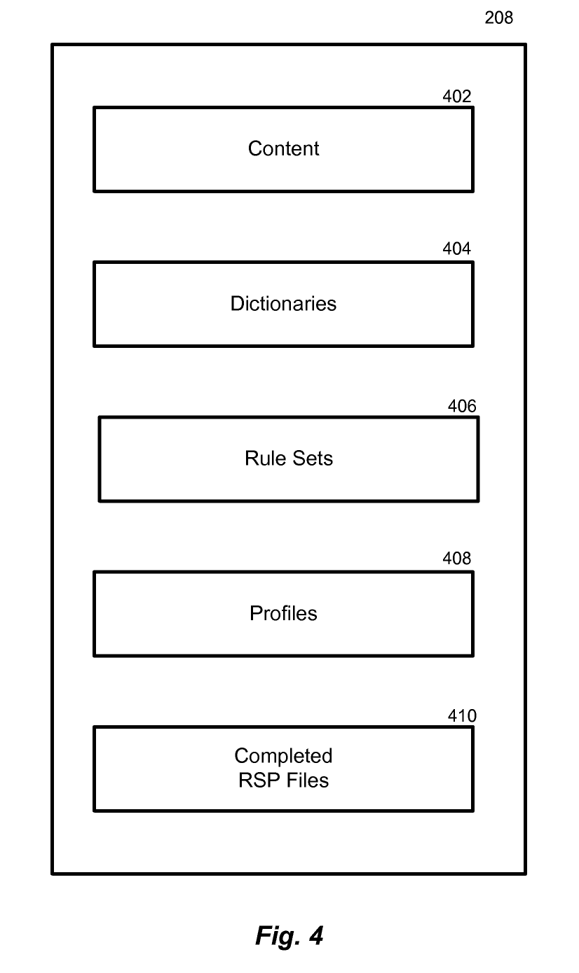

FIG. 4 is a schematic block diagram showing possible contents of the database 208 in accordance with an exemplary embodiment of the present invention. Among other things, the database 208 includes locally-stored content 402 (e.g., a local copy of a remote database), one or more dictionaries 404, various rule sets 406, user profiles 408, and completed eRSP files 410.

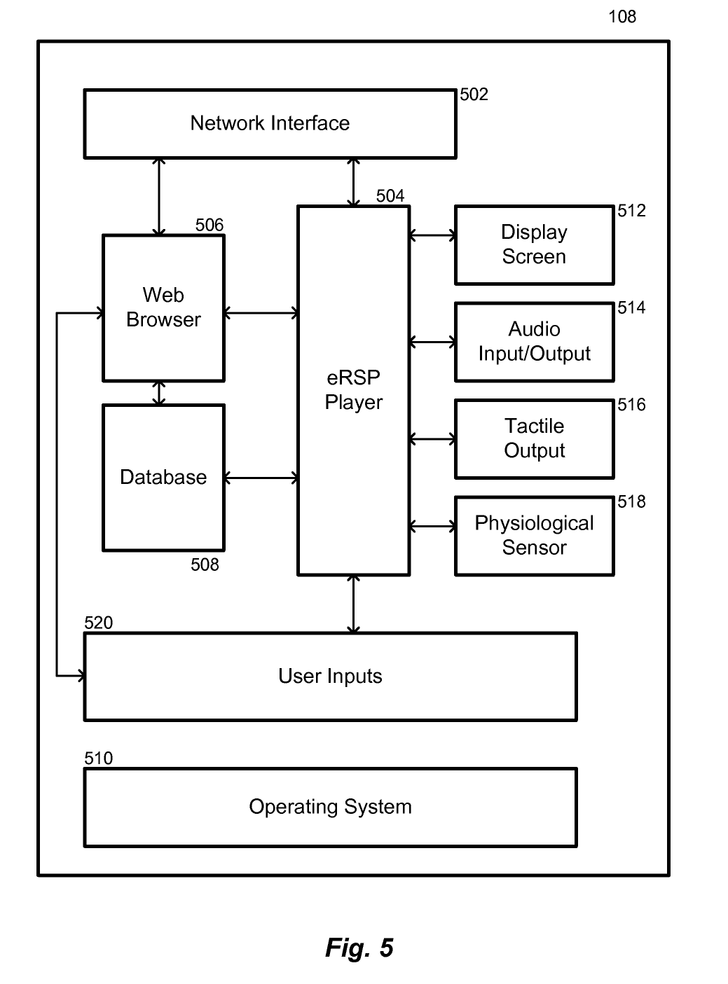

FIG. 5 is a schematic block diagram showing the relevant components of consumer device 108 in accordance with an exemplary embodiment of the present invention. Among other things, the consumer device 108 includes a network interface 502, an eRSP player 504, a web browser 506, a database 508, an operating system 510, a display screen 512, an optional audio input/output 514, an optional tactile output 516, an optional physiological sensor 518, and user inputs 520.

The web browser 506 provides the main interface to the eRSP server 102. Specifically, the web browser 506 sends requests to the eRSP server 102 and receives back completed rapid serial presentations from the eRSP server 102 over the network interface 510. The web browser 506 stores rapid serial presentations in the database 508 for access by the eRSP player 504. The web browser 506 also forwards other information, such as feedback information, to the eRSP server 102. The web browser 506 invokes the eRSP player 504 to render a rapid serial presentation.

The eRSP player 504 renders a rapid serial presentation by interpreting the various targets and descriptors and generating appropriate output signals to the display screen 512, the optional audio output 514, and the optional tactile output 516. The eRSP player 504 also receives various input signals via the user inputs 520, the optional audio input 514, and the physiological sensor 518 for, among other things, controlling the rendering of the rapid serial presentation. For example, the user may manually slow down, speed up, pause, or rewind the rendering, or the eRSP player 504 may automatically adjust the rendering based on analysis of inputs from the physiological sensor 518.

The network interface 502 may be a wireless interface or other interface through which the consumer device 502 communicates with the eRSP server 102.

The operating system 510 is an appropriate operating system that provides the general operating environment for the consumer device 108.

The following is a sample request from the consumer device 108 to the eRSP server 102 for an exemplary database search (e.g., in Wikipedia™):

```
    <Request>
        <Session>876ASDFSAF67969ASDF</Session> <!-Optional -->
        <Operation id=“1” name=“searchText” title=“monkey”
startIndex=“1” itemCount=“5” />
        <Operation id=“2” name=“getLinks” title=“monkey”
startIndex=“1” itemCount=“5” />
        <Operation id=“3” name=“getReferences” title=“monkey”
startIndex=“1” itemCount=“5” />
        <Operation id=“4” name=“getImages” title=“monkey”
startIndex=“1” itemCount=“5” size=“100×100” />
        <Operation id=“5” name=“Today's featured image”/>
        <!-- and so forth -->
    </Request>
```

In the above request, first it is confirmed that the user is connected to the server and is ready for a search. Once a search term is entered and sent to the server, the client requests a search in each of the different areas of the database. The text is searched for finding confirmed entry titles and additional entries with the search term title present in the content. The Link title is searched to find a matching database entry in the Links, then the references pages are search, then images which are resized to the screen size of the general consumer device the client is operating on, and then additional categories such as entry title, featured articles, etc.

The following is a sample response from the eRSP server 102 to the consumer device 108 for the above database search:

```
    <Response>
        <Session>876ASDFSAF67969ASDF</Session> <!-Optional -->
        <Operation id=“1” name=“searchText” title=“monkey”
startIndex=“1” itemCount=“5” >
            <Item index=“1” title=“monkey” description=“” />
            <Item index=“2” title=“monkey” description=“” />
            <Item index=“3” title=“monkey” description=“” />
            <Item index=“4” title=“monkey” description=“” />
            <Item index=“5” title=“monkey” description=“” />
        </Operation>
        <Operation id=“2” name=“getLinks” title=“monkey”
startIndex=“1” itemCount=“5” >
            <Link index=“1” url=“” />
            <Link index=“2” url=“” />
            <Link index=“3” url=“” />
            <Link index=“4” url=“” />
            <Link index=“5” url=“” />
        </Operation>
        <Operation id=“3” name=“getReferences” title=“monkey”
startIndex=“1” itemCount=“5” >
            <Reference index=“1” paramsHere=“” />
            <Reference index=“2” paramsHere=“” />
            <Reference index=“3” paramsHere=“” />
            <Reference index=“4” paramsHere=“” />
            <Reference index=“5” paramsHere=“” />
        </Operation>
        <Operation id=“4” name=“getImages” title=“monkey”
startIndex=“1” itemCount=“5” size=“100×100”>
            <Image index=“1” >binary data here</Image>
            <Image index=“2” >binary data here</Image>
            <Image index=“3” >binary data here</Image>
            <Image index=“4” >binary data here</Image>
            <Image index=“5” >binary data here</Image>
        </Operation>
        <Operation id=“5” name=“today's feature image” >
            <!-- set params on our behalf -->
        </Operation>
        <!-- and so forth -->
    </Response>
```

The above response provides confirmed matches from the search of the different areas of the database. In this example, the response includes matching article titles, links, references, images in binary to be displayed and resized for the client screen, and a feature image. Additional search results may also be included from other areas of the database.

### Generating Rapid Serial Presentations

In embodiments of the present invention, various techniques may be used alone or in combination to generate rapid serial presentations with improved characteristics that are expected to provide a more comfortable experience to the consumer.

In certain embodiments, one or more dictionaries may be referenced in order to obtain linguistic and psycholinguist attributes for various terms. Psycholinguist attributes, in particular, allow for the generation of targets and corresponding descriptors in a manner that takes into account how people actually process particular words.

In other embodiments, various rule sets may be used to generate the targets and related descriptors. Rule sets may be customized for specific consumers and/or specific types of content, and may relate to values obtained from a dictionary so as to dictate how the dictionary information is to be applied. Thus, different dictionaries and rule sets may be applied to different consumers, different types of content, and even different sections of content.

In still other embodiments, the content may be analyzed syntactically and/or semantically in order to generate targets and related descriptors that take into account the way words are used in the content. Thus, for example, the same word may be treated differently in two different contexts.

In still other embodiments, consumer profiles may be used to further customize a rapid serial presentation for a particular user. Consumer profiles may include such things as preference information provided by the consumer (e.g., preferred reading rate, dictionary, rule set, etc., which may further be specified for different types of content), information collected indirectly (e.g., by analyzing consumer activities such as web browsing, click-through rates, bounce rates, search patterns, or usage patterns), and feedback information characterizing consumer experience with rapid serial presentations (e.g., information relating to a latent physiological condition of the consumer monitored during rendering of the rapid serial presentation and information relating to consumer inputs during rendering of the rapid serial presentation). Generation of targets and corresponding descriptors may take the consumer profile information into account in order to tailor the rapid serial presentation for the consumer.

In yet other embodiments, the order in which content is presented to the consumer may be determined according to the context for the rapid serial presentation and the targets and corresponding descriptors may be generated based at least in part on the determined order and the context. For example, an article about a particular medication might have sections relating to the class of drug, the drug's history (e.g., who discovered it and how), approved uses, contraindications, dosing, side effects, drug interactions, signs of drug overdose, and overdose remedies. In response to a general query about the particular medication, a rapid serial presentation might begin with the approved uses, contraindications, and dosing information followed by the other information. In response to a query received from a poison control center, however, a rapid serial presentation might begin with signs of drug overdose and overdose remedies. Such contextual processing is likely to improve the comfort level of the consumer because the consumer will not need to read or fast forward through irrelevant information.

Thus, in various embodiments of the present invention, targets and corresponding descriptors may be generated using at least one of a selected dictionary, a selected rule set, syntactic and/or semantic analysis, a consumer profile, and delivery order determined based on context. Dictionaries and rule sets may be specified by the consumer (e.g., via the consumer profile or at the time of requesting information) or selected according to the type of content (which may be determined, for example, by analyzing the content or inferring the type of content from a search term provided by the consumer).

After targets and corresponding descriptors have been generated for a rapid serial presentation, a user may be given an opportunity to manually adjust the rapid serial presentation. Specifically, an authoring tool may be provided to enable the user to modify the sequence of targets and corresponding descriptors. Such modification may include such things as converting multiple targets into a single target, converting a single target into multiple separate targets, defining/modifying characteristics for outputting a target (e.g., changing the amount of time a target is to be displayed), inserting an additional target (e.g., blank screen, audio component, video component, tactile component), and removing a target.

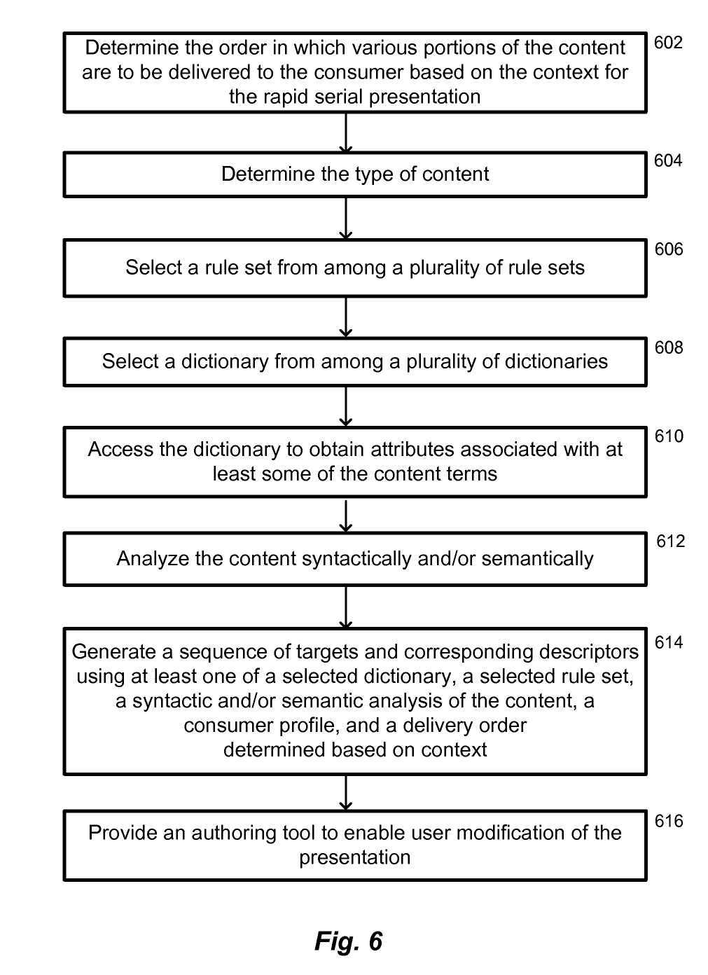

FIG. 6 is a logic flow diagram for generating targets and corresponding descriptors in accordance with exemplary embodiments of the present invention. In block 602, the order in which various portions of the content are to be delivered to the consumer may be determined based on the context for the rapid serial presentation. In block 604, the type of content may be determined. In block 606, a rule set may be selected from among a plurality of rule sets. In block 608, a dictionary may be selected from among a plurality of dictionaries. In block 610, the dictionary may be accessed to obtain attributes associated with at least some of the content terms. In block 612, the content may be analyzed syntactically and/or semantically. In block 614, a sequence of targets and corresponding descriptors may be generated using at least one of a selected dictionary, a selected rule set, a syntactic and/or semantic analysis of the content, a consumer profile, and a delivery order determined based on context. In block 616, an authoring tool may be provided to enable user modification of the presentation.

It should be noted that embodiments of the present invention may incorporate one or more of the elements represented by blocks 602, 604, 606, 608, 610, and 612 for generating a sequence of targets and corresponding descriptors for a rapid serial presentation. For example, a rule set may be used without a dictionary, a dictionary containing psycholinguistic information may be used without a rule set, dictionaries and/or rule sets may be selected with or without determining the type of content, and so on. Thus, embodiments of the present invention can include many different combinations and permutations of those elements.

### Dictionaries

Oquist, Adaptive Rapid Serial Visual Presentation (2001), which was incorporated by reference above, discloses two different algorithms for presenting text on a small screen using an adaptive RSVP technique, namely a content adaptive algorithm and a context adaptive algorithm. The content adaptive algorithm uses number of words, number of characters, average word length including delimiters, and speed (in words per minute) to compute variable exposure time. The context adaptive algorithm uses the time from the content adaptation algorithm, word frequencies of the words in a chunk, and the position of the chunk in sentences being exposed. In the context adaptive algorithm, each word in a chunk is looked up in a lexicon of word frequencies and a weight is assigned to each word accordingly such that, if the word is common, it receives a weight lower than one (i.e., it is displayed for a shorter amount of time) and if it is rare or not in the lexicon, it receives a weight higher than one (i.e., it is displayed for a longer amount of time). The use of a lexicon of word frequencies in the context adaptive algorithm assumes that frequently used words can be processed by consumers more quickly than infrequently used words and so can be displayed for shorter times. In fact, word processing is affected not only by familiarity with words and their position in a sentence, but also by other perceptions (i.e., psycholinguistic attributes). Thus, for example, it may be the case that a particular frequently used word actually requires more processing time than a less frequently used word and so should be displayed for a longer amount of time. Oquist does not take such psycholinguistic attributes into account.

Therefore, in certain embodiments of the present invention, a dictionary containing psycholinguistic information is referenced in order to obtain psycholinguistic attributes for certain terms. Terms are converted into targets and corresponding descriptors using psycholinguistic attributes obtained from the dictionary. The server may maintain multiple dictionaries to be used for different consumers and/or different types of content. The use of psycholinguistic information generally allows better decisions to be made when converting terms into targets and descriptors, resulting in a rapid serial presentation that is better able to present information in a manner that reflects how the consumers are likely to process the information. For example, one could certainly envision a situation in which two words need to be displayed, a first of which has been found to be used more frequently than a second but which also has been found to be less concrete than the other. In such a situation, the use of a linguistic attribute such as “word frequency” alone would indicate that the first word should be displayed for a shorter amount of time than the second, where the additional consideration of the psycholinguistic attribute “concreteness” might suggest that the first word should actually be displayed for a longer amount of time than the second.

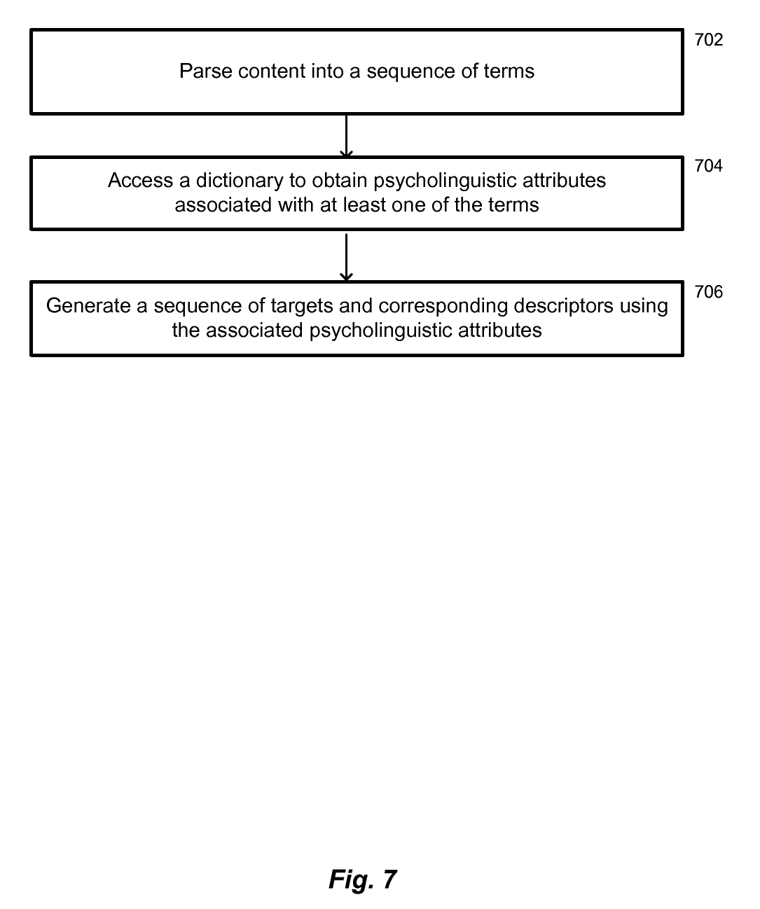

FIG. 7 is a logic flow diagram for use of a dictionary containing psycholinguistic attributes, in accordance with an exemplary embodiment of the present invention. In block 702, the content is parsed into a sequence of terms. In block 704, a dictionary is accessed in order to obtain psycholinguistic attributes associated with at least some of the terms. In block 706, the terms are converted into a sequence of targets and corresponding descriptors using the associated psycholinguistic attributes. The dictionary may be selected from among a plurality of dictionaries based on the type of content, for example, as determined by a search term provided by the consumer or by analyzing the content to determine the type of content. Alternatively, the dictionary may be selected from among a plurality of dictionaries based on a user selection, for example, as provided for in a consumer profile or in an input received from the consumer.

It should be noted that different dictionaries may be applied for different consumers and/or different types of content. A dictionary may be selected by the user or may be selected automatically by the eRSP server 102. The dictionary may be accessed over the communications network 104 or may be maintained locally by the eRSP server 102.

### Rule Sets

In certain embodiments of the present invention, one or more rule sets can be employed when converting terms into targets and corresponding tags. A rule set is a file with a list of rules that are applied to the variables assigned to entries in a dictionary or content. A rule set offers the type of term or the precise term and the assigned outcomes that will be assigned to that term if it arises within a piece of content. Rule sets can offer general categories like familiarity ratings as well as number of syllables, context of the entry, etc. When there are multiple rules for one term, where each rule assigns an outcome, a priority of rules is referenced to find which rule within the rule set takes priority.

As mentioned above, multiple rule sets may be maintained, with each rule set configured for a particular user and/or type of content. The rule set to be applied to a given content may be specified by the user, for example, as a user input or in a user profile. Alternatively, the rule set may be selected by the eRSP server 102 based on the type of content, for example, as determined by a search term provided by the user or an analysis of the content itself.

Rule sets may have different levels of granularity, e.g., rules for each word, rules for inter-sentence interactions, etc. Rule sets may include rules for model sentences or phrase structures such that text that matches a particular model may be handled according to the corresponding rule. When rule sets are used in conjunction with dictionaries, the rule sets typically refer to values or ranges of values for attributes that can be obtained from the dictionary. For example, a rule set may have a rule based on the psycholinguistic attribute “concreteness” (e.g., if concreteness <x, display word for longer amount of time; if concreteness >=x, display word for shorter amount of time). Rule sets may include rules/filters for grouping words together and for determining the amount of time such groups of words should be displayed (e.g., computed from the amount of time each individual word would be displayed). Special rules (or separate rule sets) may be provided to handle such things as typographical errors, acronyms, words of a different language, and other anomalies encountered in the content.

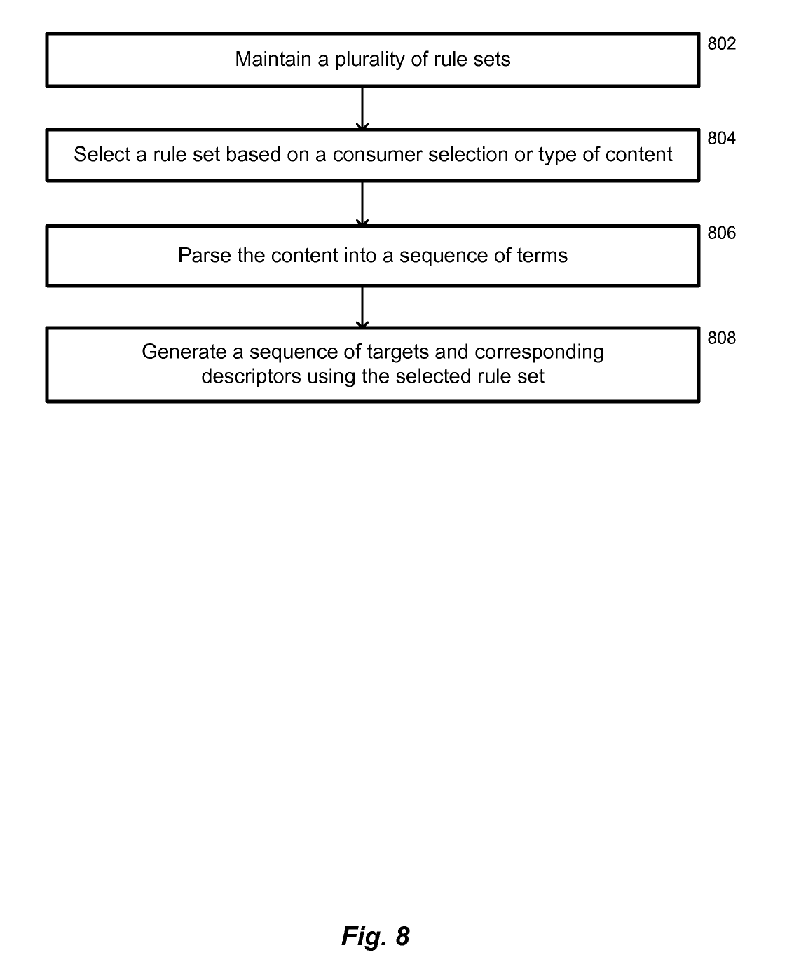

FIG. 8 is a logic flow diagram for use of rule sets, in accordance with an exemplary embodiment of the present invention. In block 802, a plurality of rule sets is maintained, where each of the rule sets defines rules for generating targets and descriptors for a different type of content. In block 804, a rule set is selected from among the plurality of rule sets based on a consumer selection or the type of content. In block 806, the contents are parsed into a sequence of terms. In block 808, the terms are converted into a sequence of targets and corresponding descriptors using the selected rule set.

The following is a list of valid filters for rules.ini that accept an integer value, in accordance with an exemplary embodiment of the present invention:

### Minimum Letters

### Minimum Phonemes

### Minimum Syllables

### Minimum Kucera Francis Frequency

### Minimum Kucera Francis Categories

### Minimum Kucera Francis Samples

### Minimum Thorndike Lorge Frequency

### Minimum Brown Verbal Frequency

### Minimum Familiarity

### Minimum Concreteness

### Minimum Imagery

### Minimum Colerado Meaningfulness

### Minimum Pavio Meaningfulness

### Minimum Age Of Acquisition

### Maximum Letters

### Maximum Phonemes

### Maximum Syllables

### Maximum Kucera Francis Frequency

### Maximum Kucera Francis Categories

### Maximum Kucera Francis Samples

### Maximum Thorndike Lorge Frequency

### Maximum Brown Verbal Frequency

### Maximum Familiarity

### Maximum Concreteness

### Maximum Imagery

### Maximum Colerado Meaningfulness

### Maximum Pavio Meaningfulness

### Maximum Age Of Acquisition

The following is a list of additional Filters for rules.ini, in accordance with an exemplary embodiment of the present invention:

### Word Type

Valid Values: ‘None’, ‘2’, ‘Q’ or ‘2,Q’ (without the quotes)

For more information about the meaning of these values, consult the MRC2 Dictionary Documentation.

### Part of Speech Filter

A comma separated list of one or more of the following values:

Noun

Adjective

Verb

Adverb

Preposition

Conjunction

Pronoun

Interjection

Past Participle

Other

### Pronouncing Dictionary Filter

A comma separated list of one or more of the following values:

Noun

Adjective

Verb

Other

### Alphasyllable Filter

A comma separated list of one or more of the following values:

Abbreviation

Suffix

Prefix

Hyphenated

Multi Word

### Status Filter

A comma separated list of one or more of the following values:

Dialect

Alien

Archaic

Colloquial

Capital

Erroneous

Nonsense

Nonce Word

Obsolete

Poetical

Rare

Rhetorical

Specialised

Standard

Substandard

varientPhoneme

Valid Values One of ‘None’, ‘B’, ‘0’, ‘B,O’ (without the quotes)

For more information about the meaning of these values, consult the MRC2 Dictionary Documentation.

writtenCapitalised

Valid Values: ‘True’ or ‘False’ (without the quotes)

irregularPlural

Valid Values: ‘None’, or any combination of the letters ‘Z’, ‘Y’, ‘B’, ‘N’, ‘P’ (without the quotes).

For more information about the meaning of these values, consult the MRC2 Dictionary Documentation.

The following is a list of formatting specifiers for rules.ini, in accordance with an exemplary embodiment of the present invention:

### @Bold=True

Will display the matching word in bold.

@Color=colorstring
Sets the display color of the word to the specified colorstring. The colorstring can be any valid HTML 4 color specification.

Examples of valid values: Red, Green, Blue, Aqua, Black, #ffeedd

### @Delay=n

Sets the display delay of the word to the floating-point value n. Generally, for every x, ‘@delay=x’ is equivalent to ‘@speed=1/x’, and vice versa.
   @Font=fontname
Will display the matching word using a font with the given fontname.

### @Italics=True

Will display the matching word in Italics Style.

### @Size=n

Will display the matching word in a font size of n. Valid values are between 1 and 7.

### @Speed=n

Sets the display speed of the word to the floating-point value n.

### @Underline=True

Will display the matching word underlined.
   @Align=aligntype
Specifies text alignment within the display window. Possible values include left, right, center, justify.

The following is a list of valid values for ‘Additive Delay Rule’ in [Default] in rules.ini, in accordance with an exemplary embodiment of the present invention:

rightmost

Takes the delay value of the rightmost word.

leftmost

Takes the delay value of the leftmost word.

limit: n

Takes the minimum between the floating-point value ‘n’ and the sum of the delays of all the words.

limit: max * n

Equivalent to ‘limit x’ where x=n * (maximum amongst the delay values)
For instance, if the delay list of a set of three words is [2, 4, 5], using the Additive Delay Rule of ‘limit: max * 1.5’ will be equivalent to ‘limit: 7.5’ (5 is the maximum amongst the delay values, and 5 * 1.5=7.5).
   subtract: n2, n3, n4, . . . .
For a delay list of length l, will use the following additive delay value calculation: ((sum of delays)−n1)
For instance, using the Additive Delay Rule of ‘subtract: 1, 1.5’ for the delay list [2, 2.5, 3], the length of the delay list is 3, so the subtracted value will be n3=1.5, and the calculated delay value will be:

(2+2.5+3)−1.5=6

multiply: n2, n3, n4, . . . .
For a delay list of length l, will use the following additive delay value calculation: ((sum of delays)*n1)
For instance, using the Additive Delay Rule of ‘multiply: 0.8, 0.75, 0.7’ for the delay list [2, 2.5, 3], the length of the delay list is 3, so the multiplier will be n3=0.75, and the calculated delay value will be:

(2+2.5+3)*0.75=5.625

The following is a first exemplary rule set. The default set of rules specifies guidelines for the minimum (12) and maximum (16) number of letters to be displayed as a unit (if these guidelines cannot be met, then the eRSP server 102 will create a target a close as possible to those guidelines), specifies the maximum additive delay value to be assigned to a word grouping to be no more than two times the display speed associated with the word having the largest display speed, and specifies the default font size to be six. The next set of rules specifies that words that are determined to be in the category of “dialect” are to be displayed in black with a priority over other color applications. The next set of rules specifies that nouns are to be displayed in blue and are to be assigned a display speed of 0.85 times the default value of one. The next set of rules specifies that verbs and adverbs are to be displayed in red and are to be assigned a display speed of 1.30 times the default value of one. The next set of rules specifies that words having more than five letters are to be displayed in black. The next set of rules specifies that adjectives are to be displayed in bold and are to be assigned a display speed of 1.4 times the default value of one. The final set of rules (which has the lowest priority) specifies that verbs are to be underlined.

| | |
|---|---|
| [default] | |
| Minimum letters = | 12 |
| Maximum letters = | 16 |
| Additive Delay Rule = | limit: max * 2 |
| @size = | 6 |
| [First Rule Name] | |
| Status Filter = | Dialect |
| @Color = | black |
| [Second Rule Name] | |
| Part Of Speech Filter = | Noun |
| @Color = | blue |
| @Speed = | 0.85 |
| [Rule Name 3] | |
| Part Of Speech Filter = | Verb, Adverb |
| @Color = | red |
| @Speed = | 1.30 |
| [Rule Name 4] | |
| Minimum letters = | 5 |
| @color = | black |
| [Rule Name 5] | |
| Part Of Speech Filter = | Adjective |
| @Bold = | true |
| @speed = | 1.4 |
| [Rule Name 6] | |
| Part Of Speech Filter = | Verb |
| @Underline = | True |

Thus, for example, if the above rule set were applied to the word grouping “the quick fox,” the word “the” would be displayed in black and would be assigned the default display speed of 1, the word “quick” would be displayed in bold and would be assigned a display speed of 1.4 (based on [Rule Name 5]), and the word “fox” would be displayed in blue and would be assigned a display speed of 0.85 (based on [Second Rule Name]). The display speeds for the three words add up to 3.25, but the word grouping as a unit would be assigned a display speed of 2.8 (i.e., two times the maximum display speed of 1.4, based on the [default] additive delay rule).

The following is a second exemplary rule set in which display speeds are specified for different parts of speech. Specifically, the display speeds are specified as follows: Noun=1.0, Adjective=1.4, Verb=1.3, Adverb=1.4, Preposition=1.0, Conjunction=0.8, Pronoun=0.9, Interjection=1.5, Past Participle=1.5; other words are displayed at 1.0 but are turned red. This rule set might act as a good base for developing a user profile for a user by adjusting the values to the preferences of the user and the content being displayed.

| | |
|---|---|
| [First Rule Name] | |
| Part of Speech Filter = | Noun |
| @Speed = | 1.0 |
| [Second Rule Name] | |
| Part of Speech Filter = | Adjective |
| @Speed = | 1.4 |
| [Third Rule Name] | |
| Part of Speech Filter = | Verb |
| @Speed = | 1.3 |
| [Fourth Rule Name] | |
| Part of Speech Filter = | Adverb |
| @Speed = | 1.4 |
| [Fifth Rule Name] | |
| Part of Speech Filter = | Preposition |
| @Speed = | 1.0 |
| [Sixth Rule Name] | |
| Part of Speech Filter = | Conjunction |
| @Speed = | .8 |
| @Italics = | True |
| [Seventh Rule Name] | |
| Part of Speech Filter = | Pronoun |
| @Speed = | .9 |
| [Eighth Rule Name] | |
| Part of Speech Filter = | Interjection |
| @Speed = | 1.5 |
| [Ninth Rule Name] | |
| Part of Speech Filter = | Past Participle |
| @Speed = | 1.5 |
| [Tenth Rule Name] | |
| Part of Speech Filter = | Other |
| @Speed = | 1.0 |
| @Color = | Red |

The following is a third exemplary rule set. The default set of rules specifies guidelines for the minimum (12) number of letters in a word grouping, the maximum (16) number of letters in a word grouping, and default font size. The next set of rules specifies that capitalized words are to be underlined and are to be assigned a display speed of 0.85. The next set of rules specifies right-justification of text within the display window. The next set of rules specifies that words having an “age of acquisition” value greater than or equal to twelve be assigned a display speed of 1.5. The next set of rules specifies that single-syllable words are to be displayed in green italics and are to be assigned a display speed of 0.6. The next set of rules specifies that the second word in the groupings delay value will be doubled. The final set of rules specifies that a word grouping is to be assigned a display speed equal to the sum of the individual word display speeds minus 0.8.

| | |
|---|---|
| [default] | |
| Minimum letters = | 12 |
| Maximum letters = | 16 |
| @size = | 6 |
| [First Rule Name] | |
| WrittenCapitalised = | True |
| @Speed = | .85 |
| @Underline = | True |
| [Second Rule Name] | |
| @Align = | right |
| [Third Rule Name] | |
| Minimum Age of Acquisition = | 12 |
| @Speed = | 1.5 |
| [Fourth Rule Name] | |
| Maximum syllables = | 1 |
| @Speed = | .6 |
| @Color = | green |
| @Italics = | True |
| [Fifth Rule Name] | |
| Additive Delay Rule = | multiply: 1, 2, 1 |
| [Sixth Rule Name] | |
| Additive Delay Rule = | Subtract: .8 |

The following is a fourth exemplary rule set. The default set of rules specifies guidelines for the minimum (12) number of letters in a word grouping, the maximum (16) number of letters in a word grouping, and default font size. The next set of rules specifies that words having a familiarity values greater than or equal to 500 be assigned a display speed of 0.75. The next set of rules specifies that words having a concreteness value less than or equal to 400 be assigned a display speed of 0.84 (concreteness refers the ability of the user to have a grasp on the content; a not so concrete word might be “truth,” while a word that is more concrete is “pencil”). The next set of rules specifies that words having a familiarity value less than or equal to 499 be assigned a display speed of 1.3. The next set of rules specifies that pronouns are to be assigned a display speed of 1.3. The last set of rules specifies that irregular plurals that are in their plural form (z), singular form (y), or both their singular and plural form (b) are to be displayed in red bold and are to be assigned a display speed of 1.3.

| [Default] | |
|---|---|
| Minimum letters = | 12 |
| Maximum letters = | 16 |
| @size = | 10 |
| [First Rule Name] | |
| Minimum Familiarity = | 500 |
| @Speed = | .75 |
| [Second Rule Name] | |
| Maximum Concreteness = | 400 |
| @Speed = | .84 |
| [Third Rule Name] | |
| Maximum Familiarity = | 499 |
| @Speed = | 1.3 |
| [Fourth Rule Name] | |
| Part of Speech Filter = | Pronoun |
| @Speed = | 1.3 |
| [Fifth Rule Name] | |
| irregularplural = | zyb |
| @Bold = | True |
| @Color = | Red |
| @Speed = | 1.3 |

The following is a fifth exemplary rule set. The default set of rules specifies guidelines for the minimum (12) number of letters in a word grouping, the maximum (18) number of letters in a word grouping, and default font size. The next rule set specifies that words having an imagery value less than or equal to 200 are to be assigned a display speed of 1.8. The next set of rules specifies words having a Brown verbal frequency value less than or equal to 40 are to be assigned a display speed of 1.4. The next set of rules specifies that words having a Thorndike Lorge frequency value greater than or equal to 60 are to be assigned a display speed of 0.9. The next set of rules specifies that words with four syllables or more are to be assigned a display speed of 1.6. The next set of rules specifies that words having a word type value “2,q” are to be displayed in italics. The next set of rules specifies that verbs are to be displayed in blue. The next two sets of rules specify that words characterized as either “nonsense” or “substandard” are to be displayed in red. Such a rule set might be useful, for example, for a non skilled language speaker who needs additional time for infrequently used words, longer words, words that are harder to imagine, and words having a low meaningfulness rating.

| | |
|---|---|
| [Default] | |
| Minimum letters = | 12 |
| Maximum letters = | 18 |
| @size = | 6 |
| [First Rule Name] | |
| Maximum Imagery = | 200 |
| @Speed = | 1.8 |
| [Second Rule Name] | |
| Maximum Brown Verbal Frequency = | 40 |
| @Speed = | 1.4 |
| [Third Rule Name] | |
| Minimum Thorndike Lorge Frequency = | 60 |
| @Speed = | .9 |
| [Fourth Rule Name] | |
| Minimum Syllables = | 4 |
| @Speed = | 1.6 |
| [Fifth Rule Name] | |
| Word Type = | 2, q |
| @Italics = | True |
| [Sixth Rule Name] | |
| Part of Speech Filter = | Verb |
| @Color = | Blue |
| [Seventh Rule Name] | |
| Status Filer = | Nonsense |
| @Color = | Red |
| [Eighth Rule Name] | |
| Status Filter = | Substandard |
| @Color = | Red |

The following is a sixth exemplary rule set that generates a rapid serial visual presentation with regular delays, the same for each target but in 10-20 letter chunks. Also the font size is specified and the font is specified.

| | |
|---|---|
| Minimum letters = | 10 |
| Maximum letters = | 20 |
| @size = | 18 |
| @font = | Times New Roman |

It should be noted that, in exemplary embodiments of the present invention, the display speed (i.e., @Speed) values are relative to a value of one, which indicates a nominal display speed selected by or for the consumer. For example, if @Speed=0.85, then the display speed will be 85% of the nominal display speed; if @Speed=1.25, then the display speed will be 125% of the nominal display speed.

In exemplary embodiments of the invention, the rule sets are “insertable” such that the eRSP generator 102 essentially plugs a selected rule set into the logic and applies the specified rules.

It should be noted that the filters, specifiers, and overall syntax for rule sets described above are exemplary only. The present invention is in no way limited to any particular types or forms of filters, filter values, specifiers, specifier values, syntax, or other rule set specifics. Thus, for example, additional constructs may be included for specifying exact values or ranges of values rather than minimum and maximum values (e.g., rather than, or in addition to “minimum concreteness” and “maximum concreteness,” could have constructs for “concreteness=n” and/or “concreteness=[n1,n2],” where n1 is a lower bound for a range and n2 is an upper bound for the range). Furthermore, mechanisms may be defined for implicitly or explicitly defining priorities among various rules.

### Authoring Tool

An authoring tool may be used to create or modify a rapid serial presentation. In order to create a rapid serial presentation, the authoring tool generally parses the content into a sequence of terms and associates each term with a default set of characteristics. The terms are presented to the user, and the user is given the ability to change various characteristics of the presentation, such as word groupings and display characteristics. The user is also given the ability to add additional targets to the presentation, for example, audio components, video components, image component, tactile components, or blank screens. Similarly, the authoring tool may be presented to the user after generation of a sequence of targets and corresponding descriptors in order to provide the user with an opportunity to manually edit the presentation.

### Voice-to-Text

Wong, Visible Language Workshop paper, which is hereby incorporated herein by reference in its entirety, discusses dynamic visual treatment of text as an extension of written language. Wong defines “typography” as the visual treatment of written language to enrich visual communication. Wong recognizes that a range of emotional qualities and tones of voice can be conveyed through treatment of the typographical form (e.g., typeface, weight, color) and also recognizes that electronic media extends the expressive possibilities by enabling typographic forms to change dynamically in size, color, and position according to a writer's expression or a reader's interaction in real time. A software tool called “exPress” and an associated scripting language that allows manipulation of typographic attributes, such as size, weight, position, transparency, color, dynamic typographic changes (e.g., a word grows in size or moves over time) are described. The exPress tool allows control over the speed at which the information is presented such that, for example, two tones of voice can be visually represented using different rhythms.

In theory, Wong's exPress tool allows a user to generate a RSVP that mimics the way in which text would be verbalized. In practice, however, it is very difficult to generate such a RSVP. Therefore, in certain embodiments of the present invention, textual content is read and recorded, the recorded reading is analyzed to identify verbal characteristics (e.g., voice inflections, word breaks, decibel strengths, and syllable stresses), the textual content is parsed into a sequence of terms, and the a sequence of targets and corresponding tags is generated from the terms using the verbal characteristics, so that a rapid serial visual presentation of the targets will mimic at least in part the verbal characteristics. In some cases, people say words quicker verbally than can be sensed visually as a comfortable reading experience. For such overly short words, the eRSP server 102 would generally adjust the rate of visual presentation to complement reading processes in the rapid serial presentation.

One possible use for such a voice-to-text technique is for converting verbal messages (e.g., voice mail) into a textual message for a portable consumer device.

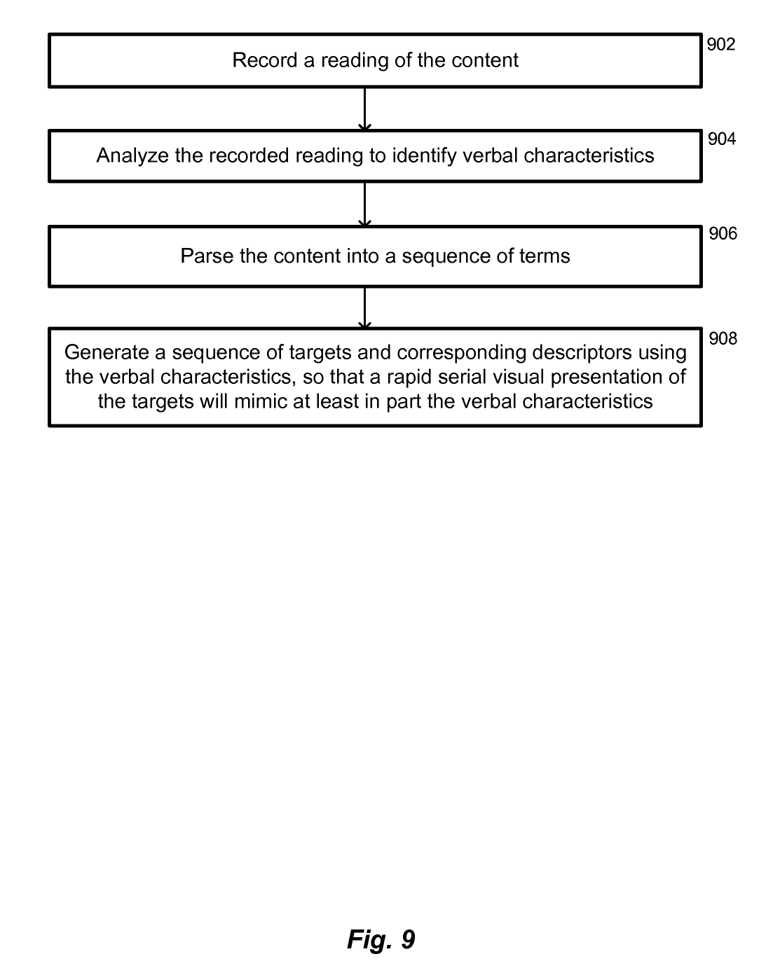

FIG. 9 is a logic flow diagram for voice-to-text in accordance with an exemplary embodiment of the present invention. In block 902, a reading of the content is recorded. In block 904, the recorded reading is analyzed to identify verbal characteristics. In block 906, the content is parsed into a sequence of terms. In block 908, a sequence of targets and corresponding descriptors is generated using the verbal characteristics, so that a rapid serial visual presentation of the targets will mimic at least in part the verbal characteristics.

### Biofeedback

Akervall, Smart Bailando Eye controlled RSVP on handhelds (2002), which was incorporated by reference above, discloses an RSVP player that is controlled in part by eye position. A pair of cameras monitors the position of the user's face and eyes and dynamically controls the RSVP presentation based on eye movements. For example, if the user looks away from the screen, the rate of text presentation may be temporarily reduced. As discussed in the article, monitoring eye position can be very difficult because it relies on two cameras and also relies to a large extent on the user remaining stationary. While some consumer devices include a single camera, very few (if any) include two cameras, and it would generally be impractical to incorporate two cameras into most consumer devices due to both space and cost constraints. Thus, eye control of RSVP presentations is not practical in many instances.

Therefore, in certain embodiments of the present invention, a physiological sensor is incorporated into the consumer device. The physiological sensor can be used to monitor a latent physiological condition of the consumer, such as heart rate, blood flow, brain waves, electronic signals, galvanic skin response, breathing, temperature, and other latent physiological conditions. The physiological condition is analyzed in order to infer an emotional state of the consumer with regard to the presentation. The physiological condition and/or information about the inferred emotional state may be used locally by the consumer device 108 to dynamically adjust the presentation and/or may be sent back to the eRSP server 102 for use in generating subsequent presentations for the consumer.

In an exemplary embodiment, the physiological sensor may include an infrared transducer onto which the consumer places a finger. The infrared transducer is typically positioned at a location where one of the consumer's fingers would normally be placed during normal operation of the consumer device (e.g., while holding a cell phone or PDA). The infrared transducer may be used to monitor the consumer's heart rate, blood flow, etc. Alternatively or additionally, the sensor may include one or more electrodes for generating and/or measuring electrical signals, such as for measuring galvanic skin response of the consumer. Alternatively or additionally, the sensor may include an antenna for monitoring brain waves or other electromagnetic activity emanating from the consumer. Alternatively or additionally, the sensor may include a thermometer for measuring the consumer's temperature.

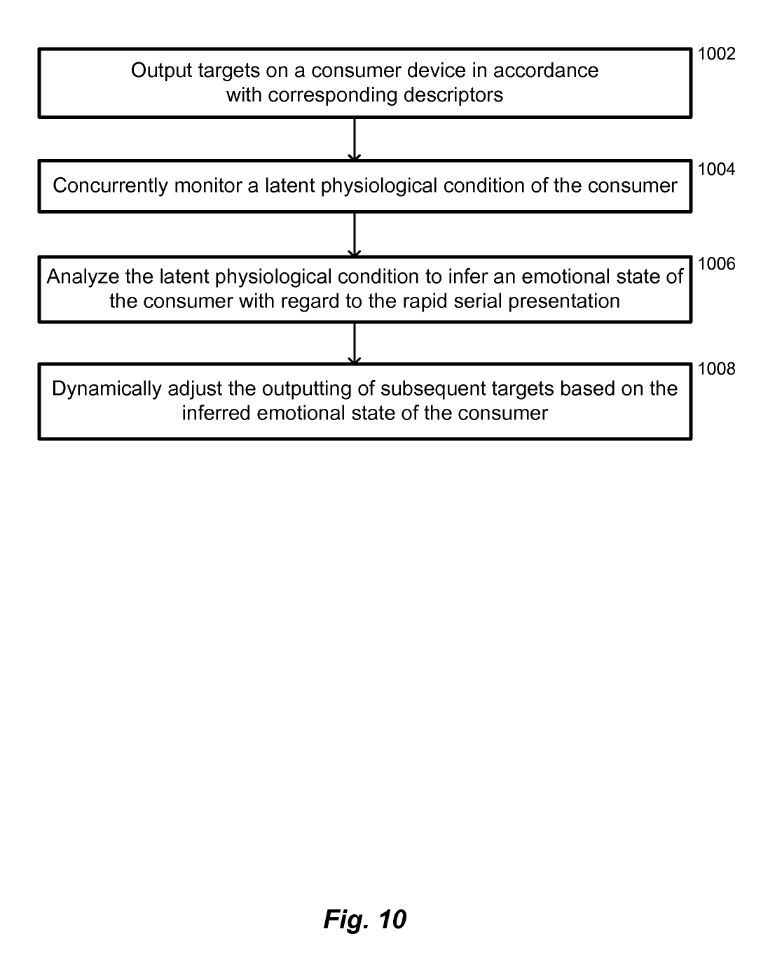

FIG. 10 is a logic flow diagram for biofeedback in accordance with an exemplary embodiment of the present invention. In block 1002, targets are output on a consumer device in accordance with corresponding descriptors. In block 1004, a latent physiological condition of the consumer is monitored concurrently. In block 1006, the latent physiological condition is analyzed to infer an emotional state of the consumer with regard to the rapid serial presentation. In block 1008, the outputting of subsequent targets is dynamically adjusted based on the inferred emotional state of the consumer. In block 1010, feedback information relating to the latent physiological condition may be transmitted to the presentation server for use in generating a subsequent rapid serial presentation for the consumer.

Embedded eRSP Players

In certain embodiments of the present invention, an eRSP player is embedded in a web browser such as, for example, Microsoft's Internet Explorer™ or Apple's Safari™. In such embodiments, the consumer generally uses the web browser to find information of interest. The user might then highlight the portion to be displayed using eRSP and then either right-click to access an eRSP control screen or click on a preview button on the menu bar in order to display the text in eRSP mode. An additional button may be included to switch from eRSP into a large screen or full screen view. An eRSP player could similarly be integrated with other applications, such as, for example, word processors (e.g., Microsoft Windows), email applications (e.g., Microsoft Outlook™), spreadsheet applications (e.g., Microsoft Excel™), Adobe Acrobat™ reader, etc. The eRSP player could add audio components, video components, image components, or tactile components to the presentation. The integrated eRSP player may include a mechanism by which the user can switch between rapid serial presentation and traditional textual display modes.

### Embedded Advertisements

As mobile devices become increasingly more common, the sale of content for those mobile devices has also become more popular. One of the fundamental constraints of mobile devices is their screen size. The constraint of screen size has been a barrier to advertisers trying to have their ads viewed on mobile devices. Embodiments of the present invention can provide an opening into this currently untapped market of advertising on mobile devices by incorporating advertisements into rapid serial presentations. For example, a number of advertisements may be included at the beginning of the rapid serial presentation. The price charged to a consumer for a rapid serial presentation could be gated on the number of advertisements the consumer is willing to view. For example, full price might be charged if the consumer is unwilling to view advertisements, while increasing discounts might be provided for increasing numbers of advertisements. Mechanisms can be provided to ensure that the advertisements are actually viewed by the consumer, for example, by requiring the consumer to take an action (e.g., click the mouse) within a predetermined amount of time following an advertisement.

Embodiments may include any of a variety of mechanisms that allow a content provider to confirm that a user has viewed one or more advertisements to some degree of confidence and may require such confirmation, for example, as a condition precedent to providing the user with access to content or otherwise with credit for having viewed the advertisement. Specifically, one or more advertisements may be presented to a user, and feedback information is sent back to the content provider from which the content provider can infer or confirm that the user actually viewed the advertisement(s). The user may be given “credit” for having viewed an advertisement provided the feedback information meets predetermined criteria (e.g., received in a timely manner and/or provides certain types of information and/or includes a sufficient number of “correct” responses, etc.). In the event the user is not credited for having viewed a particular advertisement, the user may be required to view the same advertisement, view a different advertisement, and/or view one or more additional advertisements in order to receive credit and obtain access to the content.

Feedback information may take any of various forms. For example, the user may be required to take some specified action within a specified amount of time (e.g., click a predetermined key or button, click on a specified link, answer one or more questions, provide specified information, complete a puzzle, forward the advertisement to a friend, send a reply or a text message to a specified address, respond verbally, etc.) and/or information about the user or the consumer device (e.g., loudspeaker volume during rendering of the advertisement, movement/inactivity of the consumer device during rendering of the advertisement, a video of the user taken from the consumer device during rendering of the advertisement, confirmation that the entire advertisement was rendered, etc.) may be sent back to the content provider. Feedback information may be required/solicited from the user during and/or following an advertisement, e.g., in the form of a questionnaire, a required action, or otherwise. For example, the user could be presented with a series of questions following rendering of an entire advertisement, or questions could be interspersed within the advertisement.

Thus, upon receiving a request for content from a user, the content provider may present one or more advertisements to the user (perhaps one at a time) and solicit feedback information from the user or otherwise receive feedback information. Upon receipt of the feedback information, the content provider typically analyzes the feedback information to determine whether the feedback information indicates to a satisfactory degree that the user viewed the advertisement(s) or satisfied other requirements for accessing the content (e.g., forwarding the advertisement to a number of friends). If the feedback information indicates that the user viewed the advertisement(s) or satisfied other requirements for accessing the content, then the content provider provides the user with access to the requested content. Otherwise, the content provider may deny access to the content or may require the user to take other actions (e.g., view additional advertisements) in order to access the content.

In certain embodiments, the user may be given an option to either purchase content at full price without viewing any advertisements (or with a required minimum number of advertisements) or may be given an option to receive the content at a discount upon agreeing to view one or more (additional) advertisements. For example, in the event that a user wants to obtain content (e.g., a ring tone) from a web site, the content might be sold for one dollar with no advertisements, but the user could be given the option to view one advertisement to get the content for 66 cents, view two advertisements to get the content for 33 cents, or view three advertisements to get the content for free. Thus, the cost charged for content can vary based on such things as the number or type of advertisements viewed by the user.

Additional or alternative discounts may be provided if the user agrees to take other actions. For example, additional discounts may be provided if the user sends an article or forwards the advertisement to other people. The additional discount may increase based on the number of people to whom the user sends the advertisement. For example, the user might receive no discount (or may receive a nominal discount) for viewing an advertisement but may receive the content free if the user sends the advertisement to three friends. Feedback information could be collected from each person who receives the advertisement, and the user may be given credit only for recipients who view the advertisement or meets other requirements to a satisfactory degree.

Thus, upon receiving a request for content from a user, the content provider may present the user with various options, such as to purchase the content at full price without having to view any advertisements or meet other requirements or to obtain the content at a discount upon viewing one or more advertisements or meeting other requirements. Assuming the user elects to obtain the content at a discount, then the content provider presents the appropriate number of advertisements to the user (perhaps one at a time) and solicits feedback information from the user or otherwise receives feedback information. Upon receipt of the feedback information, the content provider typically analyzes the feedback information to determine whether the feedback information indicates to a satisfactory degree that the user viewed the advertisement(s) or satisfied other requirements for accessing the content (e.g., forwarding the advertisement to a number of friends). If the feedback information indicates that the user viewed the advertisement(s) or satisfied other requirements for accessing the content, then the content provider provides the user with access to the requested content at the discounted price. Otherwise, the content provider may deny access to the content or may require the user to take other actions (e.g., view additional advertisements) in order to access the content.

As in other advertising contexts, the content provider may charge its advertisers for distributing advertisements, e.g., on a per-advertisement basis or otherwise. The collection of feedback information, however, provides additional opportunities for the content provider. For example, the content provider may store and analyze the feedback information, e.g., to evaluate such things as effectiveness of an advertisement, demographics of users, usage patterns of users and other behavioral or contextual attributes, and other marketing information. The content provider may use the results of such analysis for such things as selecting future advertisements and/or content for a particular user or group of users. For example, if the feedback information indicates that a particular user is more interested in consumer electronics than automobiles, then the content provider may send consumer electronics advertisements rather than automobile advertisements to that user in the future. The content provider could also vary the amount it charges to advertisers based on the expected effectiveness of those advertisements as determined using the feedback information. For example, if the feedback information indicates that a particular user is more interested in consumer electronics than automobiles, then the content provider could send consumer electronics advertisements to that user and could charge consumer electronics companies more for those advertisements based on evidence from the feedback information that the advertisement is reaching an interested consumer. Users and/or advertisements could be ranked or rated based on the feedback information received by the content provider. Also, a score could be computed for a user/advertisement combination, and the amount charged to the advertiser for presenting that advertisement to that user could be based on the score.

Thus, the content provider may receive feedback information, store the feedback information, e.g., in a database, and analyze the feedback information. The content provider may determine appropriate advertisements and/or content for a particular user or group of users based at least in part on the feedback information. The content provider may vary the amount it charges to advertisers based at least in part on the feedback information.

Additionally, or alternatively, the content provider may charge the advertisers and/or third parties for access to the feedback information. For example, the content provider may sell the feedback information (or a summary thereof) or may provide access to a database of feedback information. Advertisers and other parties could use the feedback information to evaluate such things as the effectiveness of the advertisements, the demographics of the users, and other marketing information. For example, if users are asked to report the color of the car in an advertisement, then advertisers may want to know if a large percentage of users are answering incorrectly and may be willing to pay for such market research. Advertisers could use the feedback information to revise their advertisements and/or advertising strategies. For example, the feedback information might suggest that certain types of advertisements are effective while others are not effective, and the feedback information might suggest the most effective advertising space for different types of advertisements.

Additionally, or alternatively, the feedback information may be used to select rulesets and/or profiles for generating and/or rendering rapid serial presentations. As described in the related applications incorporated by reference above, rulesets and/or profiles may be used during the generation and/or rendering of rapid serial presentations. Such rulesets and/or profiles may be selected in whole or in part based on feedback information received from a user or group of users and may also be updated based on such feedback information. For example, if the feedback information were to suggest that a particular user is at a certain reading level, then an appropriate ruleset or profile could be selected for rapid serial presentations to that user, and the user's personal profile could be updated accordingly.

Additional eRSP Generation Techniques

As discussed above, different rule sets may be used for different types of content. Content type may be determined in a number of ways, for example, using metadata “tags” embedded in or associated with content (e.g., keywords), using a search term entered by the user to locate the content, or by “pre-searching” or otherwise analyzing the content, to name but a few. An appropriate rule set may be selected dynamically based on the type of content.

As discussed above, various characteristics (e.g., font, font size, font color, etc.) can be specified for targets based on rules in a rule set, and such characteristics can be conveyed in descriptors. Additional rules/descriptors may be included for adding special effects to a rapid serial presentation. For example, special rules and/or descriptors may allow for activation of a dynamic font (e.g., with a certain/specialized animation or fade-in/fade-out). Additionally, or alternatively, special rules and/or descriptors may allow for layering of text/graphics (e.g., behind a word that is displayed, display a different word in a lighter color and/or larger size so as to provide a priming effect for the word).

As a way to help improve the comfort level of the user, the presentation generator may insert additional pauses, for example, at regular intervals (e.g., every X words, every X seconds) and/or at typically pause points (e.g., following a comma or period) to allow time for blinks and for general catch-up by the user. Such additional pauses may be punctuated with a brief message, perhaps displayed at a slightly different location and/or with different characteristics than the main eRSP text (e.g., “blink,” “breath,” “take a break,” etc.). The presentation generator may take various factors, such as sentence length and perceived reading level, into account when generating a presentation.

As discussed above, a dictionary typically does not include a quantified value for each attribute for each term. Therefore, it may be necessary or desirable to fill in missing values over time, for example, based on feedback information received from users, from consumer devices, or from other sources.

Furthermore, additional terms may be added to a dictionary over time. For example, when the presentation generator encounters terms that are not in the dictionary, the presentation generator may add those words to the dictionary or otherwise highlight those terms so that they can be added to the dictionary later if desired. Additionally, or alternatively, user-specific terms may be added to the dictionary for use in generating rapid serial presentations (e.g., organizations, institutions, and individuals may want to have in their databases/dictionaries selected words and values specific to them, such as project names, a specific terms for their operations, and terms of art, to name but a few).

As discussed above, dictionaries may be customized with new or modified types of psycholinguistic attributes reflecting users' experiences with rapid serial presentation. For example, an elicited emotional response attribute could be added to the dictionary. Values for this attribute could be added based on feedback information provided by users or otherwise received, for example, during or following rendering of a rapid serial presentation.

It should be noted that the presentation generator may refer to more than one dictionary when generating a rapid serial presentation. For example, there may be one or more general-purpose dictionaries as well as one or more special-purpose dictionaries, such as, for example, a medical dictionary, a scientific dictionary, and a dictionary containing company or user specific terms, to name but a few.

Different dictionaries may contain overlapping attributes, and the presentation generator may reconcile different attribute values obtained from different dictionaries for a particular term or target (e.g., if one dictionary assigns a high concreteness value to a particular term and another dictionary assigns a low concreteness value to that term, then the presentation generator might, for example, select one of those values, average the values, or ignore the values). The presentation generator may perform such reconciling based on, for example, the context in which the term is used (e.g., if the presentation generator is processing a scientific journal article, then it might weigh values obtained from a scientific dictionary over values obtained from a general-purpose dictionary).

Additionally, or alternatively, different dictionaries may contain different attributes, and the presentation generator may combine or otherwise use the different attributes from the different dictionaries for a particular term or target.

Additionally, or alternatively, the presentation generator may tailor the rapid serial presentation for a specified timeframe. For example, the presentation generator may tailor the presentation to fit within a predetermined timeframe (e.g., a 15 second commercial timeslot). Different eRSP versions of particular content may be created, e.g., for 15 second viewing, 30 second viewing, or 60 second viewing, and the user may be permitted to select which version to view. Alternatively, the user may specify a timeframe, and the presentation may be generated, amended, and/or rendered so as to fit within the specified timeframe.

In certain embodiments, a rapid serial presentation may be transmitted from a server to a remote consumer device over a communication network. Some types of consumer devices, such as cell phones and PDAs, generally communicate over relatively slow communication links. Thus, it can take a substantial amount of time to transmit a large rapid serial presentation (e.g., covering an entire web page, article, or book) from the server to the consumer device, which may be perceived by the user as unacceptable delay. This problem can be exacerbated when the server needs to generate the rapid serial presentation dynamically, since the perceived delay generally will be even longer than if the rapid serial presentation had been previously generated and ready for transmission.

Therefore, rather than generating a rapid serial presentation for a large portion of content and/or transmitting the entire rapid serial presentation to the consumer device as a single unit, the rapid serial presentation may be generated and/or transmitted in segments, and the consumer device may render the segments as they are received rather than waiting for the entire rapid serial presentation to be received before rendering begins. For example, when a user requests content from a server, the server may divide the content into segments (e.g., 300-500 words each) and generate tags and related descriptors one segment at a time. The server could then transmit the tags and related descriptors for one segment while generating the tags and related descriptors for the next segment, and the consumer device could begin rendering without having to wait for the entire rapid serial presentation to be received.

In various embodiments, rapid serial presentations may be transmitted to one or more users, e.g., as notes, broadcasts, or daily reminders.

A server or other device may selectively generate a rapid serial presentation for a particular user, e.g., based on a profile of the user or a parameter in the request for content. For example, the user may be able to specify whether content is to be provided in eRSP form or in, say, HTML form. The server may obtain content from one or more other servers.

As discussed above, tactile signals and other types of alerts may be embedded in rapid serial presentations, for example, to highlight important information. Such tactile/alert signals (e.g., vibration or beep) may be placed so as to immediately precede the information to be highlighted, so that the tactile/alert signal gets the attention of the person in time for the person to pay particular attention to the following information.

Additional eRSP Rendering Techniques

In various embodiments, digital typography may be used to help improve clarity of rapid serial presentation displays on certain types of devices.

The user may be permitted to specify or configure the position of the rapid serial presentation on the screen. For users with macular degeneration or other condition in which there are two focal points, the user may use the first focal point to center the text in an area of the eye that macular generation has not taken effect, allowing the user to read text using a rapid serial presentation technique.

As discussed above, a rapid serial presentation may be “rendered” on a consumer device by serially outputting the sequence of targets on the consumer device in accordance with the presentation characteristics specified by the descriptors. Transitions between targets may utilize special effects, e.g., fade-in and/or fade-out, in order to smooth the transition between targets. For example, when switching from one target to the next, the former may fade out as the latter fades in, and such fading out of the former and fading in of the latter may or may not overlap. Such fade-in and/or fade-out may be specified in the rapid serial presentation itself or may be selectively added by the eRSP player.

Additionally, or alternatively, the eRSP player may pause on certain words (e.g., the first time an unfamiliar word is being displayed, such as, for example, a proper name) and prompt the user for input, such as whether to add the word to a dictionary and/or whether to continue with rendering of the rapid serial presentation. In this regard, the consumer device may include or use one or more dictionaries against which the words of the rapid serial presentation can be compared, and the words may be added to such dictionaries for future reference. The words flagged by users may also be collected and provided to third parties (e.g., by selling the information or providing access to a database containing the information) such as for use in marketing. Furthermore, such words may be sent to the eRSP generator to be added to its dictionaries or otherwise to be used for generating presentations.

Additionally, or alternatively, the eRSP player may automatically adjust rendering based on ambient light conditions. For example, if the user moves from low light to bright light, then the eRSP player may adjust such things as the display background, the display brightness/contrast level, or the speed at which text is being presented, to name but a few. The consumer device may include a light detector (e.g., an in-built camera of a mobile phone, an “electric eye,” etc.) to allow for detection of changes in ambient light levels.

Additionally, or alternatively, the eRSP player may automatically adjust rendering based on ambient noise levels. For example, if the ambient noise level increases, then the eRSP player may adjust the rates at which information is rendered (e.g., display times and/or delay times). If the ambient noise reaches a predetermined threshold, then the eRSP player may slow down or pause the rendering, and the consumer device may resume rendering at an appropriate time (e.g., after the noise level subsides or after waiting a predetermined amount of time) or may prompt the user whether or not to continue. The consumer device may include a microphone to allow for detection of changes in ambient noise levels.

Additionally, or alternatively, the eRSP player may automatically adjust rendering based on physiological conditions of the user. For example, the consumer device may include a heart/pulse monitor or other device for monitoring the user, and the eRSP player may adjust rendering based on information obtained from the monitor and/or send the information to the eRSP generator to be used in generating a rapid serial presentation for the user. The eRSP player may also pause briefly on the current target when a person blinks in order to give the person time to read the target.

As a way to help improve the comfort level of the user, the eRSP player may insert additional pauses, for example, at regular intervals (e.g., every X words or every X seconds, which may be user-configurable), upon encountering an unknown word (e.g., with reference to a dictionary) and optionally providing the consumer an opportunity to add the unknown word to a dictionary, upon detection of a predetermined unacceptable ambient light condition (e.g., a light level above or below a predetermined threshold), upon detection of a predetermined unacceptable ambient noise condition (e.g., a noise level above a predetermined noise level threshold), upon determining that the consumer has not viewed the rapid serial presentation for a predetermined amount of time (e.g., determining that the consumer blinked or looked away from the screen for a predetermined amount of time via an eye monitor such as a built-in camera of the consumer device; detecting a change in consumer pulse rate or absence of a pulse signal via a pulse monitor such as a mechanical sensor, a thermal sensor, an optical sensor, or a galvanic skin response sensor of the consumer device; determining that the consumer is no longer in contact with or operating the consumer device via a contact device such as a mechanical sensor, a thermal sensor, an optical sensor, or a galvanic skin response sensor of the consumer device; or determining that the consumer is outside of a predetermined proximity via a proximity monitor such as an infrared proximity detector of the consumer device), upon detecting a predetermined notification event (e.g., phone call, email message, text message, instant message, voice mail message, missed call message, pop-up message, warning, alert, reminder, timer, low battery warning, or other notifications including, for example, messages received through online dating, social, and professional networks), upon encountering a non-RSP component of the rapid serial presentation (e.g., a chart, a table, a graph, a spreadsheet, a footnote, a comment, a picture, a drawing, a slide show, an object, a video clip, an audio clip, a file, a document, a link, etc.) which may be rendered automatically or under user control at the same location or at a different location, upon the consumer navigating out of an eRSP window or screen area (e.g., to select a link, view an advertisement, or take other action outside of the eRSP display area), and/or at typical pause points (e.g., following a comma or period) to allow time for blinks and for general catch-up by the user. The eRSP player may take various factors, such as sentence length and perceived reading level, into account to determine when to insert additional pauses. The eRSP player may determine when to insert additional pauses based at least in part on consumer preference information (e.g., information provided by the consumer and/or information obtained indirectly). Pause information may be specified by the eRSP generator within the rapid serial presentation (e.g., using special descriptors) or may be determined by the eRSP player (e.g., based on user-configurable parameters).

Such additional pauses may be punctuated with a brief message (e.g., a suggested action for the consumer to perform such as “blink,” “breath,” “take a break;” an advertisement; a link that the consumer can select in order to obtain further information; a link that the consumer can select in order to forward the message to one or more other consumers; a question requiring a response from the consumer; etc.), perhaps displayed at a slightly different location and/or with different characteristics than the main eRSP text.

Such messages may be selected in any of a variety of ways. For example, messages may be selected based on one or more attributes associated with the consumer (e.g., a demographic attribute, a psychographic attribute, and/or a behavioral attribute obtained directly and/or indirectly, for example, using contextual marketing techniques) and/or location of the consumer device. Certain attributes may be obtained from a consumer profile, which may include feedback information obtained previously from the consumer and/or information obtained indirectly (e.g., by monitoring consumer usage patterns).

The message may solicit feedback information from the consumer such as, for example, an unknown word flagged by the consumer, an answer to a question concerning the message, or an opinion concerning the message. As discussed below, advertisements and other information may be displayed on the screen along with the rapid serial presentation. The message may solicit feedback information regarding such advertisement or other information, and certain embodiments may resume rendering only upon receipt of such feedback information.

The eRSP player may automatically continue rendering following such pauses (e.g., after pausing or displaying a message for a predetermined amount of time or after returning to a predetermined acceptable ambient noise or light condition) or may require a user input before continuing rendering (e.g., clicking on a predetermined link, providing an affirmation that the consumer has read and/or forwarded the message, or pressing a predetermined button on the consumer device), and such operation may be user-configurable. The consumer may be given a credit or discount for having read or forwarded a message, and the amount of the credit or discount may be based on the number of other consumers to which the message was forwarded. Rendering may resume from a predetermined or user-configurable place, e.g., from where the rapid serial presentation was paused or from prior to where the rapid serial presentation was paused.

Additionally, or alternatively, the eRSP player may include a mechanism to assess whether the user is still viewing the rapid serial presentation (e.g., based on user inputs, biofeedback, etc.) and automatically pause the rendering if it is determined that the user has not viewed the rapid serial presentation for some period of time. The eRSP player may indicate that the rendering has been paused (e.g., a visual display, and audible sound, a tactile output, etc.) and may prompt the user (e.g., “do you wish to continue?”) and await a user response (e.g., based on a user input, biofeedback, etc.) before continuing the rendering.

In some cases, a user may have a limited amount of time to view a rapid serial presentation. Therefore, the rapid serial presentation may be tailored for an allotted timeframe. For example, different eRSP versions of particular content may be created for 15 second viewing, 30 second viewing, or 60 second viewing, and the user may be permitted to select which version to view. Alternatively, the user may specify a timeframe, and the presentation may be generated, amended, and/or rendered so as to fit within the specified timeframe.

Additionally, or alternatively, metadata may be displayed on the screen along with the rapid serial presentation itself. For example, metadata such as key words tagged to the eRSP content or information about what other users that accessed the same content are reading may be displayed. Such metadata may allow the user to easily navigate to additional content and/or services.

Additionally, or alternatively, the eRSP player may present the user with a list of rulesets/profiles and allow the user to easily switch between different rulesets/profiles (e.g., using arrow keys, page-up/page-down, etc.).

Additionally, or alternatively, the eRSP player may provide the user with the ability to toggle between eRSP mode and regular (text) viewing mode. When in regular viewing mode, the eRSP player might display a full page of text and allow the user to navigate the text as usual. The eRSP player may allow the user to select a word and automatically have the word searched, e.g., by a web search engine.

As discussed above, rapid serial presentations may be particularly advantageous for devices having small display screens. Rapid serial presentation may be employed with wearable consumer devices such as, for example, eyeglasses, eyeglass frames, sunglasses, and goggles, to name but a few. Such wearable consumer devices are sometimes available with in-built display screens and headphones, which could be used for rendering rapid serial presentations.

Rapid serial presentations may also be employed with public display devices such as, for example, billboards, street signs, banners on web pages or in other public media, or store/mall displays, to name but a few. Display screens can also be placed behind mirrors (e.g., in public restrooms) so that the rapid serial presentation is viewable while a person is looking in the mirror. Rapid serial presentations rendered on public displays might use a general-purpose ruleset/profile so as to be readable by a wide range of people (e.g., different ages, different genders, etc.).

The content and/or rendering of rapid serial presentations may be adjusted based on the person who is viewing the presentation. For example, the viewer or the viewer's consumer device could be identified, e.g., by wireless network, RFID, face recognition, or other means, and the content and/or rendering could be adjusted according to the person's profile stored locally or obtained from a remote server over a network. If the actual identity of the viewer cannot be determined, it may be possible to identify a characteristic of the viewer (e.g., male vs. female, teen vs. parent, etc.) and apply a corresponding profile/ruleset to adjust content and/or rendering (e.g., if teen, display with cool graphics, if parent, pause longer on words such as “sale”). The actual content delivered to the viewer could be adjusted (e.g., if teen, advertise how cool the product is, if parent, advertise the sale price). Thus, different people could see different advertisements, or different people could experience the same advertisement differently according to different profiles/rulesets. Furthermore, rapid serial presentations may be tailored to a particular user or user location (e.g., a store might transmit rapid serial presentations to consumer devices within a certain proximity, and those rapid serial presentations may be generic or tailored to specific users).

Similarly, users may be provided with passwords, tokens, or the like (e.g., a SIM card or RFID tag) to access mobile content (e.g., through a subscription service) from a consumer device.

As discussed above, various types of user controls can be provided to allow the user to control and adjust rendering of a rapid serial presentation. Alternative embodiments may include touch-screen controls for such things as starting, stopping, pausing, or changing speed of a rapid serial presentation and switching between an eRSP mode and a regular text mode. The use of a touch-screen display may be facilitated by use of a stylus. Additionally, or alternatively, voice commands may be used to control a rapid serial presentation. Additionally, or alternatively, the consumer device may include an orientation sensor (e.g., an accelerometer or gyroscope) and may allow the user to control a rapid serial presentation by changes in consumer device orientation.

In any case, feedback information may be collected from the users and/or the consumer devices before, during, or after rendering of a rapid serial presentation. Such information may be stored for use in generating and/or rendering rapid serial presentations and may be used to update such things as rulesets, profiles, and dictionaries. Such information may also be provided to third parties, e.g., by selling the information or providing access to a database of the information.

The eRSP player may also provide a text-to-speech conversion that utilizes information in the eRSP descriptors to adjust such things as volume, pitch, intonation, delays, and other voice filters. Specialized rulesets may be used to tune the rapid serial presentation to text-to-speech conversion, e.g., to convey such things as volume, pitch, intonation, delay, and other characteristics.

Rendering of an eRSP presentation may be controlled using a wireless remote controller. For example, rendering of an eRSP presentation on an Apple™ Notebook computer may be controlled using its associated wireless remote controller, or rendering of an eRSP presentation by an digital set top box may be controlled using its associated wireless remote controller.

Exemplary eRSP Ruleset and Markup Language File

As discussed above, a rapid serial presentation may be in the form of a markup language file. The following is an exemplary eRSP ruleset specification based on various linguistic and psycholinguistic attributes and a resulting markup language file for a rapid serial presentation including results from a search for the term “safety lamp” in Wikipedia™. It should be noted that this particular ruleset specification is supplied as an example of the types of parameters that can be specified and is not intended to represent a real-world ruleset.

### Ruleset Specification:

Sub Rule 1

Age of Aquisition (AoA)

Range 100 to 200

Speed 1.55

BackColor Green

ForeColor Green

Font Size 13

Font Name Courier New

Sub Rule 2

Number of Phonemes

Min 11

Speed 0.65

BackColor Ivory

ForeColor Violet

Font Size 13

Font Color Tahoma

Sub Rule 3

Capitalization

Capitalized

Speed 0.45

BackColor Black

ForeColor Brown

Font Size 9

Font Name Arial

Sub Rule 4

Imaginability

Range 451 to 550

Speed 1.4

BackColor Magenta

ForeColor Red

Font Size 19

Font Name N/A

Sub Rule 5

Syllables

Min 1

Speed 0.8

BackColor Yellow

ForeColor Blue

Font Size 11

Font Name N/A

Sub Rule 6

Concreteness

Range 600 to 700

Speed 0.65

BackColor Brown

ForeColor N/A

Font Size 28

Font Name Tahoma

Sub Rule 7

P_Meaningfulness

Max 900

Speed 0.95

BackColor Blue

ForeColor Pink

Font Size 29

Font Name N/A

Sub Rule 1 specifies that, if the age of acquisition associated with a particular target is in the range 100 to 200, then the target will be assigned a display time of 1.55, background color Green, font color Green, font size 13, and font type Courier New. Sub Rule 2 specifies that, if the number of phonemes in the target is 11 or more, then the target will be assigned a display time of 0.65, background color Ivory, font color Violet, font size 13, and font type Tahoma. Sub Rule 3 specifies that, if the capitalization value for the target is capitalized, then the target will be assigned a display time of 0.45, background color black, font color brown, font size 9, and font type Arial. Sub Rule 4 specifies that, if the imaginability value for the target is in the range 451 to 550, then the target will be assigned a display time of 1.4, background color Magenta, font color Red, font size 19, and default font type. Sub Rule 5 specifies that, if the target has more than one syllable, then the target will be assigned a display time of 0.8, background color Yellow, font color Blue, font size 11, and default font type. Sub Rule 6 specifies that, if the concreteness value for the target is in the range 600 to 700, then the target will be assigned a display time of 0.65, background color brown, default font color, font size 28, and font type Tahoma. Sub Rule 7 specifies that, if the P_Meaningfulness value for the target is not higher than 900, then the target will be assigned a display time of 0.95, background color Blue, font color Pink, font size 29, and default font type. Of course, more than one Sub Rule may apply to a particular target, and the eRSP generator selects the appropriate Sub Rule based on a predetermined priority scheme.

MARKUP LANGUAGE FILE:

<?xml version=“1.0” encoding=“UTF-8” ?>
- <WikipediaResponse>
- <Data>
<Type>0</Type>
<text>Safety lamp A safety lamp is any of several types of lamp, which are
designed to be safe to use in coal mines. These lamps are designed to
operate in air that may contain coal dust, methane, or firedamp, all of which
are potentially flammable or explosive. First Safe Lamps The first safety
lamp was invented by William Reid Clanny, an Irish physician, who
announced his discovery on May 20th, 1813 at the Royal Society of Arts in
London, but it was not tried out in a colliery until 1815. Within months of
this demonstration, two improved designs had been announced: one by
George Stephenson, which later became the Geordie lamp, and the Davy
lamp, invented by Sir Humphry Davy. Most later lamps are constructed on
the principle discovered by Davy, that a flame enveloped in wire gauze of a
certain fineness does not ignite firedamp. Both the Davy and Stephenson
lamps were fragile. The gauze in the Davy quickly rusted in the moist air of
a coal pit, and so became unsafe, while the glass in the Stephenson was
easily broken, and could then allow the flame to ignite firedamp in the
atmosphere. Later designs, the Gray, Mueseler, Marsaut, and other lamps,
tried to overcome these problems by using multiple gauze cylinders, but
the glass remained a problem until toughened glass became available. Also,
the light that all these gave was poor and this was not solved until the
introduction of electric lighting in mines around 1900. But it took until 1930
for the introduction of battery-powered helmet lamps to finally solve the
problem. Early Illumination Prior to the invention of these safety lamps,
miners used candles with open flames or phosphorescent sources of light
(such as rotting fish)and later flint or steel mills designed by ‘Spedding.’
Later, barometers were used to tell them if atmospheric pressure was low
(in which case more methane seeped out of the mine into the air). The use
of small mammals or birds was used much later to warn of the presence of
the deadly carbon monoxide present after underground fires or explosions,
the so-called afterdamp. Such animals are much more susceptible to the
gas, and will die before a human, so giving an early warning of the
problem. An alternative method of removing the methane involved igniting
the gas deliberately to cause explosions, thus evacuating the mines of the
majority of explosive or easily flammable material present. The lack of
good lighting was a prime cause of a painful eye affliction (nystagmus).
Modern Lamps Nowadays, safety lamps are mainly electric, and
traditionally mounted on miners' helmets (such as the wheat lamp), sealed
to prevent gas penetrating the casing and being ignited by electrical sparks.
However, although its use as a light source was superseded by electric
lighting, the flame safety lamp has continued to be used in mines into
recent years to detect methane and blackdamp.</text>
<ruleSet>550555555575555555455557575555555355455555557555054705555575
300535575553005555575355555555550575525775505530555555555575505557575
557555557555555555550555507555555557555555555555555550554555555555555
575400557555575755755575557555055455555555557552557575055550552505755
555052055555557757557557540575535475505755555555550545575554550055557
575555555555555545575757757555555453455455555555555575557547557575755
555555440555575555555150057055755557550705550555475555755705555554557
5575555555555755755550</ruleSet>
- <ruleInfo>
<Rule>1,1.55,Green,Green,13,Courier New</Rule>
<Rule>2,0.65,Ivory,Violet,13,Tahoma</Rule>
<Rule>3,0.45,Black,Brown,9,Arial</Rule>
<Rule>4,1.4,Magenta,Red,19,</Rule>
<Rule>5,0.8,Yellow,Blue,11,</Rule>
<Rule>6,0.65,Brown,,28,Tahoma</Rule>
<Rule>7,0.95,Blue,Pink,29,</Rule>
</ruleInfo>
<delayCount>13,24,37,38,40,48,62,63,66,73,74,82,93,98,104,108,114,118,122,123,
134,149,155,158,173,177,183,186,198,200,202,203,204,207,217,228,230,253,258,263,
270,282,294,297,305,306,318,330,358,361,370,376,384,399,413,429,434,439,444,446,
450,463,465,477,496,</delayCount>
<delayInfo>200,200,200,200,200,200,250,250,200,250,250,200,250,200,250,250,200,
200,250,200,200,200,250,200,200,200,250,200,200,200,200,250,250,200,200,200,200,
250,250,250,200,200,250,200,250,200,250,250,200,200,200,200,200,200,200,250,
200,200,250,250,250,200,200,200,250,</delayInfo>
- <images>
<image>http://upload.wikimedia.org/wikipedia/commons/thumb/a/a4/
Mine_safety_lamp.jpg/100px-Mine_safety_lamp.jpg</image>
</images>
</Data>
</WikipediaResponse>

In this example, the markup language file includes (among other things) a <text> section, a <ruleSet> section, a <ruleInfo> section, a <delayCount> section, a <delayInfo> section, and an <images> section.

The <text> section includes the text to be displayed. Both the eRSP generator and the eRSP player logically parse the text into a sequence of targets according to predetermined parsing scheme (e.g., a comma following a word may be displayed along with that word). In this example, the targets are generally delimited by spaces, although targets may also be groups of words or other types of elements. Thus, in this example, the sequence of targets may be: Safety Lamp A safety lamp is . . . .

The <ruleSet> section includes a series of rule numbers to be applied respectively to the targets parsed from the <text> field. There is a one-to-one relationship between the rule numbers specified in the <ruleSet> section and the targets in the <text> field, i.e., the rule number at offset N in the <ruleSet> list is applied to the Nth target. It should be noted that rule number 0 indicates that default values are to be applied to the target; no specific parameters for rule number 0 are specified in the <ruleInfo> section in this exemplary embodiment. Thus, in this example, the first target (“Safety”) will be rendered in accordance with rule number 5, the second target (“lamp”) will be rendered in accordance with rule number 5, the third target (“A”) will be rendered in accordance with rule number 0, and so on.

The <ruleInfo> section specifies one or more rules to be applied to the targets in accordance with the <ruleSet> section. Each rule starts with <Rule> and ends with </Rule>. In this example, there are seven rules numbered 1-7. Each rule includes (from left to right) a rule number field, a display time field that specifies a display time as a multiple of a reference value that is maintained by the consumer device and is preferably user-adjustable, a background color field, a font color field, a font size field, and a font type field. Specifically, rule number 1 specifies a display time multiplier of 1.55, font color Green, background color Green, font size 13, and font type Courier New; rule number 2 specifies a display time multiplier of 0.65, font color Ivory, background color Violet, font size 13, and font type Tahoma; rule number 3 specifies a display time multiplier of 0.45, font color Black, background color Brown, font size 9, and font type Arial; rule number 4 specifies a display time multiplier of 1.4, font color Magenta, background color Red, font size 19, and default font type; rule number 5 specifies a display time multiplier of 0.8, font color Yellow, background color Blue, font size 11, and default font type; rule number 6 specifies a display time multiplier of 0.65, font color Brown, default background color, font size 28, and font type Tahoma; and rule number 7 specifies a display time multiplier of 0.95, font color Blue, background color Pink, font size 29, and default font type. It should be noted that this particular set of rules is supplied as an example of the types of parameters that can be specified in the markup language file and is not intended to represent a real-world rule set (one could imagine that a 9-point font displayed in brown on a black background with a 0.45 multiplier, per rule number 3, might be difficult to read). The rules may specify additional attributes to be applied to the targets, such as, for example, maximum number of letters to be displayed together, minimum number of letters to be displayed together, preferred number of letters to be displayed together, information about word groupings, additional delay factors (e.g., interaction of multiple words), and special effects, to name but a few.

The <delayCount> section identifies particular targets (by offset number) before which additional delay (specified in the <delayInfo> section) will be added. In this example, additional delays will be added prior to the 13th target, the 24th target, the 37th target, and so on.

The <delayInfo> section specifies the additional delay values to be added before the targets identified in the <delayCount> section. In this example, an additional delay of 200 units (i.e., the first delay value specified in the <delayInfo> field) will be added prior to the 13th target (i.e., the first offset specified in the <delayCount> field), an additional delay of 200 units (i.e., the second delay value specified in the <delayInfo> field) will be added prior to the 24th target (i.e., the second offset specified in the <delayCount> field), and so on. Thus, in this example, an additional delay of 200 units will be added between the common and the word “which” (i.e., the 13th target) in the first line of the <text> section, an additional delay of 200 units will be added between the period and the word “These” (i.e., the 24th target) in the second line of the <text> section, and so on.

The <images> section specifies the location of one or more images associated with the search. Each image specification begins with <image> and ends with </image>. In this example, there is one image specified.

Since the markup language file includes the entire text passage to be displayed, embodiments of the invention may allow the user to toggle between an eRSP mode and a full screen mode at any point of rendering. Thus, for example, the user could start the presentation in eRSP mode (either by default or by user selection) and switch to full screen mode, or vice versa. The use of offsets to map each target to a rule number facilitates a transition from full screen mode to eRSP mode. For example, the eRSP player can begin or resume the eRSP presentation at the Nth target and easily locate the corresponding rule number at offset N into the <ruleSet> section.

### Exemplary User Interface

As discussed above, rapid serial presentation may be particularly advantageous for consumer devices with small screens such as mobile telephones, personal digital assistants, personal computers, pagers, portable video games, digital watches, portable media players, and the like, although it can certainly be used on other types of devices. An exemplary prototype embodiment provides an interface from a mobile telephone platform to a content provider (specifically the Wikipedia™ online encyclopedia, although the interface could certainly be to other content providers) over a wireless communication network (e.g., cellular telephone network), with search results displayable in eRSP format at the mobile telephone. The mobile telephone runs a client application that includes, among other things, an eRSP player and a user interface. The client application communicates with a remote server via the wireless communication network. The server includes, among other things, an eRSP generator and an Internet connection for communication with the content provider (and potentially with other sites).

In practice, the user enters search criteria via the user interface. The client application sends a request to the server including, among other things, the search criteria and a profile identifier for a profile that is selectable by the user via the user interface. Upon receipt of the request, the server sends via the Internet a request to the content provider including the specified search criteria. Upon receipt of a response from the content provider including the content, the server (and particularly the eRSP generator) generates an eRSP presentation in the form of a markup language file using the specified profile and sends the markup language file to the client application via the wireless communication network. The client application (and particularly the eRSP player) renders the eRSP presentation in accordance with the markup language file and other parameters (e.g., presentation speed, default text size, and other parameters that may be preconfigured and/or selectable by the user).

It should be noted that the server may divide a large amount of content into a series of eRSP presentation segments, which may be generated and sent individually. Among other things, such segmentation may allow the user to begin viewing a portion of the content while the server is still processing later portions of the content.

It should also be noted that the server may be operated by any of various entities. For example, the server may be operated by a wireless carrier (e.g., Verizon™, AT&T™, Research In Motion™), by the content provider (e.g., Wikipedia™, Google™, Yahoo™), or by a third party service provider (e.g., the applicant or assignee of the subject patent application), to name but a few. The server may obtain content from any of various sources including, but not limited to, local storage, remote storage, and/or other servers.

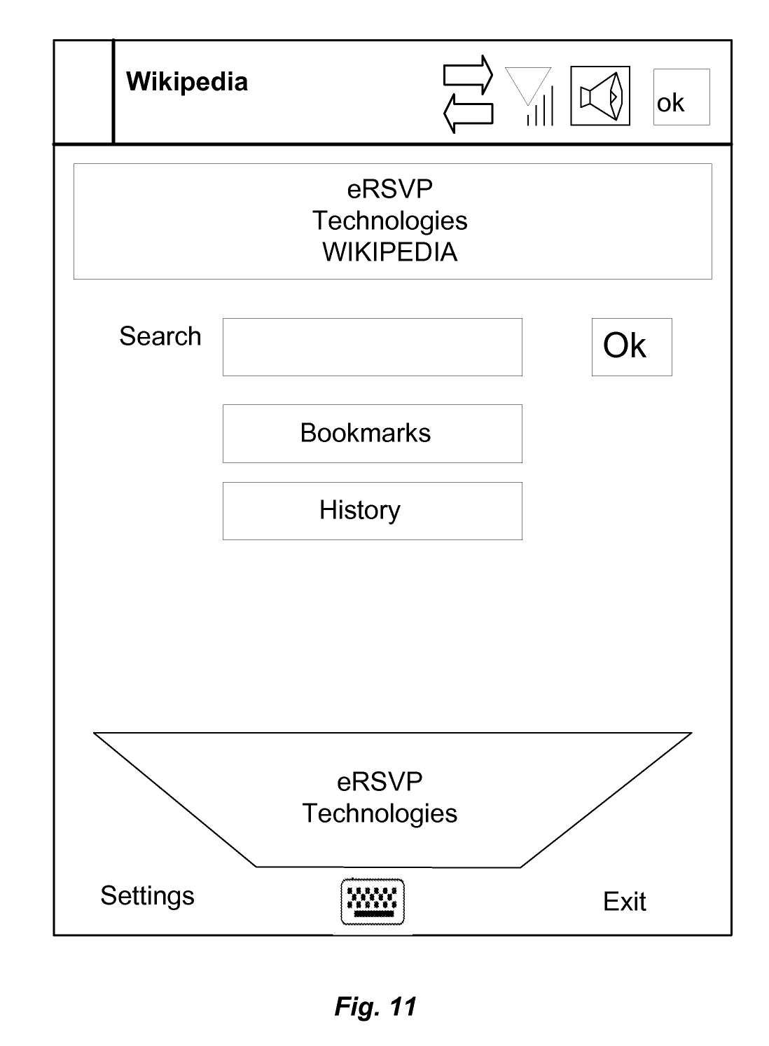

In the exemplary embodiment, the mobile telephone conveniently includes a touch panel screen that can be used (e.g., with a stylus) to navigate and enter information through various user interface screens, although other types of screens may be used in alternative embodiments. The user interface includes various screens that permit entry of search criteria as well as configuration of various parameters for both eRSP and full-screen viewing of content. Some exemplary user interface screens are described below with reference to FIGS. 11-24. It should be noted that white-out strips are included in some of the figures to facilitate the representation of text on the dark background and are not part of the screens in this exemplary embodiment.

FIG. 11 shows an exemplary search screen in accordance with an exemplary embodiment of the present invention. The main portion of the search screen includes a search window, a bookmarks tab, and a history tab. A user may enter a search term or phrase into the search window and select the “Ok” tab to have the term or phrase searched by the Wikipedia™service, or alternatively, the user may select prior terms/phrases from the bookmarks tab or select from among a number of previous search results from the history tab. The bottom of the screen includes a settings tab, a keyboard tab, and an exit tab. At any time, the user may select the settings tab to move to a settings screen allowing configuration of various operational parameters, select the keyboard tab to open a virtual keyboard to facilitate entering textual information into the search window, or select the exit tab to exit the application.

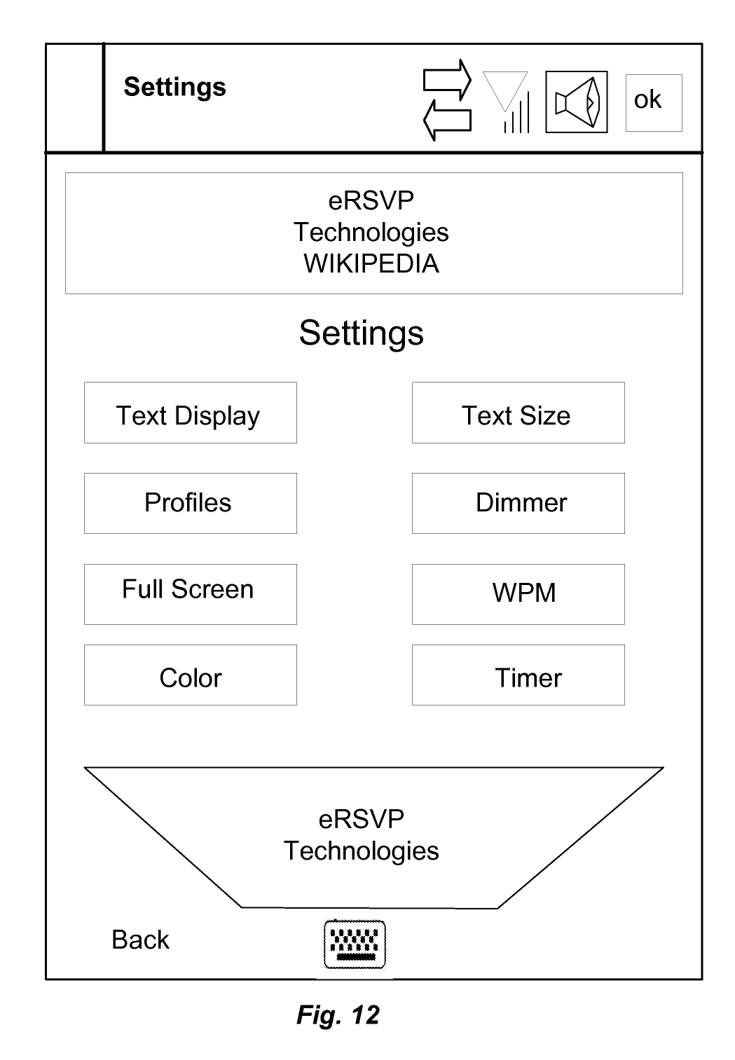

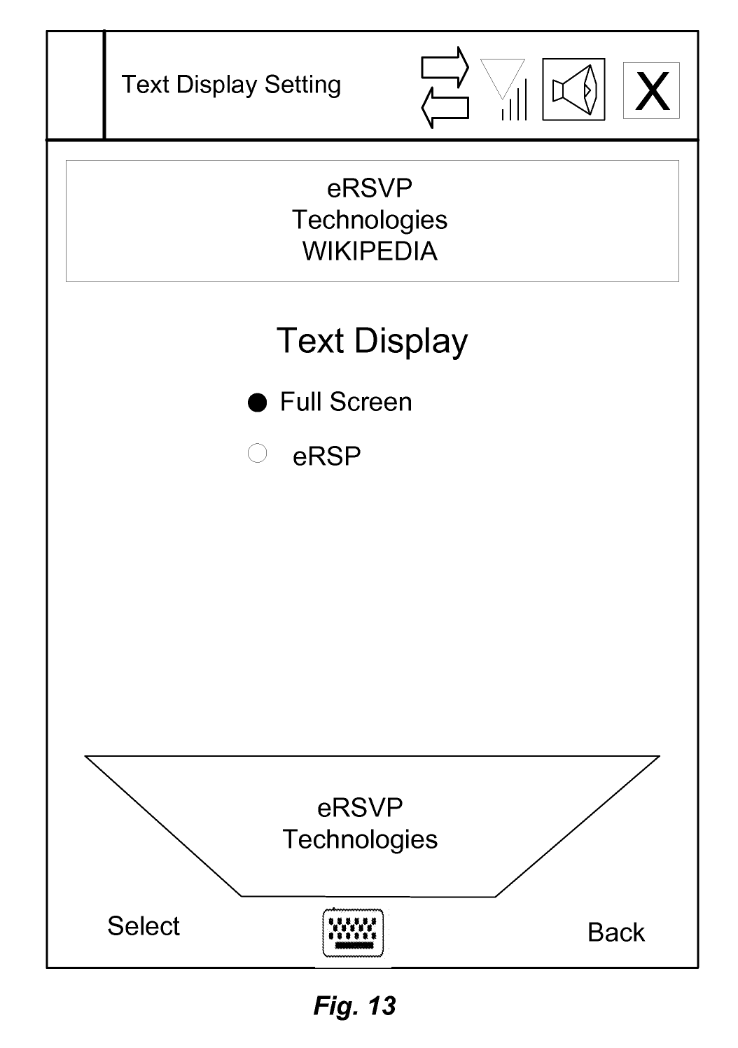

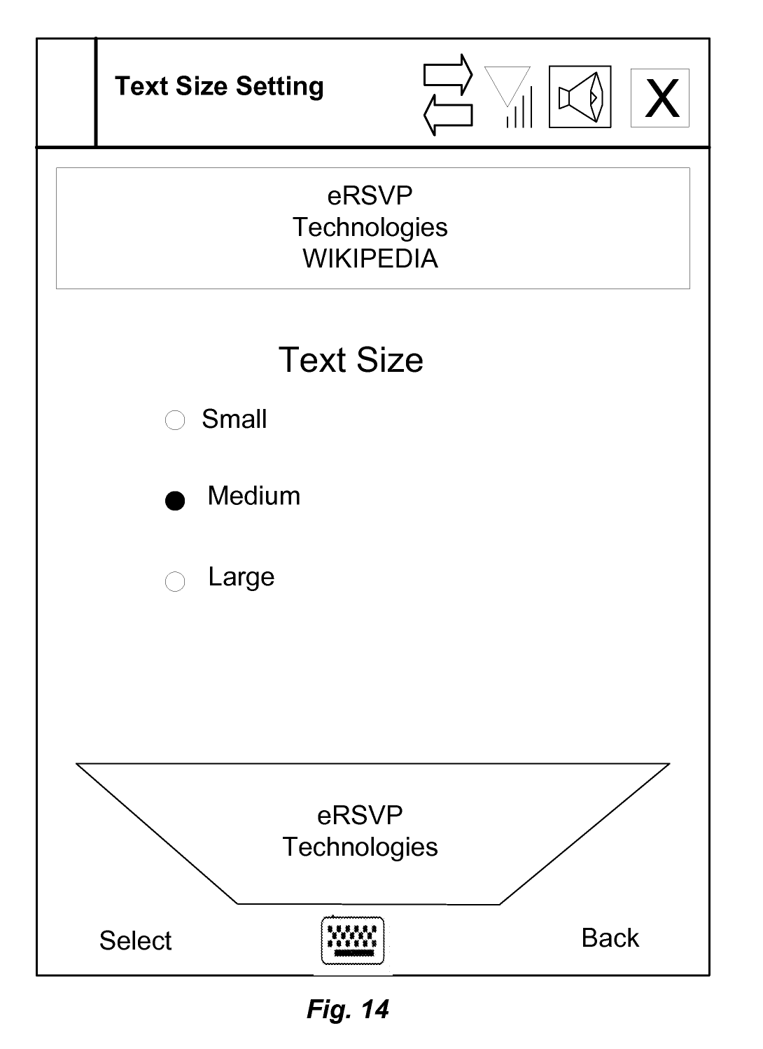

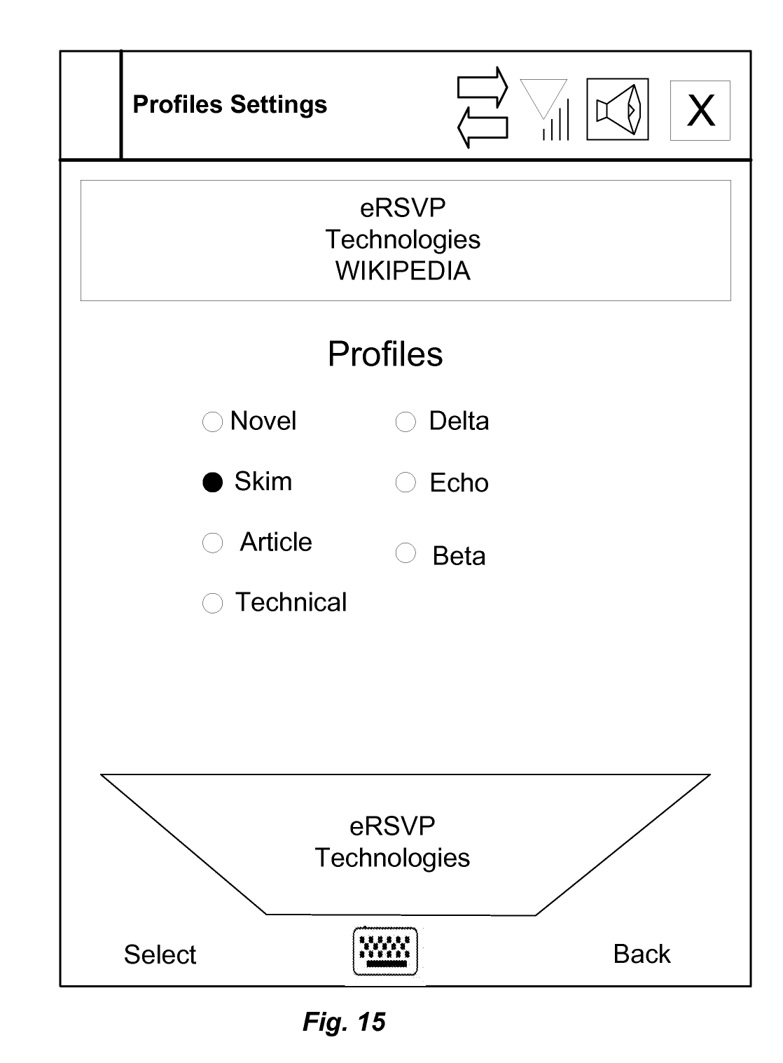

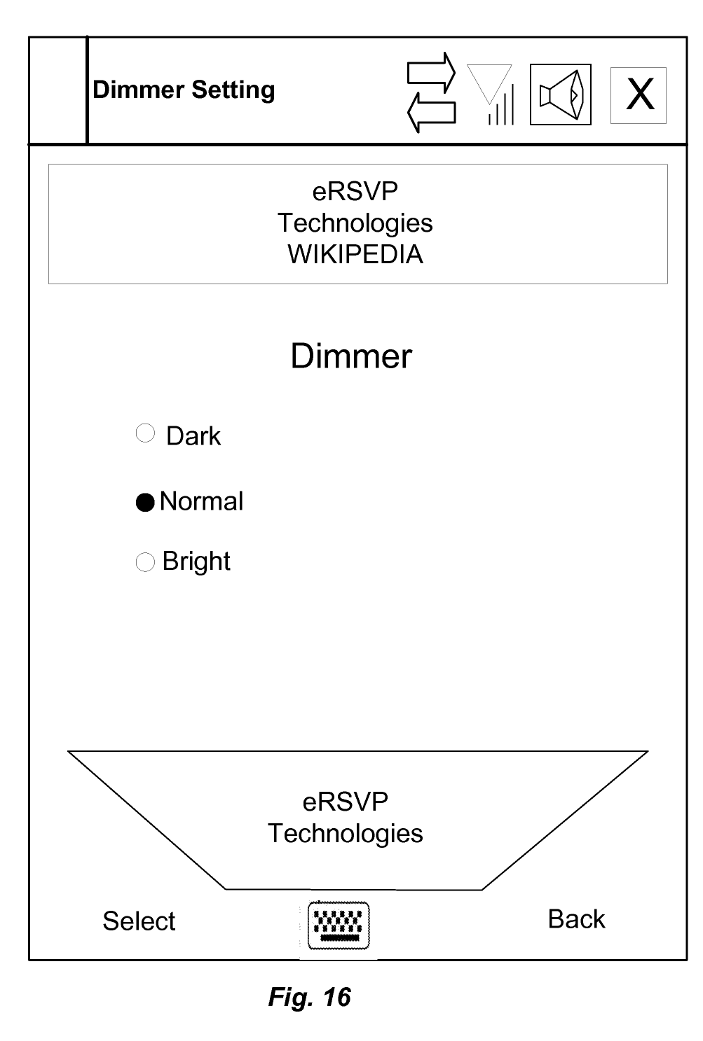

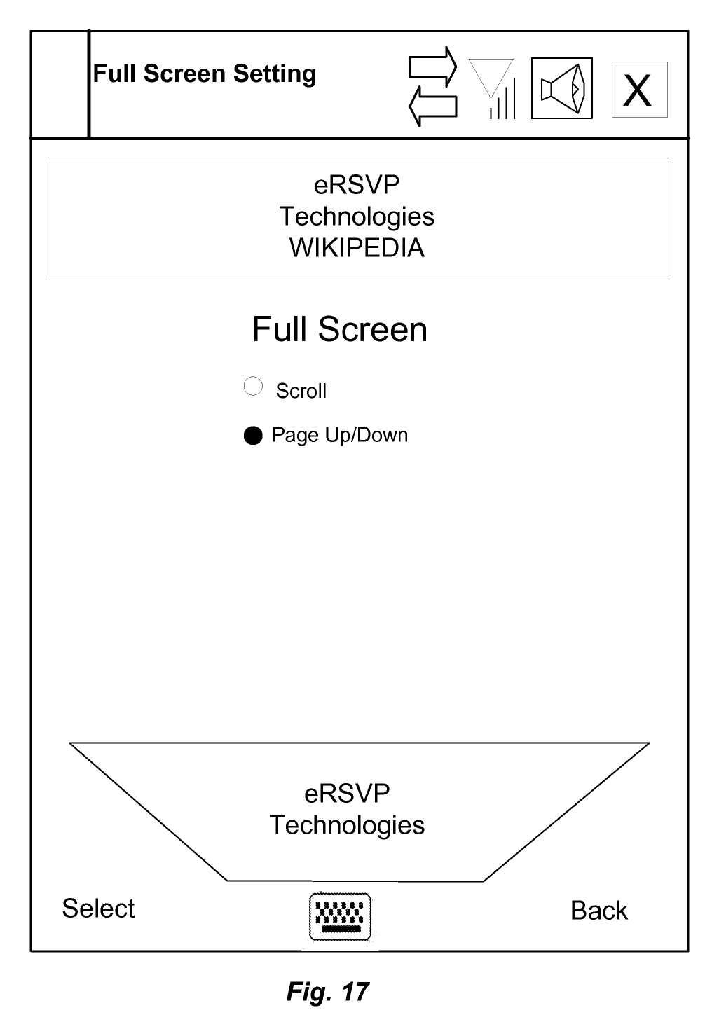

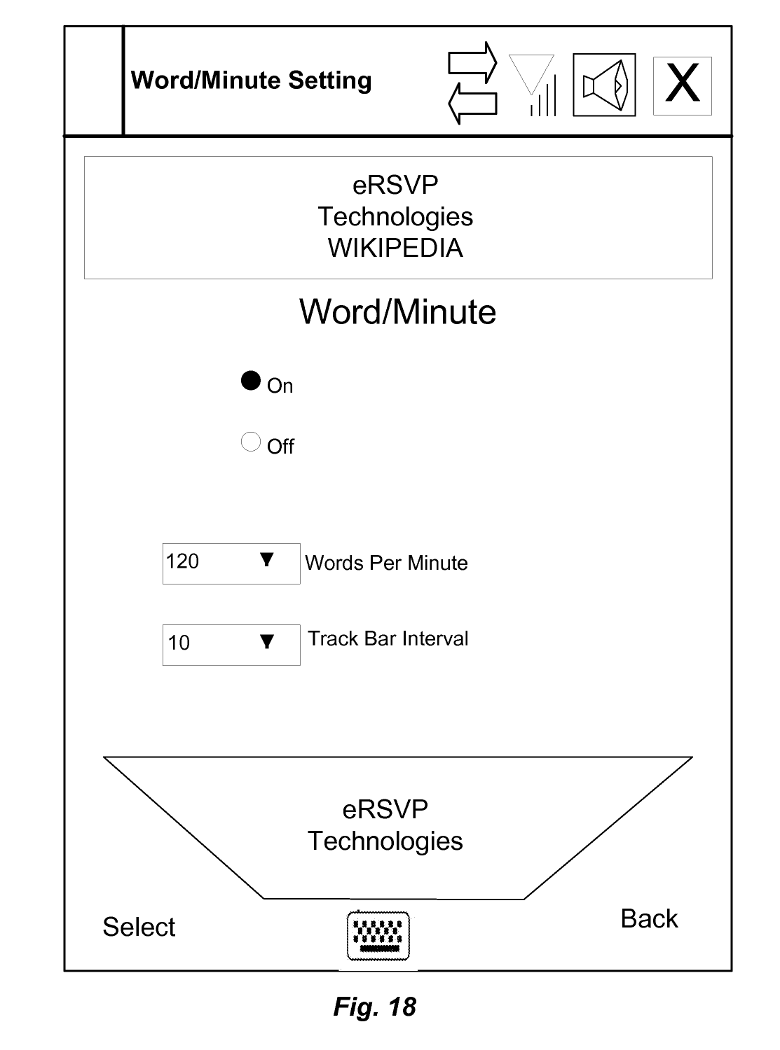

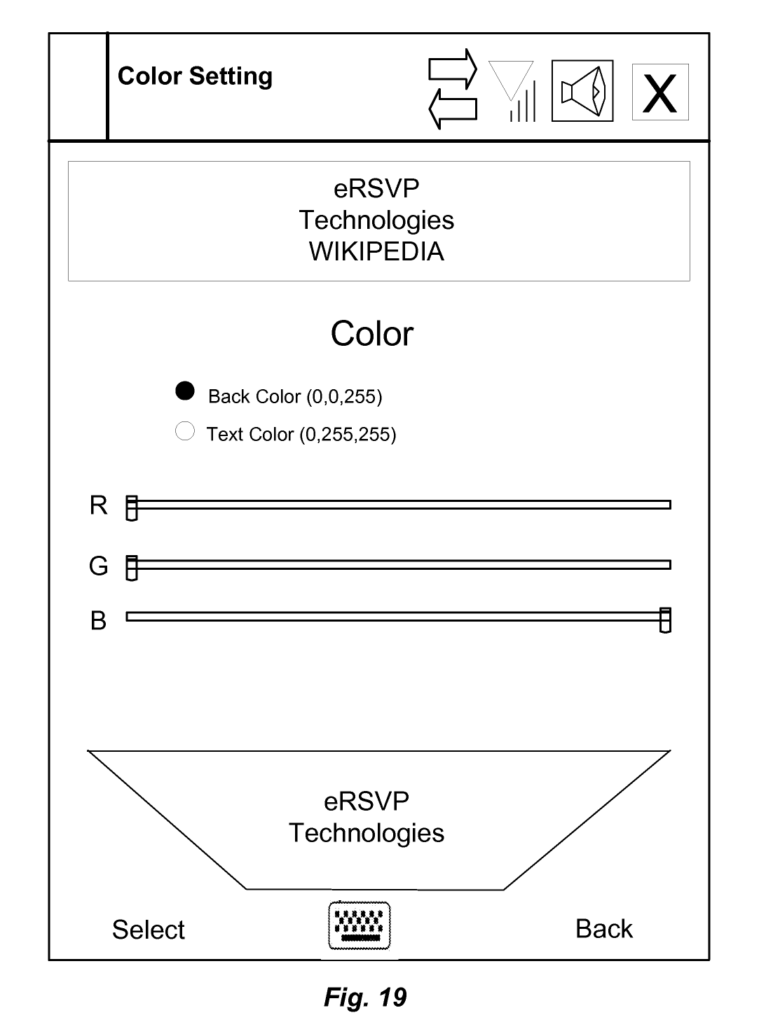

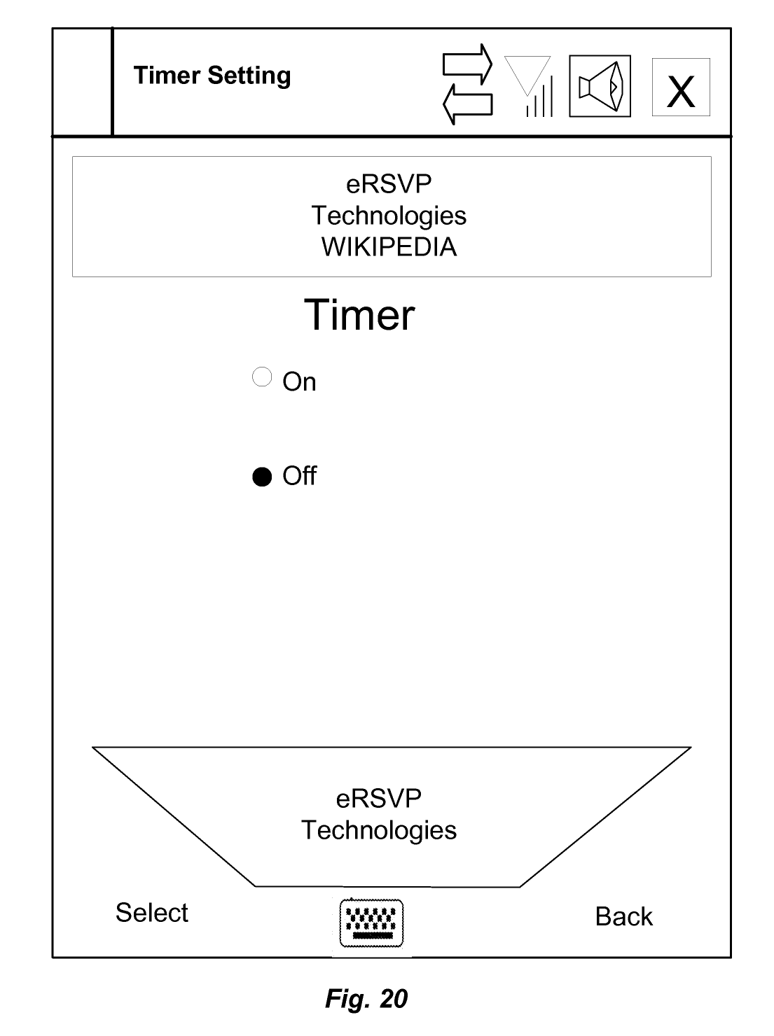

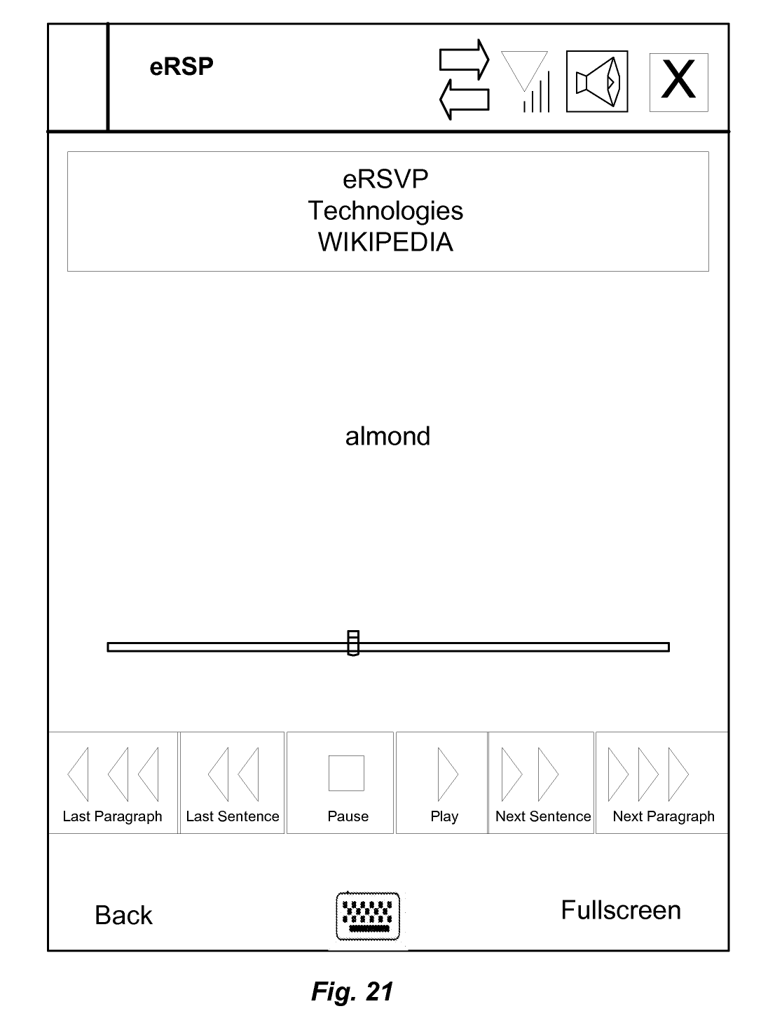

FIG. 12 shows an exemplary settings screen in accordance with an exemplary embodiment of the present invention. The main portion of the settings screen includes a text display tab, a text size tab, a profiles tab, a dimmer tab, a full screen tab, a WPM (words per minute) tab, a color tab, and a timer tab. The user may select the text display tab to configure the default text display mode (i.e., full screen or eRSP); an exemplary text display setting screen is shown in FIG. 13. The user may select the text size tab to configure default text size parameters; an exemplary text size setting screen is shown in FIG. 14 (in an alternative embodiment, the text size setting screen allows selection of actual text size and other related parameters rather than just small, medium, or large). The user may select the profiles tab to configure a default profile to be used for eRSP generation; an exemplary profiles settings screen is shown in FIG. 15. The user may select the dimmer tab to configure a default brightness for the display screen; an exemplary dimmer setting screen is shown in FIG. 16 (in an alternative embodiment, the dimmer screen is replaced with a server screen, not shown, allowing user specification of the IP address of the eRSP server, mainly for testing purposes). The user may select the full screen tab to configure a control mode (i.e., scroll or page up/down) for the full screen text display mode; an exemplary full screen setting screen is shown in FIG. 17. The user may select the WPM (words per minute) tab to configure default speed parameters (e.g., words per minute and track bar interval; the track bar is described below with reference to FIG. 21) for the eRSP text display mode; an exemplary WPM screen is shown in FIG. 18. The user may select the color tab to configure default background and text colors; an exemplary color setting screen is shown in FIG. 19. The user may select the timer tab to enable and disable a timer that is used in the prototype system to limit the frequency with which searches can be conducted by the user; an exemplary timer setting screen is shown in FIG. 20. Each of the screens shown in FIGS. 13-20 includes a select tab for saving configuration settings and returning to the settings screen, a keyboard tab for opening a virtual keyboard, and a back tab for returning to the settings screen without changing configuration. The bottom of the settings screen includes a back tab and a keyboard tab. The user may select the back tab to return to the search screen.

FIG. 21 shows an exemplary eRSP screen in accordance with an exemplary embodiment of the present invention. Among other things, the eRSP screen includes a virtual window area where eRSP targets (in this case, the word “almond”) are displayed. Below the eRSP window area is a track bar allowing the user to adjust presentation speed and a set of controls allowing the user to (from left to right) go back one paragraph, go back one sentence, pause the presentation, play the presentation, go forward one sentence, and go forward one paragraph. The bottom of the eRSP screen includes a back tab allowing the user to go back to the previous screen, a keyboard tab allowing the user open a virtual keyboard, and a fullscreen tab allowing the user to toggle to the full screen mode. In the event the user switches to full screen mode in the middle of the presentation (in this example, at the word “almond”), the full screen mode will display the text on or about the same point in the presentation (in this example, the portion of text including the word “almond”).

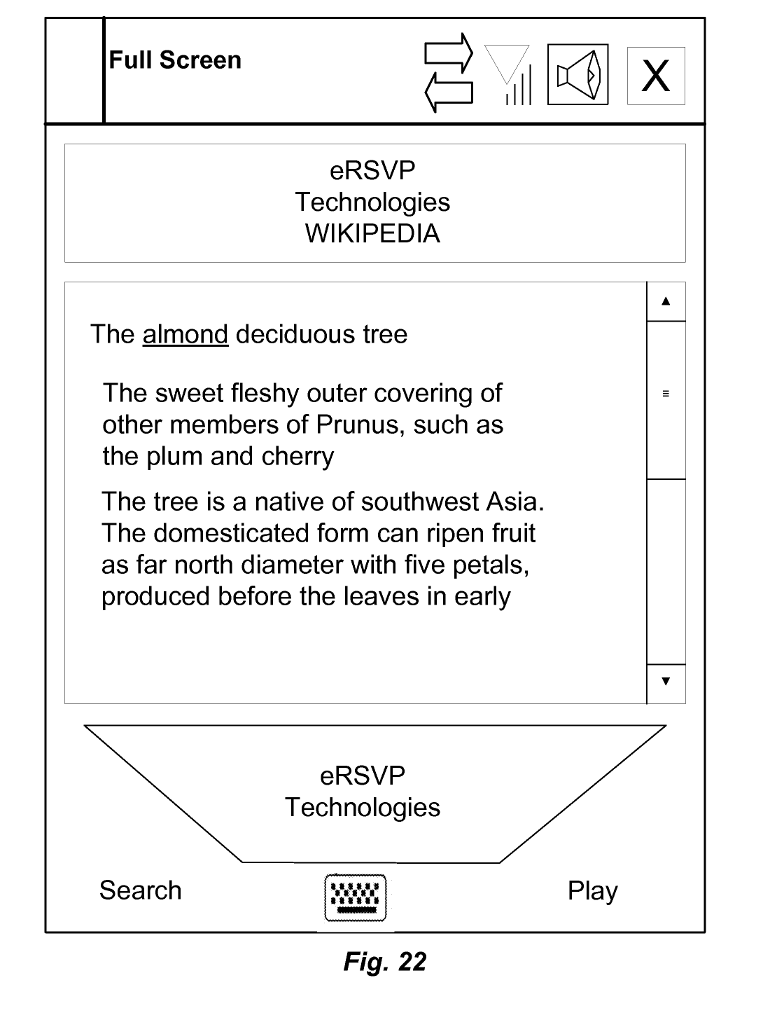

FIG. 22 shows an exemplary full screen in accordance with an exemplary embodiment of the present invention. The text is displayed in the main window area. In this example, the full screen mode is set for scroll mode, as indicated by the scroll bar on the right-hand side of the display window; if the full screen mode had instead been configured for page up/down mode, then page up and page down tabs would be displayed in lieu of the scroll bar. The bottom of the full screen includes a search tab allowing the user to select or highlight a word or phrase in the full text (in this example, the word “almond”) and have the word or phrase searched without having to return to the search screen and enter the search criteria. The bottom of the full screen also includes a keyboard tab allowing the user open a virtual keyboard and a play tab allowing the user to toggle back to eRSP mode.

It should be noted that a similar search function could be added to the eRSP screen so that the user can select or highlight a target and have it searched without having to return to the search screen.

It should also be noted that alternative embodiments may allow the user to specify a search service for the search (e.g., a particular search engine, dictionary, website, etc.).

It should be noted that the results from different searches may be presented in different eRSP and non-eRSP windows. Thus, for example, the results of a first search may be displayed in a first window, the results of a second search performed from that first window may be displayed in a second window, and so on. Additional searches may also be permitted, so that three or more windows, each having different search results or other content, may be active at a given time. The user may be permitted to navigate between the windows in various ways. For example, multiple windows may be displayed on the screen simultaneously, the windows may be “stacked” so that only one of the windows is displayed at a time, a “forefront” window may be displayed along with “thumbnails” of the other window(s) so as to allow the user to select a thumbnail to be brought to the forefront, etc.

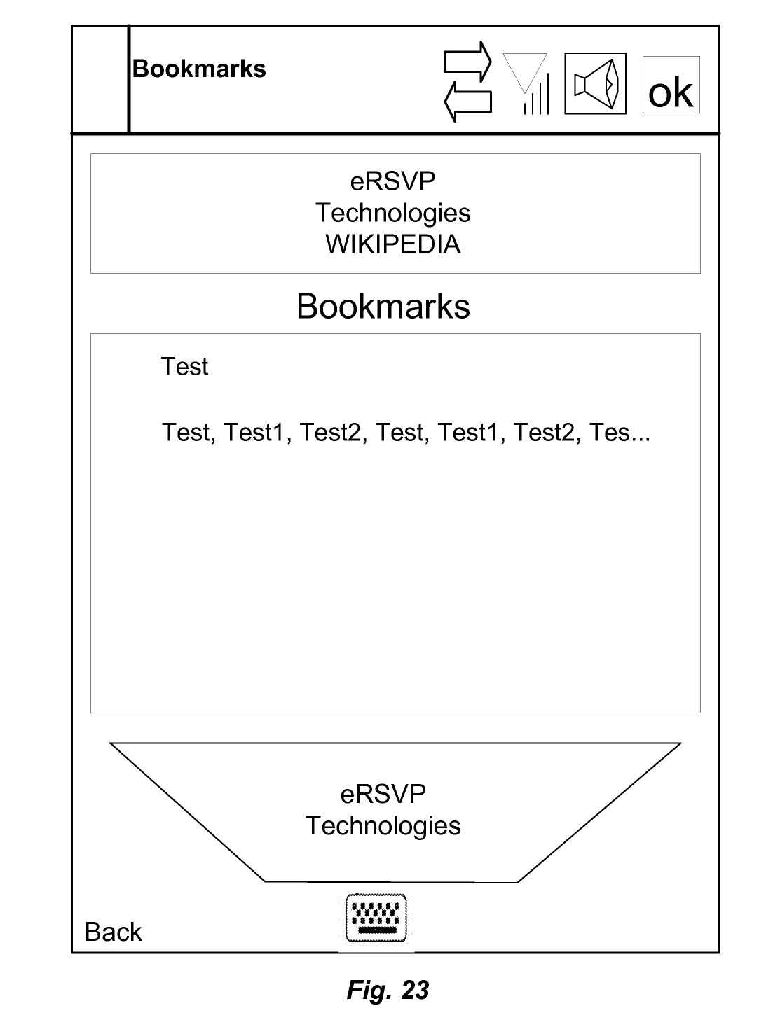

FIG. 23 shows an exemplary bookmarks screen in accordance with an exemplary embodiment of the present invention. Bookmarks are eRSP presentations that have been selected by the user and saved in local storage. The user may select a bookmarked eRSP presentation and play it from local storage so that the process of searching and eRSP generation does not have to be repeated.

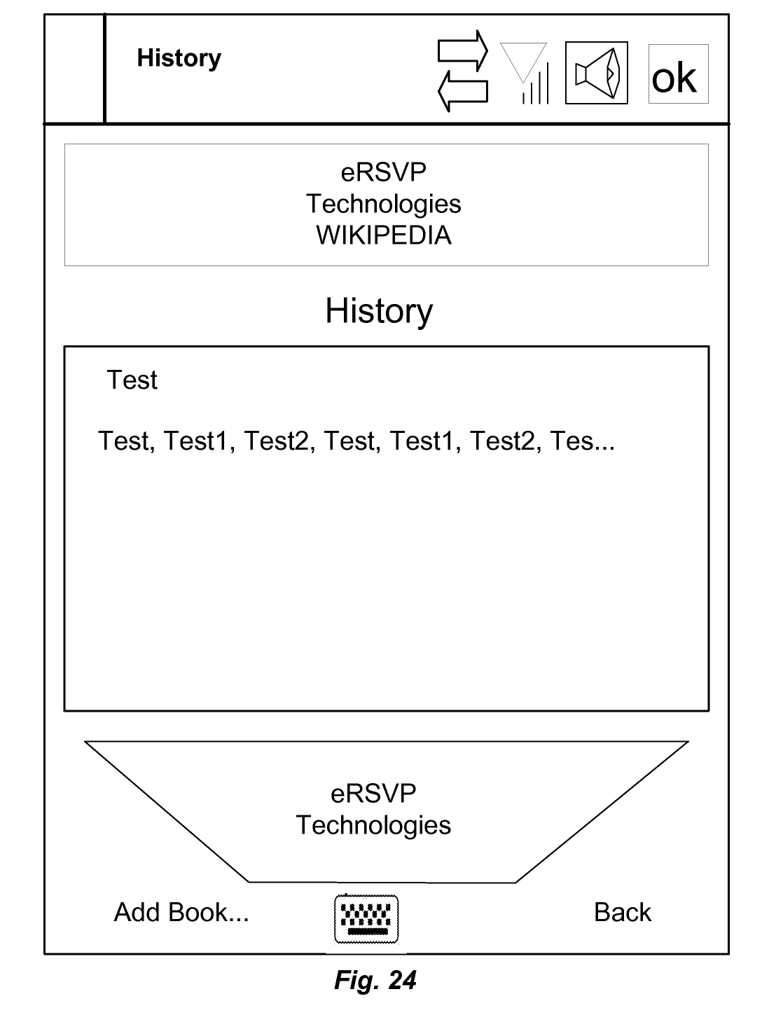

FIG. 24 shows an exemplary history screen in accordance with an exemplary embodiment of the present invention. The history screen shows the last N (e.g., 10, in an exemplary embodiment) eRSP presentations that have been received by the client application and saved in local storage. The user may select an eRSP presentation from the history screen and play it from local storage so that the process of searching and eRSP generation does not have to be repeated. Additionally, the user may use the “Add Book . . . ” tab at the bottom of the screen to bookmark a selected eRSP presentation so that it does not get inadvertently deleted as additional eRSP presentations are received and stored.

It should be noted that the window pane icon shown at the top left corner of the exemplary screens is a trademark of Microsoft Corporation.

It should also be noted that each exemplary screen includes a company logo (in this example, “eRSVP Technologies”) as well as a content provider logo (in this example, “Wikipedia”). Such logos may be omitted or may be customized for specific products and applications. Such logos may be static or active (e.g., the user may be permitted to click on a logo to navigate to a related web site).

It should also be noted that alternative embodiments may use additional and/or different screens, tabs, or parameters. For example, the eRSP screen and the full screen may include a menu tab providing access to a menu of options such as, for example, search (e.g., to search a selected term or phrase), play (e.g., to switch from full screen mode to eRSP mode), fullscreen (e.g., to switch from eRSP mode to full screen mode), image (e.g., to view a related image), add bookmark, etc.

Although the exemplary prototype system described above was designed specifically to interface with the Wikipedia™ online encyclopedia service, it should be noted that embodiments may be independent of a particular provider. Instead, the server may select an appropriate provider for a given search, or the user may be permitted to specify a provider or select from a list of providers such as, for example, Wikipedia™, Google™, Yahoo™, Ask.com™, Microsoft™, Apple™, YouTube™, FaceBook™, etc. It should also be noted that any provider of content (e.g., the eRSP server itself or an external content provider accessed by the eRSP server, such as the Wikipedia™ service accessed by the eRSP server in the above example) may in turn obtain content from other local or remote sources. Thus, for example, providers such as Wikipedia™, Google™, Yahoo™, Ask.com™, Microsoft™, Apple™, YouTube™, FaceBook™ may in turn obtain content from other sources (e.g., external servers, documents, etc.) for inclusion in a rapid serial presentation.

eRSP may be used to view a section of a larger presentation e.g., document, web page, electronic book, search results, etc. Thus, for example, the user may request information (e.g., document, web page, electronic book, online search, etc.) and, upon receiving the information, select a portion to be displayed using eRSP. The received information may include descriptors, such that the eRSP player can render the selected portion using the corresponding descriptors. Alternatively, descriptors may be requested for the selected portion (e.g., from the server that provided the information) or generated locally.

Open Window Space Provided by eRSP

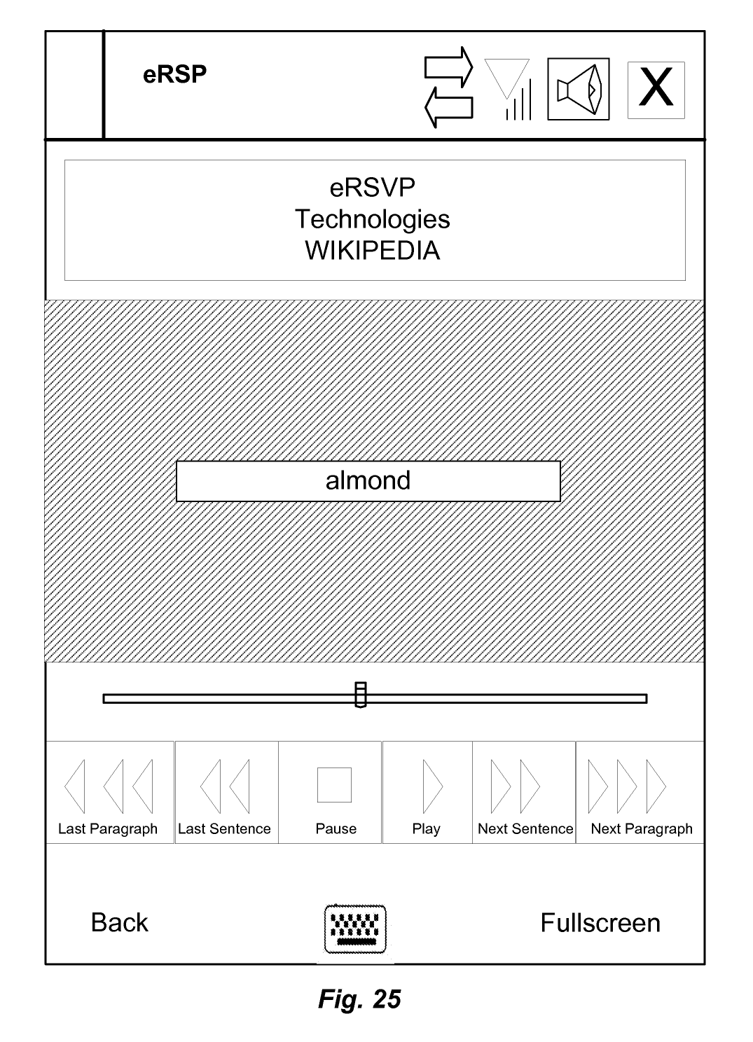

It can be seen from a comparison of the eRSP screen shown in FIG. 21 and the full screen shown in FIG. 22 that the eRSP screen frees up a substantial amount of window space, e.g., surrounding the eRSP window area. FIG. 25 shows some of the open window space (i.e., the hatched area surrounding the eRSP window area) made available by eRSP in an exemplary embodiment of the invention. Such open space represents extremely valuable “real estate,” especially on devices with small display screens that are typically starved for display space, but also on devices with larger display screens such as, for example, laptop and desktop computer. In addition to allowing larger text to be displayed in the eRSP window if desired (e.g., to improve the user's reading experience), such open space may be used for any of a variety of other purposes, some of which are discussed below without limitation.

### Use of Open Window Space for Advertisements

Another exemplary use for the open window space made available by eRSP is placement of advertisements and resultant opportunities to produce income from such placement of advertisements.

Without limitation, advertisements may be placed above, below, along-side, around (e.g., like a “picture frame” or border), or behind (e.g., as a background) the eRSP window area, for example, within the hatched area shown in FIG. 25, and advertisements may even be included within the eRSP controls (e.g., advertisements may be included in the track bar and/or scroll bar, and such advertisements may be shown with special effects such as “unraveling” as the track/scroll bar moves across the screen). Alternatively, the screen could be split into an eRSP portion (e.g., including the eRSP window area and related controls) and an advertisement portion including one or more advertisements. Particularly on small screen devices, the price for an advertisement could be based on the amount of space the advertisement occupies on the screen. Advertisements may be displayed in either eRSP or full screen mode (e.g., the advertisement may be displayed in full screen mode even if the text is being displayed in eRSP mode, and vice versa). Advertisements may be in the form of pop-up or bubble ads that display for some period of time and then disappear.

Without limitation, advertisements may be static/inactive (e.g., banners, icons, text, pictures, video, etc.) or active (e.g., “clickable” banners, icons, text, pictures, video, links, etc.). When the user selects an active advertisement during eRSP rendering, the eRSP player may pause rendering and open the advertisement in whatever form is appropriate (e.g., advertisement could be displayed in eRSP mode or full screen mode). Advertisements may be persistent (e.g., the same advertisement is displayed for an extended period, e.g., while a particular screen is displayed) or variable (e.g., advertisements change, for example, every X words, every X seconds, or at natural pause points such as commas and periods). Different types of advertisements may be placed on the same screen (e.g., a sponsor may be listed above the eRSP window area and an active advertisement for that sponsor may be included below the eRSP window). Advertisements may be vendor-specific or vendor-neutral (e.g., there could be a generic banner above, below, along-side, around, or behind (e.g., as a background) the eRSP window area that, when selected by the user, leads to a different screen containing additional information such as, for example, a number of sponsored sites relating to the search topic, links to coupons for related products and services, links to audio clips, pictures, or video clips related to the topic, etc.).

In addition to providing open window space in which advertisements may be placed, eRSP provides various temporal opportunities for displaying advertisements. For example, one or more advertisements may be shown on the search screen prior to entry of search criteria by the user. Additionally, or alternatively, one or more advertisements may be shown while the search is taking place and/or while the rapid serial presentation is loading. Additionally, or alternatively, one or more advertisements may be displayed at various times during rendering of the rapid serial presentation such as, for example, persistently on the eRSP screen, variably on the eRSP screen (e.g., changing every X words, every X seconds, every paragraph, every page, at natural pause points, etc.), during pre-set pauses (e.g., the markup language file may include embedded pauses and may specify advertisements to be displayed during those pauses), during pauses introduced by the eRSP player (e.g., every X words, every X seconds, every paragraph, every page, at natural pause points, etc.), during user-initiated pauses (e.g., when user selects the pause tab), during pauses due to external stimuli (e.g., upon detection of a loud noise), during pauses upon detection of an incoming phone call, email, text message, etc. (e.g., perhaps displayed along with caller id information, sender name/address, etc.), to name but a few. A series of related advertisements may be displayed during rendering, e.g., an initial advertisement displayed during loading of the presentation and then follow-on advertisements at various points during the presentation.

Advertisements may be selected in any of various ways. For example, advertisements may be selected based on the search criteria provided by the user and/or based on a personal profile/ruleset for the user. Advertisements may be customized for a particular user, e.g., based on a user profile/ruleset or feedback information provided by the user in response to past presentations and advertisements (e.g., some users may prefer and respond favorably to short advertisements, while other users may prefer and respond favorably to longer advertisements with more information, and the advertisements may be customized accordingly).

The eRSP generator and/or the eRSP player may adjust certain attributes of the rapid serial presentation or its window surroundings such as, for example, font type, font color, background, or border, to support or reinforce a particular company or advertisement. For example, if a particular advertiser or sponsor is closely associated with a particular color or design (e.g., a certain baseball team associated with red socks, a certain insulation company associated with pink fiberglass, etc.), then attributes of the rapid serial presentation (e.g., font type, font color, background, border, etc.) could be periodically changed to that color or design (e.g., repeated logo displays, pale logos in a repeated pattern as wallpaper, bright logos in a repeated pattern as a border design, etc.) to remind the user of the advertiser or sponsor. Similarly, other outputs, such as sounds, may be used to periodically reinforce the advertiser or advertisement (e.g., the “ding dong” sound for Avon™ cosmetics).

### Use of Open Window Space for Additional Controls

Another exemplary use for the open window space made available by eRSP is placement of additional eRSP controls. For example, additional controls such as a progress/scroll bar, additional navigation controls (e.g., start over, page forward, page back, find next occurrence of search term in text, etc.), and links to stored eRSP files (e.g., links to bookmarked files, links to last N files viewed, links to last N search results, etc.) may be placed in the open space.

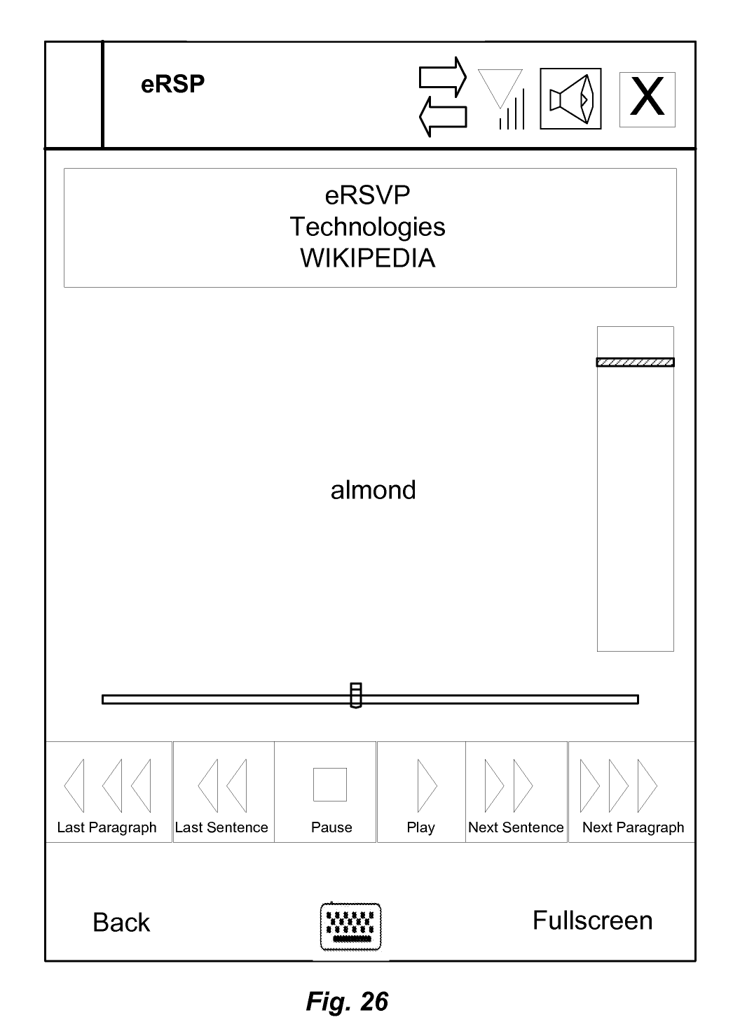

FIG. 26 shows an exemplary eRSP screen including a progress/scroll bar placed in the open space to the right side of the eRSP window area. The progress/scroll bar may show the relative position of the displayed text within the overall presentation and may allow the user to easily move backward and forward in the presentation.

### Use of Open Window Space for Additional Information

Another exemplary use for the open window space made available by eRSP is placement of additional information and resultant opportunities to produce income from such placement of additional information. For example, information about the eRSP presentation (e.g., total number of words, estimated presentation duration, etc.), information about the relevant companies (e.g., the service provider, a sponsor of the eRSP presentation, the name of the content provider or identification of the content source, etc.), information from other applications (e.g., reminders from a calendar program such as Microsoft Outlook™, tasks from a “to-do” list, message waiting indication from a voice mail or email system, incoming call indication from a telephone system, etc.), and/or environmental information (e.g., time, date, temperature, weather forecast, etc.) may be placed in the open space.

Another exemplary use for the open window space made available by eRSP is placement of links to related information or services. For example, in addition to obtaining content from the primary content provider (Wikipedia™ in the above example) based on the search criteria, the server may obtain related information from other sources such as, for example, a dictionary definition of the term/phrase from an online dictionary; a list of synonyms and/or antonyms for the term/phrase from an online thesaurus; links to pictures related to the term/phrase from an online picture library; links to videos related to the term/phrase from an online video library (e.g., YouTube™); links to coupons related to the term/phrase from various online vendors; and/or links to sites containing relevant information, to name but a few. Such links to related information or services may be selected in a variety of ways, such as, for example, a consumer profile, consumer feedback information, consumer usage patterns, and various types contextual marketing information, to name but a few. Links may also relate to the eRSP content such as, for example, links to non-RSP components of the rapid serial presentation (e.g., pictures, charts, etc.) or links to related topics (e.g., for an eRSP presentation relating to osteoporosis, links to web pages relating to the disease and its treatments may be presented to the consumer. The eRSP screen may include a predetermined set of tabs that allow user access to such related information and services, or the links may be placed on the screen dynamically and may change based on the eRSP content or other contextual information. As one example, links may be displayed for some period of time, e.g., during rendering of the rapid serial presentation or during a pause, and the link may be removed from the display (e.g., by fading away) if the consumer does not select the link within the designated time period. Multiple links may be displayed for overlapping periods of time, for example, in a stacked fashion (e.g., a first link may be displayed upon encountering a first embedded component and a second link may be displayed above the first upon encountering a second embedded component, and each may be displayed for X seconds before fading away, with the stack collapsing as each successive link is removed). The links may be displayed in various forms such as, for example, bars, icons, windows, or text, to name but a few. Different colors or other attributes may be used to indicate how much time the link will remain on the screen for selection by the consumer (e.g., the link may turn from green to yellow and finally to red just before fading away, or the link may include a “progress bar” type feature that indicates how much longer the link will remain on the screen).

FIG. 27 shows an exemplary eRSP screen including a sponsor banner, an information panel, and a set of additional control tabs positioned in the open space around the eRSP window area. In this example, the sponsor banner includes a link to a sponsor's web site (e.g., Almond Growers of America, a fictitious organization); the information panel displays such things as the time, date, eRSP presentation length, and eRSP presentation duration; and the set of additional control tabs (labeled D, T, P, V, C, R) allow user access respectively to a dictionary definition for the term/phrase, a thesaurus entry for the term/phrase, links to pictures related to the term/phrase, links to videos related to the term/phrase, coupons related to the term/phrase (e.g., coupons for discounts on almonds and almond products), and links to other relevant information (e.g., how almonds are grown/harvested/processed, almond history/trivia, almond recipes, medicinal uses of almonds, an almond grower's association, etc.).

Thus, RSP content may be rendered in a first area of a display screen and non-RSP content may be rendered in at least one other area of the display screen (e.g., RSP and non-RSP content may be rendered in different windows). For example, the non-RSP content may include video content and the RSP content may include corresponding captions, the non-RSP content may include foreign-language audio content and the RSP content may include corresponding translation of the foreign-language audio content, the non-RSP content may include audio content and the RSP content may include corresponding transcription of the audio content, the non-RSP content may include slides for a slide show and the RSP content may include corresponding captions, the non-RSP content may include a portion of a document and the RSP content may include corresponding text for the portion of the document, or the non-RSP content may include information relating to the RSP content (e.g., a bar, window, or icon that the consumer can select in order to navigate to other content or information). The rendering of the RSP content may be synchronized with the rendering of the non-RSP content. The non-RSP content may be rendered in an active area of the display screen so as to allow the consumer to enter information and take various actions, e.g., to take notes, draw pictures, send messages (e.g., text message, email messages, instant messages, place phone calls, etc.), record audio, record video, browse the web, interact with an application related to the RSP content, or interact with an application unrelated to the RSP content. The consumer may be allowed to selectively stop and start rendering of the RSP content and may be allowed to selectively move between the RSP and non-RSP areas.

Sonified eRSP with Rulesets

As discussed above, rapid serial presentations may include audio or sounds in addition to, or in lieu of, text or other elements. Thus, for example, a rapid serial presentation may include an audio track. Audio may be provided on a continuum or in discrete bursts. Rulesets may be applied to the audio track to define attributes for rendering the audio track. For example, a rule may specify that a target be displayed in a large font size and that a sound be played if, say, the concreteness value for the target is below a certain threshold value; in this way, the target will be both visually and aurally highlighted. The audio track may be used for other purposes such as, for example, providing a neutral background soundstage or expressing emotions or moods.

An extension of such sonified eRSP with rulesets is text-to-speech, in which both text and a reading of the text is provided simultaneously. At very high speeds, either text alone or speech alone is difficult for the human mind to comprehend. It is believed, however, that comprehension can be improved by the combination of speech with text, since each complements the other. Rulesets are applied to both the text and the speech, for example, to synchronize the text and the speech and/or to control intonation of the speech.

### Additional Rules for Improving Comprehension

Arthur Wingfield PhD and Patricia Tun PhD of Brandeis University recently reported results in Directions in Psychological Science suggesting that people with hearing loss may exhibit reduced comprehension in some contexts not because they failed to hear words that were spoken but because of “the extra effort the adults with hearing loss had to expend” to hear the words, which had consumed the mental or cognitive “resources that would otherwise have been available for memorization.” Wingfield and Tun recommend that people who speak to those with hearing loss pause after clauses to give listeners time to perceptually catch up.

Thus, people with hearing loss may benefit from altered rhythm patters such as, for example, additional delays placed between words or clauses or at other times (e.g., every few words). It is believed that others, such as, for example, people with other impairments (e.g., dyslexia, learning disabilities, etc.) or people who speak a different primary language, may benefit from similar altered rhythm patterns.

Thus, rulesets for generating rapid serial presentations may include rules for producing altered rhythm patterns such as, for example, inserting additional delays between words or clauses or at other appropriate times. Such rules may be integrated with other rules (e.g., a single ruleset may be tailored for a particular impairment) or may be applied after other rules have been applied (e.g., a first ruleset may be used to produce a rapid serial presentation and a second ruleset may be used to tailor the rapid serial presentation for a particular impairment). Such rules may be applied to rapid serial presentation of textual information as well as to sonified eRSP (e.g., speech or text-to-speech).

Integration of eRSP with Applications/Services

It is envisioned that eRSP will become a preferred information delivery method for many applications and services (both online applications/services and offline applications/services), especially when those applications and services are accessed from portable consumer devices with small display screens but certainly in other contexts as well. It is therefore envisioned that eRSP will become tightly integrated into such applications and services. For example, eRSP generation and/or eRSP rendering may be integrated into such things as document creation/management applications (e.g., Microsoft Word, Microsoft Excel™, Microsoft Powerpoint™, Microsoft Outlook™, Adobe Acrobat™ reader, etc.); text/instant messaging applications (e.g., AOL Instant Messenger™, SMS short messaging service, etc.); online databases (e.g., Wikipedia™, etc.); online dictionaries (e.g., merriam-webster.com, freeonlinedictionary.com, etc.); online search facilities (e.g., Google™, Yahoo™, Ask.com™, etc.); online publishers (e.g., online newspapers such as Boston.com™ or Washingtonpost.com™, online magazines, etc.); online stores (e.g., Amazon™, Apple iTunes™, etc.); online sports networks (e.g., espn.com, nfl.com, mlb.com, etc.); online social networking services/platforms (e.g., YouTube™, FaceBook™, MySpace™, Twitter™, etc.); electronic learning environments (e.g., reading/language training for children, foreign language lessons, etc.); company/organization web sites; blogs; message boards; file sharing sites; web browsers (e.g., Microsoft Explorer™, Apple Safari™, Netscape™, etc.); operating systems (e.g., Microsoft Windows™, Apple MAC OS, UNIX™, Linux™, etc.); and wireless service providers (e.g., Verizon™, AT&T™, T-Mobile™, Research In Motion™, etc.), to name but a few.

It is also envisioned that eRSP will be integrated with user profiles on many types of online applications and services. For example, a user may be permitted to specify in his or her profile that eRSP is the preferred method of receiving information, in which case the service provider may use eRSP as a default for presenting information to that user.

Additionally, or alternatively, a user may be permitted to post eRSP files and/or an eRSP reader program (e.g., in personal web pages, MySpace™ pages, FaceBook™ profiles, etc.) for others to view information in eRSP format. Such an eRSP reader program may be provided in the form of a “widget” that can be embedded in a web site. Including an eRSP reader program in such shared online applications and services would tend to create a self-propagating distribution network of eRSP content and functionality.

eRSP Windows on Larger Screens

There are many situations in which both primary content and secondary information is displayed on a single screen. For example, tickers (e.g., stock ticker, news, sports information, etc.) and closed captioning are often displayed on television screens, subtitles are often included in movies, and pop-up notifications (e.g., phone call or email received) are often displayed on computer screens. In certain embodiments of the present invention, such secondary information may be displayed in a separate window or area using eRSP, for example, to reduce the amount of screen space used for such secondary information or to improve readability, and such eRSP displays may be persistent or transitory. eRSP windows may be extended to other uses such as, for example, heads-up displays for fighter pilots, text displays for GPS navigation systems, and emergency notification systems, to name but a few.

Similarly, various embodiments of the present invention may be used to place embedded advertisements on both large screen and small screen devices. As discussed above, eRSP screens may include embedded advertisements, and such screens may be placed on large screen devices as well as small screen devices. For example, an eRSP screen may be placed as a separate window on a large screen device such as a computer screen, a television screen, or a billboard, to name but a few.

Various embodiments permit text and other types of media to be presented and/or manipulated in multiple windows, e.g., for multitasking or for presenting mixed-media content in different formats in different windows. For example, the textual portion of a mixed-media presentation (e.g., a document, web page, article, electronic book, search result, etc.) may be displayed in an eRSP window, while other elements (e.g., pictures, videos, spreadsheets, tables, advertisements, related links, etc.) may be displayed in one or more separate windows. Similarly, screens for different applications may be displayed in separate windows (e.g., a text document in an eRSP window and a spreadsheet or other application screen in a separate window, for example, to allow the user to take notes regarding the eRSP content). Similarly, separate screens may be used to display different portions of content or different content (e.g., a first eRSP window displaying results from a first search, a second eRSP window displaying results from a second search conducted from the first eRSP window). The multiple windows may be displayed in any of a variety of ways such as, for example, multiple windows displayed simultaneously (e.g., in separate window panes, in a split screen arrangement, etc.) or multiple windows “stacked” so that one window is (selectively) displayed at a time. The user may be permitted to switch between the various windows (e.g., an eRSP window to control eRSP rendering and another window to manipulate the pictures, videos, spreadsheets, tables, advertisements, related links, etc.), for example, by clicking on a window to be displayed or otherwise brought to the forefront or selecting a window from a list of active windows (e.g., from a drop-down or pull-down menu). Additionally, or alternatively, switching between different windows may be performed automatically, for example, to display different portions of a presentation or different content in appropriate formats (e.g., the eRSP player may render a portion of text in an eRSP window, automatically switch to a different window to display an embedded picture, video, spreadsheet, table, advertisement, related link, etc., then switch back to the eRSP window to continue rendering text; user input may be solicited before switching to or from a particular window). Switching between windows may cause the windows to be automatically re-sized (e.g., the size of the window moving to the forefront may be enlarged while the size of the window moving to the background may be reduced or changed into a “thumbnail”). The various windows may be displayed simultaneously on the screen or may be “stacked” so that only one window is shown at a time. One or more “background” windows may be presented as “thumbnails” that may be selected to bring the selected window to the forefront.

Similarly, mixed-media content may be dynamically displayed in different formats within a single window. For example, for a document that includes elements such as tables or pictures interspersed with text, the textual passages may be displayed in eRSP format and the other elements may be displayed in full screen mode, and the eRSP player may automatically toggle between the two display modes (and possibly others, e.g., for tables, spreadsheets, etc.) as appropriate. The user may be prompted before toggling between certain screens (e.g., before toggling from a full-screen picture back to eRSP text).

Content displayed in an eRSP window may be synchronized or coordinated with content displayed in one or more other windows (e.g., video, spreadsheet, slide show, etc.), including eRSP windows and/or non-eRSP windows. For example, subtitles displayed in an eRSP window may be synchronized with corresponding video shown in a separate window, slides for a slide show (e.g., in PowerPoint™) may be synchronized with corresponding captions displayed in a separate eRSP window, portions of a spreadsheet or other document may be synchronized with corresponding explanations displayed in a separate eRSP window, etc. Synchronization information may be specified using eRSP descriptors (e.g., within an eRSP markup language file) or may be handled using separate mechanisms.

Alternative eRSP Output Formats

In certain embodiments of the present invention, eRSP may be output in formats that are supported by other types of players. For example, eRSP output could be formatted for Flash™ player, JavasScript™, QuickTime™, Windows Media Player™, or Microsoft Silverlight™, to name but a few. Such alternative output formats may be produced in various ways such as, for example, directly by the eRSP generator or by a separate converter that converts the output produced by the eRSP generator (e.g., a markup language file) into an alternative format (e.g., there might be an XML-to-Flash converter, an XML-to-QuickTime converter, etc.).

### CONCLUSION

Thus, eRSP techniques may be used to improve a user's reading experience on devices with electronic screens, including, but not limited to, small-screen consumer devices and larger screen devices. In addition, the rule sets for the eRSP techniques could be adjusted for special purposes, such as for people with impaired vision, dyslexia, learning disabilities, and other conditions.

In many of the embodiments described above, various elements (e.g., parameters for generating a rapid serial presentation, parameters for rendering a rapid serial presentation, parameters for pausing and resuming rendering of a rapid serial presentation, advertisements or other messages to be displayed to a consumer, etc.) may be selected based on attributes associated with the consumer or the consumer device. Numerous techniques for selecting such elements are disclosed above in various contexts, and it should be noted that a technique described in one context generally may be used in other contexts. Many of the techniques involve selecting elements based on real or perceived consumer preferences including personal, demographic, psychographic, and/or behavioral attributes. Such consumer preferences may be obtained directly from the consumer or indirectly (e.g., based on consumer activities, which may be monitored using contextual or other marketing or targeted advertising techniques). Generally, speaking, contextual marketing is an online marketing model in which selection of targeted advertisements for a consumer is based on recent online activities of the consumer such as, for example, searching or browsing activities. Contextual marketing programs may use a “cookie” or other component that runs on the consumer device to facilitate tracking of user activities such as, for example, searches performed, articles read, and advertisements “clicked” by the consumer. One example of contextual marketing is the Google™ AdSense program, which displays advertisements based on the consumer's search terms. Embodiments of the present invention may use contextual marketing or other techniques for generating and rendering rapid serial presentations and/or to select advertisements and other messages.

It should be noted that section headings are used above for convenience and should not be construed to limit the present invention in any way.

It should be noted that the logic flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In a typical embodiment of the present invention, the eRSP generator 204 and eRSP player 504 are implemented in Java with JDK 1.5.0.6.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as but not limited to Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as but not limited to a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as but not limited to Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The present invention may be embodied in other specific forms without departing from the true scope of the invention. The described embodiments are to be considered in all respects only as illustrative and not restrictive.

What is claimed is:

1. A method for rendering a rapid serial presentation on a consumer device having at least a display screen, the method comprising:
rendering a portion of the rapid serial presentation on the display screen of the consumer device;
automatically pausing rendering of the rapid serial presentation;
displaying a message on the display screen for a quantum of time during such pausing; and
thereafter resuming rendering of the rapid serial presentation on the display screen.

2. A method according to claim 1, wherein the message includes an advertisement.

3. A method according to claim 2, wherein the advertisement includes a link that a consumer can select in order to obtain further information.

4. A method according to claim 1, wherein the message includes a suggested action for a consumer to perform.

5. A method according to claim 1, wherein the message includes a question requiring a response from a consumer.

6. A method according to claim 1, wherein the rapid serial presentation is rendered at a first location on the display screen and wherein the message is displayed at a different location on the display screen.

7. A method according to claim 1, wherein rendering of the rapid serial presentation is resumed after the message has been displayed for a predetermined amount of time.

8. A method according to claim 1, wherein rendering of the rapid serial presentation is resumed upon receipt of a specified input from a consumer via the consumer device.

9. A method according to claim 8, wherein the message includes a link that the consumer must select in order to resume rendering of the rapid serial presentation, and wherein the input includes such selection of the link.

10. A method according to claim 8, wherein the input includes actuation of a specified actuator of the consumer device.

11. A method according to claim 8, wherein the input includes an affirmation that the consumer has read the message.

12. A method according to claim 11, wherein the consumer is provided with a credit or discount for having read the message.

13. A method according to claim 1, wherein automatically pausing rendering of the rapid serial presentation includes at least one of:
automatically pausing rendering of the rapid serial presentation after a predetermined amount of time; and
automatically pausing rendering of the rapid serial presentation after a predetermined number of words.

14. A method according to claim 13, wherein the predetermined amount of time and the predetermined number of words are configurable by a consumer.

15. A method according to claim 1, wherein automatically pausing rendering of the rapid serial presentation includes automatically pausing rendering of the rapid serial presentation upon encountering an unknown word in the rapid serial presentation.

16. A method according to claim 15, wherein the message presents a number of consumer-selectable options including at least a first option to add the unknown word to a dictionary and a second option to resume rendering of the rapid serial presentation without adding the unknown word to the dictionary.

17. A method according to claim 1, wherein the consumer device includes a light detector through which ambient light conditions can be monitored, and wherein automatically pausing rendering of the rapid serial presentation includes automatically pausing rendering of the rapid serial presentation upon detection of a predetermined unacceptable ambient light condition.

18. A method according to claim 17, where the predetermined unacceptable ambient light condition includes at least one of:
an ambient light level below a predetermined ambient light level threshold; and
an ambient light level above a predetermined ambient light level threshold.

19. A method according to claim 17, wherein rendering of the rapid serial presentation is automatically resumed upon return to a predetermined acceptable ambient light condition.

20. A method according to claim 1, wherein the consumer device includes a microphone through which ambient noise levels can be monitored, and wherein automatically pausing rendering of the rapid serial presentation includes automatically pausing rendering of the rapid serial presentation upon detection of a predetermined unacceptable ambient noise condition.

21. A method according to claim 20, wherein the predetermined unacceptable ambient noise condition includes an ambient noise level above a predetermined noise level threshold.

22. A method according to claim 20, wherein rendering of the rapid serial presentation is automatically resumed upon return to a predetermined acceptable ambient noise condition.

23. A method according to claim 1, wherein automatically pausing rendering of the rapid serial presentation includes automatically pausing rendering of the rapid serial presentation upon detecting a predetermined notification event.

24. A method according to claim 1, wherein the notification event includes at least one of a phone call, an email message, a text message, an instant message, a voice mail message, a missed call message, a pop-up message, a warning, an alert, a reminder, a timer, and a low battery warning.

25. A method according to claim 23, wherein the message relates to the notification event.

26. A method according to claim 1, wherein automatically pausing rendering of the rapid serial presentation includes automatically pausing rendering of the rapid serial presentation upon detecting a condition indicating that a consumer has not viewed the rendering of the rapid serial presentation for a predetermined amount of time.

27. A method according to claim 26, wherein at least one of:
(a) the consumer device includes an eye monitor and the condition includes at least one of:
determining that the consumer blinked;
determining that the consumer blinked more than once within a predetermined amount of time;
determining that the consumer looked away from the display screen for a predetermined amount of time;
(b) the consumer device includes a pulse monitor and the condition includes at least one of:
detecting a change in consumer pulse rate; and
detecting absence of a pulse signal;
(c) the consumer device includes a contact device that the consumer must contact in order for rendering to occur and the condition includes determining that the consumer is no longer in contact with the contact device; and
(d) the consumer device includes a proximity monitor and the condition includes determining that the consumer is outside of a predetermined proximity.

28. A method according to claim 27, wherein at least one of:
the eye monitor includes a built-in camera of the consumer device;
the pulse monitor includes one of a mechanical sensor, a thermal sensor, an optical sensor, and a galvanic skin response sensor of the consumer device;
the contact device includes one of a mechanical sensor, a thermal sensor, an optical sensor, and a galvanic skin response sensor of the consumer device; and
the proximity monitor includes an infrared proximity detector of the consumer device.

29. A method according to claim 1, wherein the message includes a link that a consumer can select to forward the message to one or more other consumers.

30. A method according to claim 29, wherein the consumer is provided with a credit or discount for forwarding the message.

31. A method according to claim 31, wherein the amount of the credit or discount is based on the number of other consumers to which the message is forwarded.

32. A method according to claim 1, wherein displaying the message comprises:
selecting a message from among a plurality of messages; and
displaying the selected message.

33. A method according to claim 32, wherein selecting the message comprises:
identifying an attribute associated with a consumer; and
selecting the message based on the attribute.

34. A method according to claim 33, wherein the attribute includes at least one of:
a demographic attribute associated with the consumer;
a psychographic attribute associated with the consumer; and
a behavioral attribute associated with the consumer.

35. A method according to claim 33, wherein identifying the attribute comprises:
storing a profile for the consumer, the profile including attributes associated with the consumer; and
obtaining the attribute from the profile.

36. A method according to claim 35, wherein the profile includes feedback information obtained previously from the consumer.

37. A method according to claim 32, wherein selecting the message comprises:
determining a location of the consumer device; and
selecting the message based on the location of the consumer device.

38. A method according to claim 1, wherein rendering of the rapid serial presentation is automatically paused based on pause information included in the rapid serial presentation.

39. A method according to claim 1, wherein rendering of the rapid serial presentation is automatically paused independently of pause information included in the rapid serial presentation.

40. A method according to claim 1, wherein rendering of the rapid serial presentation is automatically paused at least in part based on preference information provided previously by a consumer.

41. A method according to claim 1, further comprising:
displaying an advertisement on the display screen simultaneously with rendering the portion of the rapid serial presentation, wherein the message relates to the displayed advertisement.

42. A method according to claim 41, wherein the portion of the rapid serial presentation is rendered in a predetermined window area of the display screen and wherein the advertisement is displayed in one of:
an area adjacent to the window area;
an area surrounding the window area;
a background area; and
a control area.

43. A method according to claim 41, wherein the message prompts a consumer for feedback information regarding the advertisement, and wherein the rendering is resumed only upon receipt of the feedback information.

44. A method according to claim 1, further comprising:
collecting feedback information from a consumer in response to the message.

45. A method according to claim 44, wherein the feedback information includes at least one of:
an unknown word flagged by the consumer;
an answer to a question concerning the message; and
an opinion concerning the message.

46. A method according to claim 1, further comprising:
displaying an advertisement on the display screen prior to rendering the portion of the rapid serial presentation; and
rendering the portion of the rapid serial presentation only upon receipt of a specified input from a consumer via the consumer device.

47. A method according to claim 8, wherein the specified input causes rendering of the rapid serial presentation to resume from where the rapid serial presentation was paused.

48. A method according to claim 8, wherein the specified input causes rendering of the rapid serial presentation to resume from prior to where the rapid serial presentation was paused.

49. A method according to claim 1, wherein rendering of the rapid serial presentation is automatically paused at a non-RSP component of the rapid serial presentation, and wherein the message allows a consumer to selectively render the non-RSP component.

50. A method according to claim 49, wherein the non-RSP component includes at least one of a chart, a table, a graph, a spreadsheet, a footnote, a comment, a picture, a drawing, a slide show, an object, a video clip, an audio clip, a file, a document, and a link.

51. A method according to claim 49, wherein the rapid serial presentation is rendered at a first location on the display screen and wherein the non-RSP component is rendered at a second location on the display screen.

52. A method according to claim 51, wherein rendering of the rapid serial presentation is selectively resumed at the first location in conjunction with rendering of the non-RSP component at the second location.

53. A method according to claim 1, wherein the message is displayed prior to pausing and continues to be displayed during the pausing.

54. A method for rendering a rapid serial presentation on a consumer device having at least a display screen, the method comprising:
rendering RSP content in a first area of the display screen; and
rendering non-RSP content in at least one other area of the display screen.

55. A method according to claim 54, wherein the rendering of the RSP content is synchronized with the rendering of the non-RSP content.

56. A method according to claim 54, wherein at least one of:
the non-RSP content includes video content and the RSP content includes corresponding captions;
the non-RSP content includes foreign-language audio content and the RSP content includes corresponding translation of the foreign-language audio content;
the non-RSP content includes audio content and the RSP content includes corresponding transcription of the audio content;
the non-RSP content includes slides for a slide show and the RSP content includes corresponding captions;
the non-RSP content includes a portion of a document and the RSP content includes corresponding text for the portion of the document;
the non-RSP content includes information relating to the RSP content; and
the RSP content includes a ticker.

57. A method according to claim 54, wherein rendering the non-RSP content includes rendering the non-RSP content in an active area of the display screen.

58. A method according to claim 57, wherein the active area allows a consumer to at least one of:
take notes;
draw pictures;
send messages;
record audio;
record video;
browse the web;
interact with an application related to the RSP content; and
interact with an application unrelated to the RSP content.

59. A method according to claim 54, wherein the RSP content is rendered in a first window, and wherein the non-RSP content is rendered in at least one separate window.
